(19) United States
(12) Patent Application Publication
(10) Pub. No.: US 2025/0144623 A1
(43) Pub. Date: May 8, 2025

(54) CHEMICAL PROCESSING SYSTEM, INSTRUMENT AND SAMPLE CARTRIDGE

(71) Applicant: INVIVOSCRIBE INC., San Diego, CA (US)

(72) Inventors: Jeffrey Edward MILLER, Del Mar, CA (US); Martin Anthony MOTTRAM, Melbourn (GB); Balazs KISS, Melbourn (GB); Andrew James MALLOY, Melbourn (GB); Paul Malcolm CRISP, Melbourn (GB); Peter Lee CROSSLEY, Melbourn (GB); Lauren Victoria Elizabeth LAING, Melbourn (GB); Alexander Robert MACLACHLAN, Melbourn (GB)

(21) Appl. No.: 18/269,254

(22) PCT Filed: Dec. 23, 2021
(86) PCT No.: PCT/US2021/065045

§ 371 Date: Jun. 22, 2023

Related U.S. Application Data
(63) Continuation-in-part of application No. 29/820,394, filed on Dec. 21, 2021.
(60) Provisional application No. 63/130,450, filed on Dec. 24, 2020.
(60) Provisional application No. 63/241,167, filed on Sep. 7, 2021.
(60) Provisional application No. 63/292,314, filed on Dec. 21, 2021.

(51) Int. Cl. B01L 3/00

(52) U.S. Cl. CPC B01L 3/50273; B01L 2200/04; B01L 2200/0605; B01L 2200/16; B01L 2300/043; B01L 2400/049

(57) ABSTRACT

A sample cartridge for a chemical processing instrument. The sample cartridge comprises a primary reaction vessel configured to accommodate a fluid sample for processing and configured to receive a lid for closing an open top of the primary reaction vessel, and a reagent vessel configured to receive one or more fluid reagents via an open top of the reagent vessel. The reagent vessel is connected to the primary reaction vessel via a primary reagent channel with a primary reagent valve disposed in the primary reagent channel to control fluid flow through the primary reagent channel. The sample cartridge further comprises a primary pneumatic port in fluid communication with the primary reaction vessel and configured to be connected to a pneumatic module to selectively adjust a pressure within the primary reaction vessel when the lid is closed to draw the fluid contents of the reagent vessel into the primary reaction vessel.

### CROSS-REFERENCE TO RELATED APPLICATIONS

This application claims priority from the following priority applications, the entire contents of which are incorporated herein by reference: U.S. Provisional Patent Application 63/130,450, filed on Dec. 24, 2020; U.S. Provisional Patent Application 63/241,167, filed Sep. 7, 2021; U.S. Provisional Patent Application 63/292,314, filed Dec. 21, 2021; and U.S. Design patent application Ser. No. 29/820,394, filed Dec. 21, 2021.

### TECHNICAL FIELD

Embodiments generally relate to systems, instruments, methods and computer-readable media for performing operations on samples, such as nucleic acid extraction operations and the like, as well as sample cartridges for use with a chemical processing instrument.

### BACKGROUND

State-of-the-art automated machines and instruments for performing nucleic acid extraction operations and the like tend to be capable of receiving and processing low volumes of sample input, usually less than 1 ml and typically around 200 ul. However, there are times when it is desirable to extract nucleic acid from a much larger input sample in order to output enough genetic material to carry out downstream processing.

Furthermore, in standard high-throughput labs using well plates and large automated liquid handling robots, large volume samples typically need to be aliquoted into smaller volumes for automated processing, which is inefficient for machine usage. A typical machine may have many channels, each able to take a small sample, but aliquoting will lead to fewer patients occupying the run-time of a machine.

A further common issue with known automated machines is contamination. The risk of this is increased wherever a vessel containing patient derived material is open within the machine, a moving pipettor is used and/or whenever materials that have contacted patient derived material are stored within an instrument (e.g., pipette tips)

A further issue with known automated machines is the difficulty in achieving sufficient control of the end-to-end process to ensure highest quality.

Yet a further issue is achieving adequately concentrated and/or quantified nucleic acids from the extraction workflow to be inputted directly into the downstream assay. Applications such as MRD typically require highly concentrated DNA (˜500 ng/μL) which is rarely achieved using the available instrumentation for nucleic acid extraction. In addition, most existing systems aimed at automating cell free DNA (cfDNA) extractions do not select for a certain size of nucleic acid. cfDNA is typically ˜150 bp, and downstream assays are negatively impacted by the presence of genomic DNA (gDNA) contamination in cfDNA samples.

It is desired to address or ameliorate one or more shortcomings or disadvantages associated with prior art to systems, instruments, methods and computer-readable media for performing operations on samples, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a sample cartridge for a chemical processing instrument, the sample cartridge comprising: a primary reaction vessel configured to accommodate a fluid sample for processing and configured to receive a lid for closing an open top of the primary reaction vessel; a reagent vessel configured to receive one or more fluid reagents via an open top of the reagent vessel, the reagent vessel being connected to the primary reaction vessel via a primary reagent channel with a primary reagent valve disposed in the primary reagent channel to control fluid flow through the primary reagent channel; and a primary pneumatic port in fluid communication with the primary reaction vessel and configured to be connected to a pneumatic module to selectively adjust a pressure within the primary reaction vessel when the lid is closed to draw the fluid contents of the reagent vessel into the primary reaction vessel.

The sample cartridge may further comprise a primary pneumatic channel extending between the primary pneumatic port and the primary reaction vessel, wherein an opening of the primary pneumatic channel into the primary reaction vessel is located part way up a sidewall of the primary reaction vessel. The opening of the primary pneumatic port into the primary reaction vessel may be located nearer to the top of the primary reaction vessel than the bottom of the primary reaction vessel. In some embodiments, an opening of the primary reagent channel into the primary reaction vessel is located part way up a sidewall of the primary reaction vessel. In some embodiments, the opening of the primary reagent channel into the primary reaction vessel is located nearer to the top of the primary reaction vessel than to the bottom of the primary reaction vessel.

In some embodiments, the sample cartridge may further comprise a liquid trap configured to restrict the passage of liquids out of the sample cartridge. The liquid trap may be disposed within or at one end of the primary pneumatic channel, for example. The liquid trap may be disposed at or in a base of the sample cartridge. The liquid trap may comprise a gas permeable membrane. The liquid trap may comprise a hydrophobic polymer material which can act as a gas permeable or semi-permeable membrane. The liquid trap may be configured to accommodate a minimum volume of liquid before becoming blocked or overflowing. The minimum liquid capacity volume of the liquid trap may be in the range of 1 μL to 1000 μL, 10 μL to 100 μL, 40 μL to 80 μL, or 50 μL to 60 μL, for example.

In some embodiments, the sample cartridge further comprises an output vessel configured to receive a final output fluid from the primary reaction vessel via a final output channel. The sample cartridge may further comprise an output vessel pneumatic port in communication with the output vessel via an output vessel pneumatic channel and configured to be connected to a pneumatic module to selectively adjust the pressure in the output vessel to draw the final output fluid into the output vessel from the primary reaction vessel via the final output channel. The sample cartridge may further comprise a temporary lid configured to close the output vessel during processing, the temporary lid being connected to and defining openings for the final output channel and output vessel pneumatic channel into the output vessel.

In some embodiments, the sample cartridge may be provided without an output vessel, and may further comprise a final output channel configured to carry a final output fluid from the primary reaction vessel to a removable output vessel. The cartridge may further comprise an output vessel pneumatic port configured to be in fluid communication with the output vessel via an output vessel pneumatic channel and configured to be connected to a pneumatic module to selectively adjust the pressure in the output vessel to draw the final output fluid into the output vessel from the primary reaction vessel via the final output channel. The sample cartridge may further comprise a temporary lid configured to close the output vessel during processing, the temporary lid being configured to fluidly connect the final output channel and output vessel pneumatic channel to the output vessel.

In some embodiments, the sample cartridge further comprises: a quality control vessel configured to receive an aliquot of the output fluid for quality control analysis; a quality control channel extending between the quality control vessel and a quality control junction with the final output channel; and a quality control pneumatic port in fluid communication with the quality control vessel and configured to be connected to a pneumatic module to selectively adjust a pressure within the quality control vessel to draw the aliquot of final output fluid from the final output channel through the quality control channel and into the quality control vessel. The quality control vessel may be preloaded with a dye to be mixed with the aliquot of final output fluid for quality control analysis.

The sample cartridge may further comprise a buffer solution vessel configured to receive a buffer solution through an open top of the buffer solution vessel for mixing with the final output fluid for quality control analysis; a buffer channel extending between the buffer solution channel and a buffer junction with the final output channel between the quality control junction and the primary reaction vessel; and a buffer channel valve disposed in the buffer channel to control flow of the buffer solution through the buffer channel.

The sample cartridge may further comprise: an intermediate outlet from the final output channel between the quality control junction and the output vessel; a sealed chamber into which the intermediate outlet opens; an air-permeable liquid barrier membrane covering the outlet; and an intermediate outlet pneumatic port in fluid communication with the sealed chamber and configured to be connected to a pneumatic module to selectively adjust a pressure within the sealed chamber to draw air through the air-permeable membrane from the final output channel.

In some embodiments, the sample cartridge further comprises a sealed waste vessel configured to receive waste fluid from the primary reaction vessel via a waste channel; and a waste pneumatic port in fluid communication with the waste vessel and configured to be connected to a pneumatic module to selectively adjust a pressure within the waste vessel to draw fluid from the primary reaction vessel through the waste channel and into the waste vessel.

In some embodiments, the sample cartridge further comprises a secondary reaction vessel configured to receive a primary output fluid from the primary reaction vessel via a primary output channel fluidly connecting the primary reaction vessel to the secondary reaction vessel, and configured to receive one or more fluid reagents from the reagent vessel via a secondary reagent channel fluidly connecting the reagent vessel to the secondary reaction vessel; a primary outlet valve disposed in the primary outlet channel to control flow through the primary outlet channel; and a secondary reagent valve disposed in the secondary reagent channel to control flow through the secondary reagent channel. The secondary reaction vessel may be sealed, and in some embodiments, the sample cartridge further comprises a secondary pneumatic port in fluid communication with the secondary reaction vessel and configured to be connected to a pneumatic module to selectively adjust a pressure in the secondary reaction vessel to draw fluid from the primary outlet channel or secondary reagent channel into the secondary reaction vessel. The sample cartridge may further comprise a secondary pneumatic channel extending between the secondary pneumatic port and the secondary reaction vessel, wherein an opening of the secondary pneumatic channel into the secondary reaction vessel is located part way up a sidewall of the secondary reaction vessel, nearer to a top of the secondary reaction vessel than a bottom of the secondary reaction vessel. An inlet or inlets of the primary output channel and secondary reagent channel may open into the secondary reaction vessel part way up a sidewall of the secondary reaction vessel, nearer to a top of the secondary reaction vessel than a bottom of the secondary reaction vessel.

In some embodiments, at the quality control junction, the quality control channel forms an obtuse angle with part of the final output channel extending between the quality control junction and buffer junction.

In some embodiments, at the buffer junction, the buffer channel forms an obtuse angle with part of the final output channel extending between the quality control junction and buffer junction.

In some embodiments, at the buffer junction, a pre-buffer junction part of the final output channel forms an obtuse angle with part of the final output channel extending between the quality control junction and buffer junction.

In some embodiments, at the quality control junction, a post-QC junction part of the final output channel forms an obtuse angle with part of the final output channel extending between the quality control junction and buffer junction.

Some embodiments relate to a chemical processing instrument configured to receive the sample cartridge according to any of the described embodiments, the instrument comprising: a reagent dispenser configured to dispense one or more fluid reagents into the reagent vessel via the open top of the reagent vessel; and a pneumatic module configured to connect to the primary pneumatic port of the primary reaction vessel and selectively adjust a pressure within the primary reaction vessel when the lid is closed to draw fluid from the reagent vessel through the primary reagent channel into the primary reaction vessel.

The pneumatic module may be further configured to connect to the output vessel pneumatic port and selectively adjust the pressure in the output vessel to draw the final output fluid into the output vessel from the primary reaction vessel via the final output channel. The pneumatic module may be further configured to connect to the quality control pneumatic port and selectively adjust a pressure within the quality control vessel to draw the aliquot of final output fluid from the final output channel through the quality control channel and into the quality control vessel. The reagent module may be configured to dispense buffer solution into the buffer solution vessel. The pneumatic module may be further configured to connect to the intermediate outlet pneumatic port and selectively adjust a pressure within the sealed chamber to draw air through the air-permeable membrane from the final output channel. The pneumatic module may be further configured to connect to the waste pneumatic port and selectively adjust a pressure within the waste vessel to draw fluid from the primary reaction vessel through the waste channel and into the waste vessel. The pneumatic module may be further configured to connect to the secondary pneumatic port and selectively adjust a pressure in the secondary reaction vessel to draw fluid from the primary outlet channel or secondary reagent channel into the secondary reaction vessel.

The pneumatic module may be configured to detect changes in pressure and/or flow rates in order to determine when liquid transfer operations are completed. For example, when the pressure is adjusted to draw liquid from one chamber to another, once all of the liquid has been drawn through the transfer channel, air will be drawn through following the liquid, which requires less pressure difference and thus has a higher flow rate. This change in pressure and/or flow rate may be detected by the pneumatic module and used as a signal to stop the pressure actuation when the transfer process is complete.

The pneumatic module may be configured to move liquids between the various vessels of the cartridge using positive pressure or negative pressure. That is, applying positive pressure (above atmospheric pressure) in one vessel to push liquid through the transfer channels into another vessel, or applying negative pressure (below atmospheric pressure) to one vessel to draw liquid through the transfer channels into another vessel.

In some embodiments, the pneumatic module may be configured to operate using a single pressure level selectively applied to the various pneumatic ports at different times to affect different operations. In some embodiments, the pneumatic module may be configured to operate using only two pressure levels selectively applied to the various pneumatic ports at different times to affect different operations.

In some embodiments, the instrument may further comprise an optics module configured to measure a property of an aliquot of output fluid accommodated in the quality control vessel.

The instrument may be configured to receive a plurality of ones of the sample cartridge. The pneumatic module may be configured to connect to all of the pneumatic ports of the plurality of sample cartridges selectively apply pressure to selected ones of the pneumatic ports at selected times. The reagent module is configured to dispense reagents into each of the plurality of sample cartridges at selected times.

In some embodiments, the instrument further comprises a mechanism and actuator configured to move the reagent module to various positions within the instrument, each position corresponding to a respective one of the plurality of sample cartridges, to allow the reagent module to dispense one or more reagents into each respective sample cartridge.

Some embodiments relate to a chemical processing instrument configured to receive one or more sample cartridges each containing a fluid sample for processing, each sample cartridge defining: a primary reaction vessel configured to accommodate a fluid sample for processing and configured to receive a lid for closing an open top of the primary reaction vessel; a reagent vessel configured to receive one or more fluid reagents via an open top of the reagent vessel, the reagent vessel being connected to the primary reaction vessel via a primary reagent channel with a reagent valve disposed in the reagent channel to control fluid flow through the primary reagent channel; and a pneumatic port in fluid communication with the primary reaction vessel; the chemical processing instrument comprising: a reagent dispenser configured to dispense one or more fluid reagents into the reagent vessel via the open top of the reagent vessel; and a pneumatic module configured to connect to the pneumatic port of the primary reaction vessel and selectively adjust a pressure within the primary reaction vessel when the lid is closed to draw the fluid contents of the reagent vessel into the primary reaction vessel.

Some embodiments relate to a chemical processing system comprising: the instrument according to any one of the described embodiments; and one or more of the sample cartridges according to any one of the described embodiments.

Some embodiments relate to a chemical processing system comprising: one or more sample cartridges, each sample cartridge defining: a primary reaction vessel configured to accommodate a fluid sample for processing and configured to receive a lid for closing an open top of the primary reaction vessel; a reagent vessel configured to receive one or more fluid reagents via an open top of the reagent vessel, the reagent vessel being connected to the primary reaction vessel via a primary reagent channel with a reagent valve disposed in the reagent channel to control fluid flow through the primary reagent channel; and a pneumatic port in fluid communication with the primary reaction vessel; and a chemical processing instrument comprising: a reagent dispenser configured to dispense one or more fluid reagents into the reagent vessel via the open top of the reagent vessel; and a pneumatic module configured to connect to the pneumatic port of the primary reaction vessel and selectively adjust a pressure within the primary reaction vessel when the lid is closed to draw the fluid contents of the reagent vessel into the primary reaction vessel.

Some embodiments relate to a method of operation of the chemical processing instrument system, according to any one of the described embodiments, accommodating one or more of the sample cartridge, according to any one of the described embodiments, each containing a fluid sample in the primary reaction vessel, the method comprising: connecting the pneumatic module to the primary pneumatic port of the or each sample cartridge; operating the reagent module to dispense one or more reagents into the reagent vessel of the or each sample cartridge; operating the pneumatic module to reduce the pressure in the primary reaction vessel of the or each sample cartridge to draw the fluid contents of the corresponding reagent vessel through the or each primary reagent channel and into the primary reaction vessel of the or each sample cartridge.

The method may further comprise operating a shaker of the instrument to facilitate mixing of fluids in the primary reaction vessel of the or each sample cartridge. The method may further comprise operating a heater of the instrument to heat the primary reaction vessel of the or each sample cartridge to a predetermined temperature for a predetermined period of time.

In some embodiments, reagents in the primary reaction vessel of the or each sample cartridge comprise functionalised magnetic beads, and the method further comprises operating or moving magnets to hold the magnetic beads in a selected position within the primary reaction vessel.

The method may further comprise connecting the pneumatic module to the waste pneumatic port of the or each sample cartridge and reducing a pressure within the waste vessel to draw fluid from the primary reaction vessel through the waste channel and into the waste vessel. The method may further comprise connecting the pneumatic module to the secondary pneumatic port of the or each sample cartridge and reducing a pressure in the secondary reaction vessel to draw fluid from the primary outlet channel into the secondary reaction vessel. The method may further comprise connecting the pneumatic module to the secondary pneumatic port of the or each sample cartridge and reducing a pressure in the secondary reaction vessel to draw fluid from the secondary reagent channel into the secondary reaction vessel.

The method may further comprise operating a shaker of the instrument to facilitate mixing of fluids in the secondary reaction vessel of the or each sample cartridge. The method may further comprise operating a heater of the instrument to heat the secondary reaction vessel of the or each sample cartridge to a predetermined temperature for a predetermined period of time.

In some embodiments, reagents in the secondary reaction vessel of the or each sample cartridge comprise functionalised magnetic beads, and the method further comprises operating or moving magnets to hold the magnetic beads in a selected position within the secondary reaction vessel.

The method may further comprise connecting the pneumatic module to the waste pneumatic port of the or each sample cartridge and reducing a pressure within the waste vessel to draw fluid from the secondary reaction vessel and into the waste vessel via a secondary waste channel extending between the secondary reaction vessel and the waste vessel. The method may further comprise connecting the pneumatic module to the output vessel pneumatic port of the or each sample cartridge and reducing the pressure in the output vessel to draw processed fluid into the output vessel from the primary reaction vessel via the final output channel.

In some embodiments, the processed fluid drawn from the primary reaction vessel of the or each sample cartridge is drawn into the secondary reaction vessel and processed with further reagents prior to being drawn into the final output vessel via the final output channel.

The method may further comprise connecting the pneumatic module to the quality control pneumatic port of the or each sample cartridge and, prior to reducing the pressure in the output vessel to draw processed fluid into the output vessel, reducing a pressure within the quality control vessel to draw an aliquot of processed fluid from the final output channel through the quality control channel and into the quality control vessel.

The method may further comprise operating the reagent module to dispense buffer solution into the buffer solution vessel of the or each sample cartridge; and opening the buffer channel valve of the or each sample cartridge, prior to reducing the pressure in the quality control vessel of the or each sample cartridge to draw buffer solution from the buffer solution vessel via the buffer channel, and via the final output channel and quality control channel, along with the aliquot of processed fluid, into the quality control vessel.

The method may further comprise connecting the pneumatic module to the intermediate outlet pneumatic port of the or each sample cartridge and, prior to reducing the pressure in the quality control vessel, reducing a pressure within the outlet chamber of the or each sample cartridge to draw air through the air-permeable membrane from the final output channel.

The method may further comprise operating the optics module to measure a property of the aliquot of processed fluid accommodated in the quality control vessel of the or each sample cartridge.

In some embodiments, operating the reagent module to dispense reagents into the reagent vessel further comprises operating the mechanism and actuator to move the reagent module to various positions within the instrument, each position corresponding to a respective one of the one or more of sample cartridges.

Some embodiments relate to a computer-readable storage medium storing instructions that, when executed by a computer, cause the computer to perform any one of the described methods.

Some embodiments relate to a method of use of the system of any one of the described embodiments, the method comprising: depositing a fluid sample in the primary reaction vessel of the or each sample cartridge; applying a lid to seal closed the open top of the primary reaction vessel of the or each sample cartridge; inserting the or each sample cartridge into a corresponding cartridge slot in the instrument; and operating the instrument to process the fluid sample.

Some embodiments relate to a method of use of the system of any one of the describe embodiments, the method comprising: depositing a fluid sample in the primary reaction vessel of the or each sample cartridge; applying a lid to seal closed the open top of the primary reaction vessel of the or each sample cartridge; inserting the or each sample cartridge into a corresponding cartridge slot in the instrument; and operating the instrument to process the fluid sample.

The method may further comprise removing the or each sample cartridge from the instrument once the fluid sample has been processed. The method may further comprise removing the output vessel containing the processed fluid sample from the sample cartridge. The method may further comprising removing the temporary lid from the output vessel.

Some embodiments relate to a sample cartridge for use with a fluid analysis instrument, the cartridge comprising: a sample vessel configured to accommodate a fluid sample for analysis; a buffer solution vessel configured to accommodate a buffer solution; an analysis vessel configured to accommodate a mixed fluid comprising an aliquot of the fluid sample mixed with at least some of the buffer solution for analysis; a sample channel extending between the sample vessel and a first junction; a sample channel valve disposed in the sample channel to control flow of the sample through the sample channel; a buffer channel extending between the buffer solution vessel and the first junction; a buffer channel valve disposed in the buffer channel to control flow of the buffer solution through the buffer channel; a metering channel in fluid communication with the buffer channel and sample channel, the metering channel extending between the first junction and a second junction; an analysis vessel channel in fluid communication with the metering channel and extending between the second junction and the analysis vessel; and an analysis vessel pneumatic port in communication with the analysis vessel and configured to be connected to a pneumatic module to selectively adjust a pressure in the analysis vessel to draw fluid into the analysis vessel via the analysis vessel channel.

In some embodiments, at least one of the sample channel valve and the buffer channel valve comprises an active valve which can be selectively opened and closed to allow an aliquot of the fluid sample to be drawn into the metering channel, and to allow buffer solution to then be drawn through the buffer channel and through the metering channel and analysis vessel channel into the analysis vessel with the aliquot of the fluid sample for analysis. The analysis vessel may be preloaded with a dye configured to mix with the buffer solution and fluid sample to facilitate analysis.

The sample cartridge may further comprise: an intermediate outlet in fluid communication with the metering channel via the second junction; an outlet chamber into which the intermediate outlet opens; an air-permeable liquid barrier membrane covering the outlet; and an intermediate outlet pneumatic port in fluid communication with the outlet chamber and configured to be connected to a pneumatic module to selectively adjust a pressure in the outlet chamber to draw air through the air-permeable membrane from the metering channel, wherein the intermediate outlet is arranged such that liquid drawn into the metering channel from the sample channel or buffer channel is allowed to fill the metering channel, but is not allowed to progress into the analysis vessel channel. The intermediate outlet may be located at the second junction.

In some embodiments, the sample cartridge further comprises an outlet channel extending between the second junction and the outlet, such that liquid drawn into the metering channel from the sample channel or buffer channel is allowed to fill the metering channel and progress into the outlet channel, but is not allowed to progress into the analysis vessel channel.

The sample channel may further comprise: an output vessel in fluid communication with the metering channel via the second junction and via an output channel; and an output vessel pneumatic port in communication with the output vessel and configured to be connected to a pneumatic module to selectively adjust a pressure in the output vessel to draw fluid into the output vessel from the metering channel via the second junction and the output channel. The output channel may extend from the second junction to the output vessel. The output channel may extend between the intermediate outlet and the output vessel.

In some embodiments, the buffer channel valve comprises a pressure actuated valve including a buffer channel valve pneumatic port configured to be connected to a pneumatic module to selectively open or close the buffer channel valve.

Some embodiments relate to a fluid analysis instrument configured to receive a sample cartridge of any one of the described embodiments, the instrument comprising: a pneumatic module configured to connect to the analysis vessel pneumatic port and to selectively adjust a pressure in the analysis vessel to draw fluid into the analysis vessel via the analysis vessel channel; and an analysis module configured to measure a property of a fluid in the analysis vessel.

Some embodiments relate to fluid analysis instrument comprising the sample cartridge according to any one of the described embodiments, the instrument comprising: a pneumatic module connected to the analysis vessel pneumatic port and configured to selectively adjust a pressure in the analysis vessel to draw fluid into the analysis vessel via the analysis vessel channel; and an analysis module configured to measure a property of a fluid in the analysis vessel.

The analysis module may comprise an optical source configured to illuminate the fluid in the analysis vessel, and an optical detector configured to detect or measure light transmitted from the fluid in the analysis vessel.

In some embodiments, the pneumatic module is further connected to or configured to connect to the intermediate outlet pneumatic port and configured to selectively adjust a pressure in the outlet chamber to draw air through the air-permeable membrane from the metering channel. The pneumatic module may be further connected to or configured to connect to the output vessel pneumatic port and configured to selectively adjust a pressure in the output vessel to draw fluid into the output vessel from the metering channel via the second junction and the output channel. The pneumatic module may be further connected to or configured to connect to the buffer channel valve pneumatic port and to selectively open or close the buffer channel valve.

In some embodiments, the instrument is configured to receive a plurality of ones of the sample cartridge of any one of the described embodiments containing fluid samples.

The instrument may further comprise a mechanism and actuator configured to move the analysis module to various positions corresponding to respective ones of the sample cartridges for analysis of fluid in the analysis vessel of each sample cartridge.

Some embodiments relate to fluid analysis system comprising: the instrument of any one of the described embodiments; and one or more of the sample cartridge of any one of the described embodiments.

Some embodiments relate to method of operation of the fluid analysis instrument of any one of the described embodiments, containing a fluid sample in the sample vessel, the method comprising: operating the pneumatic module to draw sample fluid from the sample vessel through the sample channel and into the metering channel up to the second junction without the sample fluid progressing into the analysis vessel channel; and operating the pneumatic module to draw fluid from the buffer solution vessel through the buffer channel, metering channel and analysis channel into the analysis vessel along with an aliquot of the sample fluid from the metering channel.

The method may further comprise: operating the pneumatic module to reduce pressure in the analysis vessel during a predetermined period of time to draw sample fluid from the sample vessel through the sample channel and into the metering channel up to the second junction without the sample fluid progressing into the analysis vessel channel; and operating the pneumatic module to reduce pressure in the analysis vessel after the predetermined period to draw fluid from the buffer solution vessel through the buffer channel, metering channel and analysis channel into the analysis vessel along with an aliquot of the sample fluid from the metering channel.

In some embodiments, the method may further comprise: operating the pneumatic module to reduce pressure in the intermediate outlet to draw sample fluid from the sample vessel through the sample channel and into the metering channel until the sample fluid meets the air-permeable barrier; and subsequently operating the pneumatic module to reduce pressure in the analysis vessel to draw fluid from the buffer solution vessel through the buffer channel, metering channel and analysis channel into the analysis vessel along with an aliquot of the sample fluid from the metering channel.

The method may further comprise: operating the pneumatic module to reduce pressure in the output vessel during a predetermined period of time to draw sample fluid from the sample vessel through the sample channel and into the metering channel up to the second junction without the sample fluid progressing into the analysis vessel channel; and operating the pneumatic module to reduce pressure in the analysis vessel after the predetermined period to draw fluid from the buffer solution vessel through the buffer channel, metering channel and analysis channel into the analysis vessel along with an aliquot of the sample fluid from the metering channel. In some embodiments, the operation of the pneumatic module to draw fluid from the buffer solution vessel through the buffer channel, is continued until the metering channel is filled with air. The method may further comprise: subsequently operating the pneumatic module to reduce pressure in the output vessel to draw sample fluid from the sample vessel into the output vessel.

In some embodiments, the method further comprises: operating the pneumatic module to maintain the buffer valve in a closed state during the period in which fluid is drawn from the sample vessel; and subsequently operating the pneumatic module to maintain the buffer valve in an open state to allow fluid to be drawn from the buffer solution vessel.

Some embodiments relate to a method of operation of the fluid analysis instrument of any one of the described embodiments, accommodating one or more of the sample cartridges of any one of the described embodiments containing a fluid sample in the sample vessel of the or each sample cartridge, the method comprising: operating the pneumatic module to draw sample fluid from the sample vessel of the or each sample cartridge through the sample channel and into the metering channel up to the second junction without the sample fluid progressing into the analysis vessel channel; and subsequently operating the pneumatic module to draw fluid from the buffer solution vessel of the or each sample cartridge through the buffer channel, metering channel and analysis channel into the analysis vessel along with an aliquot of the sample fluid from the metering channel.

In some embodiments, the method further comprises: connecting the pneumatic module to the analysis vessel pneumatic port of the or each sample cartridge; operating the pneumatic module to reduce pressure in the analysis vessel of the or each sample cartridge during a predetermined period of time to draw sample fluid from the sample vessel through the sample channel and into the metering channel up to the second junction without the sample fluid progressing into the analysis vessel channel; and operating the pneumatic module to reduce pressure in the analysis vessel of the or each sample cartridge after the predetermined period to draw fluid from the buffer solution vessel through the buffer channel, metering channel and analysis channel into the analysis vessel along with an aliquot of the sample fluid from the metering channel.

The method may further comprise connecting the pneumatic module to the analysis vessel pneumatic port and intermediate outlet pneumatic port of the or each sample cartridge; operating the pneumatic module to reduce pressure in the intermediate outlet of the or each sample cartridge to draw sample fluid from the sample vessel through the sample channel and into the metering channel until the sample fluid meets the air-permeable barrier; and subsequently operating the pneumatic module to reduce pressure in the analysis vessel of the or each sample cartridge to draw fluid from the buffer solution vessel through the buffer channel, metering channel and analysis channel into the analysis vessel along with an aliquot of the sample fluid from the metering channel.

The method may further comprise: connecting the pneumatic module to the analysis vessel pneumatic port and output vessel pneumatic port of the or each sample cartridge; operating the pneumatic module to reduce pressure in the output vessel of the or each sample cartridge during a predetermined period of time to draw sample fluid from the sample vessel through the sample channel and into the metering channel up to the second junction without the sample fluid progressing into the analysis vessel channel; and operating the pneumatic module to reduce pressure in the analysis vessel of the or each sample cartridge after the predetermined period to draw fluid from the buffer solution vessel through the buffer channel, metering channel and analysis channel into the analysis vessel along with an aliquot of the sample fluid from the metering channel.

The operation of the pneumatic module to draw fluid from the buffer solution vessel through the buffer channel may be continued until the metering channel of the or each sample cartridge is filled with air.

In some embodiments, the method may further comprise: connecting the pneumatic module to the output vessel pneumatic port of the or each sample cartridge; and subsequent to drawing the buffer solution into the analysis vessel, operating the pneumatic module to reduce pressure in the output vessel of the or each sample cartridge to draw sample fluid from the sample vessel into the output vessel. The method further comprises: connecting the pneumatic module to the buffer valve pneumatic port of each of the or each sample cartridge; operating the pneumatic module to maintain the buffer valve of the or each sample cartridge in a closed state during the period in which fluid is drawn from the sample vessel; and subsequently operating the pneumatic module to maintain the buffer valve of the or each sample cartridge in an open state to allow fluid to be drawn from the buffer solution vessel.

The method may further comprise subsequently operating the analysis module to measure a property of the fluid in the analysis vessel.

The method may further comprise transmitting data relating to the measured property to an external computing device.

Some embodiments relate to a computer-readable storage medium storing instructions that, when executed by a computer, cause the computer to perform any one of the described methods.

Some embodiments relate to a method of use of any one of the described systems, the method comprising: depositing a fluid sample in the sample vessel of the or each sample cartridge; inserting the or each sample cartridge into a corresponding cartridge slot in the instrument; and operating the instrument to analyse the fluid sample. The method may further comprise removing the or each sample cartridge from the instrument once the fluid sample has been processed.

Some embodiments relate to a sample cartridge for use with a fluid analysis instrument comprising, the cartridge comprising: a sample vessel configured to accommodate a fluid sample for analysis; a buffer solution vessel configured to accommodate a buffer solution; a sealed analysis vessel configured to accommodate a mixed fluid comprising an aliquot of the fluid sample mixed with at least some of the buffer solution for analysis; a first channel extending between the sample vessel and the analysis vessel; a second channel extending from the buffer vessel to a junction with the first channel; a first valve disposed in the first channel between the sample vessel and the junction; a second valve disposed in the second channel between the buffer vessel and the junction; and a pneumatic port in communication with the analysis vessel and configured to be connected to a vacuum pump to draw fluid into the analysis vessel from the first channel, wherein at least one of the first valve and the second valve comprises an active valve which can be selectively opened and closed to allow an aliquot of the fluid sample to be drawn into the first channel and past the junction, and to allow buffer solution to then be drawn through the second channel and into the first channel past the junction, carrying and mixing with the aliquot of the fluid sample, and then flow into the analysis vessel for analysis.

Some embodiments relate to a chemical processing instrument configured to receive a sample cartridge containing a volume of at least 0.2 mL of a fluid sample, wherein the instrument is configured to be operated according to instructions stored on a computer-readable storage medium to perform any two or more of the following processing steps on the sample: processing the sample while maintaining the sample in isolation to avoid contamination of the instrument or cross-contamination with other samples; selecting nucleic acid using specific chemistries, incubation conditions, bead selection and elution parameters; selecting a desired range of single or double stranded nucleic acid sizes of a processed fluid product and discarding unwanted materials falling outside of the desired range; increasing a concentration of a selected nucleic acid product; and quantitating an aliquot of the processed fluid product, mixing with specific fluorochromes for the selected nucleic acid, and quantifying a property of the product, such as relative to a standard reference curve or a calibrated reference curve.

Some embodiments relate to a kit comprising a sample cartridge according to any one of the described embodiments, and a temporary lid configured to close the output vessel during processing, the temporary lid being configured to fluidly connect the final output channel and output vessel pneumatic channel to the output vessel. The kit may further comprise an output vessel, such as an Eppendorf tube, for example.

The temporary lid may be configured to be mechanically coupled to the cartridge by a resiliently flexible body. The body may be integrally formed with the temporary lid. The body may be configured to urge the output vessel against the cartridge when connected. The body may define channels to fluidly connect the he final output channel and output vessel pneumatic channel to the output vessel.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Various ones of the appended drawings merely illustrate example embodiments of the present disclosure and cannot be considered as limiting its scope.

FIG. 1A is a schematic of an instrument configured to receive one or more sample cartridges each containing a sample for processing, according to some embodiments;

FIG. 1B is a perspective view of the instrument of FIG. 1A, according to some embodiments;

FIG. 1C is a cut-away perspective view illustrating some of the internal components of the instrument of FIG. 1A, according to some embodiments;

FIG. 2A is a perspective view of a sample cartridge for use an instrument, according to some embodiments;

FIG. 2B is a top view of the sample cartridge of FIG. 2A;

FIG. 2C is a side view of the sample cartridge of FIG. 2A;

FIG. 2D is a bottom view of the sample cartridge of FIG. 2A;

FIG. 2E is a bottom view of the sample cartridge of FIG. 2A illustrating further details;

FIG. 2F is a bottom view of a fluid metering arrangement, according to some embodiments, which may form part of the sample cartridge of FIG. 2A;

FIG. 2G is a circuit diagram of the sample cartridge of FIG. 2A, according to some embodiments;

FIGS. 2H and 2I are perspective views illustrating alternative channel arrangements for the sample cartridge of FIG. 2A, according to some embodiments;

FIGS. 2J to 2N illustrate alternative valves for the sample cartridge of FIG. 2A, according to some embodiments;

FIG. 2O is a close-up perspective view of an intermediate outlet of the sample cartridge, according to some embodiments;

FIG. 3A is a perspective view of a reagent module of the instrument of FIGS. 1A to 1C, according to some embodiments;

FIG. 3B is a perspective view of a reagent cartridge of the reagent module of FIG. 3A;

FIGS. 4A and 4B are schematics of an optics module of the instrument of FIGS. 1A to 1C, according to some embodiments;

FIG. 5A is a schematic of the instrument of FIGS. 1A to 1C showing parts of a pneumatic module, thermal module, magnetic module, mixing module and motion module, according to some embodiments;

FIG. 5B is a side view of the instrument of FIGS. 1A to 1C showing parts of a thermal module, magnetic module, mixing module and motion module, according to some embodiments; and

FIG. 5C is a perspective view of a core unit of the instrument according to some embodiments;

FIG. 5D is a close-up perspective view of a pneumatic interface plate of the core unit of FIG. 5C;

FIG. 5E illustrates internal components of the core unit with other components omitted for clarity;

FIG. 5F is a perspective view of the sample cartridge of FIG. 7A installed in a socket of the core unit of FIG. 5C and the heating assembly engaging the sample cartridge;

FIG. 6 is a schematic diagram of a control module of the instrument of FIGS. 1A to 1C, according to some embodiments;

FIG. 7A is a perspective view of a sample cartridge, according to some embodiments;

FIG. 7B is a bottom perspective view of the sample cartridge of FIG. 7A;

FIG. 7C is an exploded assembly view of the sample cartridge of FIG. 7A;

FIG. 7D is a close up exploded view of the base and pneumatic channel plate of the sample cartridge of FIG. 7A;

FIG. 7E is a lower perspective view of the base and pneumatic channel plate of the sample cartridge of FIG. 7A;

FIG. 7F is a bottom view cross-section of a top portion of the base of the sample cartridge of FIG. 7A;

FIG. 7G is a bottom view of the base of the sample cartridge of FIG. 7A;

FIG. 7H is a bottom view of a base membrane of the sample cartridge of FIG. 7A;

FIG. 7I is a bottom view of a PSA layer of the sample cartridge of FIG. 7A;

FIG. 7J is a bottom view cross-section of a top portion of the pneumatic channel plate of the sample cartridge of FIG. 7A;

FIG. 7K is a bottom view of the pneumatic channel plate of the sample cartridge of FIG. 7A;

FIG. 7L is a superimposed view of FIGS. 7H and 7J;

FIG. 7M is a vertical cross-section of part of the sample cartridge of FIG. 7A;

FIG. 7N is a cross-section of a bottom portion of a primary reaction vessel of the sample cartridge of FIG. 7A;

FIG. 7O is a close-up perspective cross-section of a top portion of the primary reaction vessel of the sample cartridge of FIG. 7A;

FIG. 7P is a cross-section of the lid of the primary reaction vessel of the sample cartridge of FIG. 7A;

FIG. 7Q is a close-up of the secondary reaction vessel shown in FIG. 7M;

FIG. 7R is a perspective view of an alternative top portion of the secondary reaction vessel;

FIG. 7S is a close-up assembly view of part of the sample cartridge of FIG. 7A;

FIG. 7T is a perspective view of a waste fluid trap and primary fluid trap of the sample cartridge of FIG. 7A;

FIG. 7U is a perspective view of a secondary fluid trap of the sample cartridge of FIG. 7A;

FIG. 7V is a close-up assembly view of another part of the sample cartridge of FIG. 7A;

FIG. 7W is a close-up assembly view of an intermediate outlet and gas permeable membrane of the sample cartridge of FIG. 7A;

FIG. 7X is a perspective cross-section of the assembled intermediate outlet and gas permeable membrane of the sample cartridge of FIG. 7A;

FIG. 7Y is a bottom view of a welding pattern for the base membrane of the sample cartridge of FIG. 7A;

FIG. 7Z is a close-up bottom view of a metering channel and microfluidic junctions of the sample cartridge of FIG. 7A;

FIG. 8A is a perspective view of a fluid transfer apparatus, according to some embodiments;

FIG. 8B is a perspective view of the fluid transfer apparatus of FIG. 8A installed on the sample cartridge of FIG. 7A; and

FIG. 8C is a close-up cross-sectional perspective view of the connection between the fluid transfer apparatus and sample cartridge.

### DESCRIPTION OF EMBODIMENTS

Embodiments generally relate to systems, instruments, methods and computer-readable media for performing operations on samples, such as nucleic acid extraction operations and the like.

There are many chemical process workflows involving several steps that conventionally require transfer of a fluid sample to different vessels and/or different instruments. At each transfer step, there is a possibility of spillage of the sample, contamination of instruments with the sample, and potentially cross-contamination with other samples for processing.

Some embodiments relate to a sample cartridge for a chemical processing instrument, which facilitates workflow processes that isolate the sample and mitigate against cross-contamination. The sample cartridge comprises a primary reaction vessel, arranged to receive a lid, and a reagent vessel. The primary reaction vessel and the reagent vessel are connected or in fluid communication via a primary reagent channel. The primary reagent channel may have a primary reagent valve disposed in the primary reagent channel to control fluid flow through the primary reagent channel. A primary pneumatic port is in fluid communication with the primary reaction vessel and is configured to be connected to a pneumatic module. By using the pneumatic module to selectively adjust a pressure within the primary reaction vessel when the lid is closed, the fluid contents of the reagent vessel can be drawn into the primary reaction vessel.

The sample cartridge may further comprise a primary pneumatic channel extending between the primary pneumatic port and the primary reaction vessel, wherein an opening of the primary pneumatic channel into the primary reaction vessel is located part way up a sidewall of the primary reaction vessel. The opening of the primary pneumatic port into the primary reaction vessel may be located nearer to the top of the primary reaction vessel than the bottom of the primary reaction vessel. This may reduce the likelihood of the liquid specimen being aspirated into the pneumatic module and potentially contaminating the instrument.

In some embodiments, an opening of the primary reagent channel into the primary reaction vessel is located part way up a sidewall of the primary reaction vessel. In some embodiments, the opening of the primary reagent channel into the primary reaction vessel is located nearer to the top of the primary reaction vessel than to the bottom of the primary reaction vessel. This may reduce the likelihood of the liquid specimen entering the reagent channel and subsequently the reagent vessel, which might otherwise lead to cross-contamination in the instrument.

Various other features are described below, according to some embodiments, which further mitigate against cross-contamination, including sealed vessels for processing of the sample, separate open vessels for receiving reagents, one way valves and a pneumatic system for driving fluid flow which allows for the reaction vessels to be sealed.

There are also many chemical processing workflows which require quantitation of an aliquot of a fluid sample for analysis or measurement of one or more properties of the fluid sample, such as for quality control, for example.

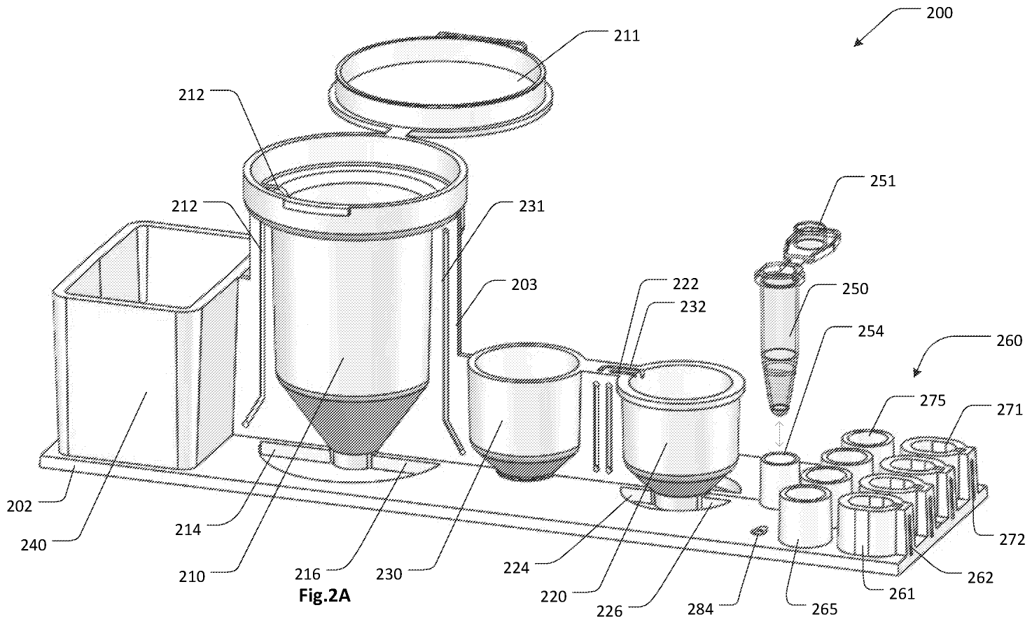

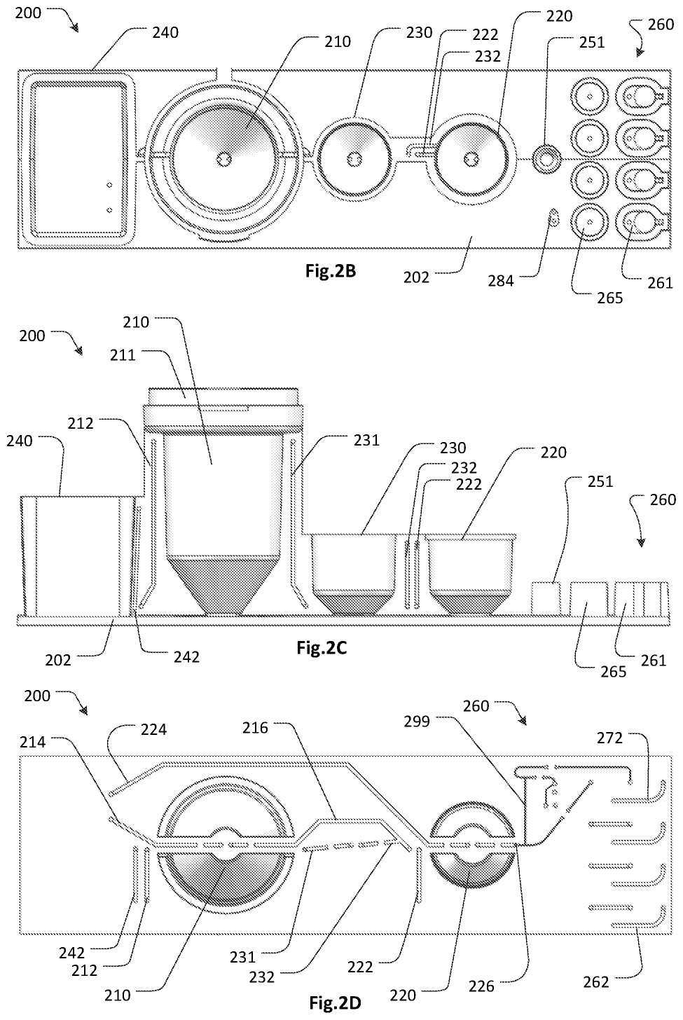

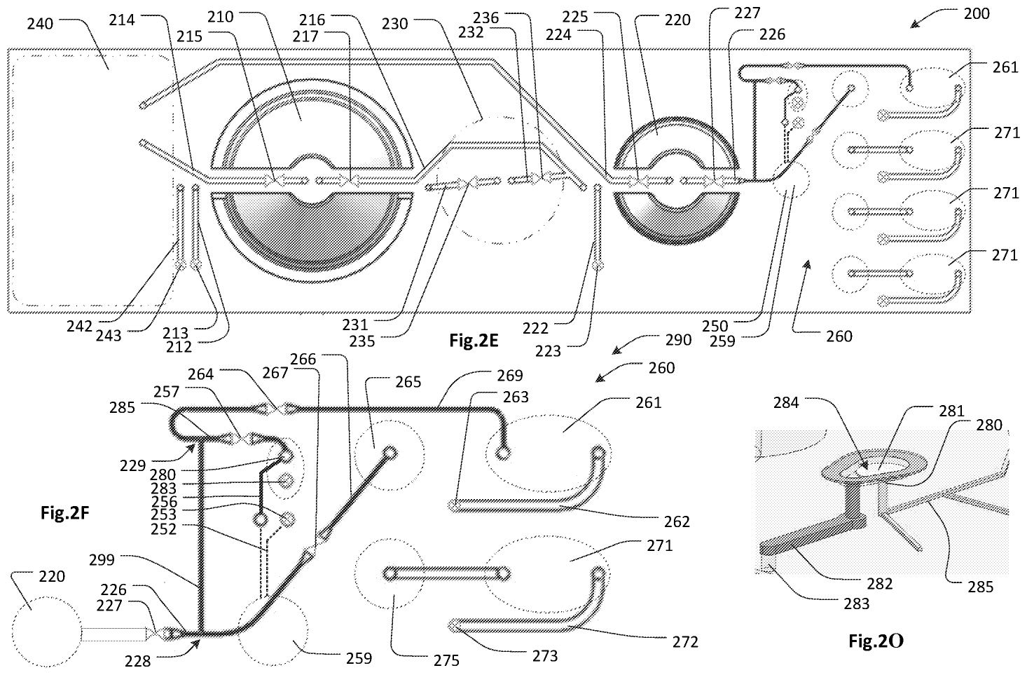

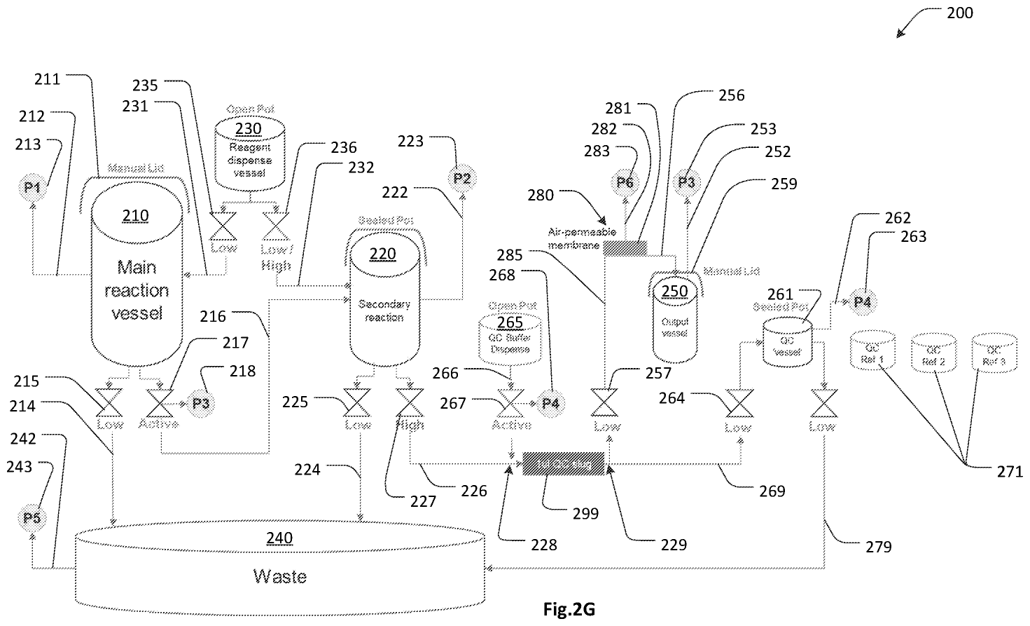

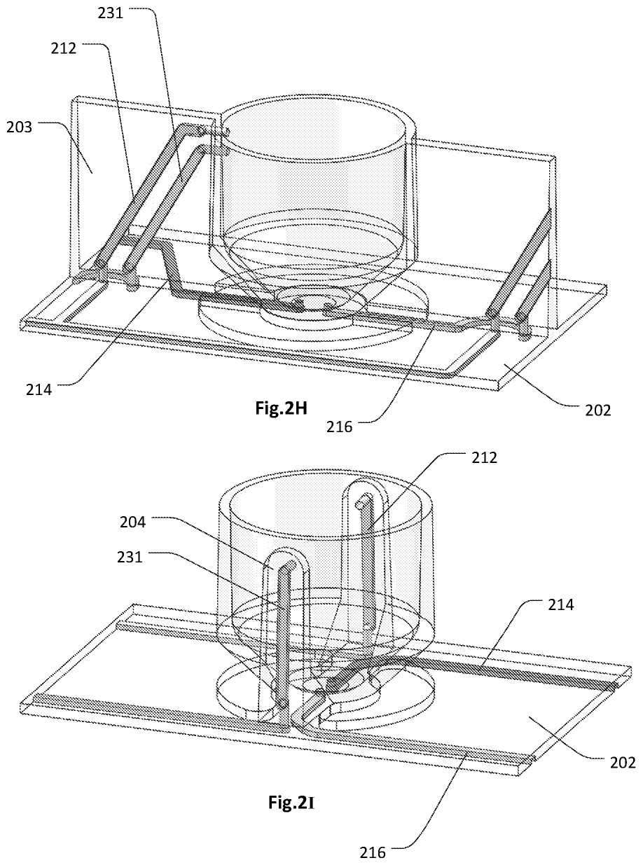

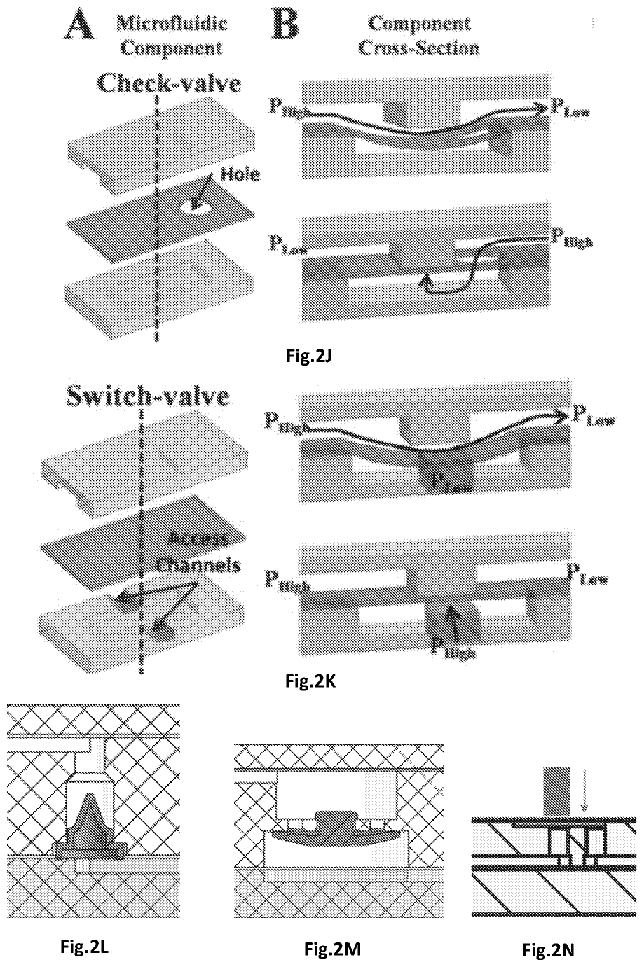

Some embodiments relate to an arrangement of channels and valves which allow precise fluid metering for isolating an aliquot of known volume for analysis or quality control, as described below in relation to FIGS. 2E to 2G. This arrangement may be included on a sample cartridge for use in an instrument, or even on a dedicated fluid analysis instrument.

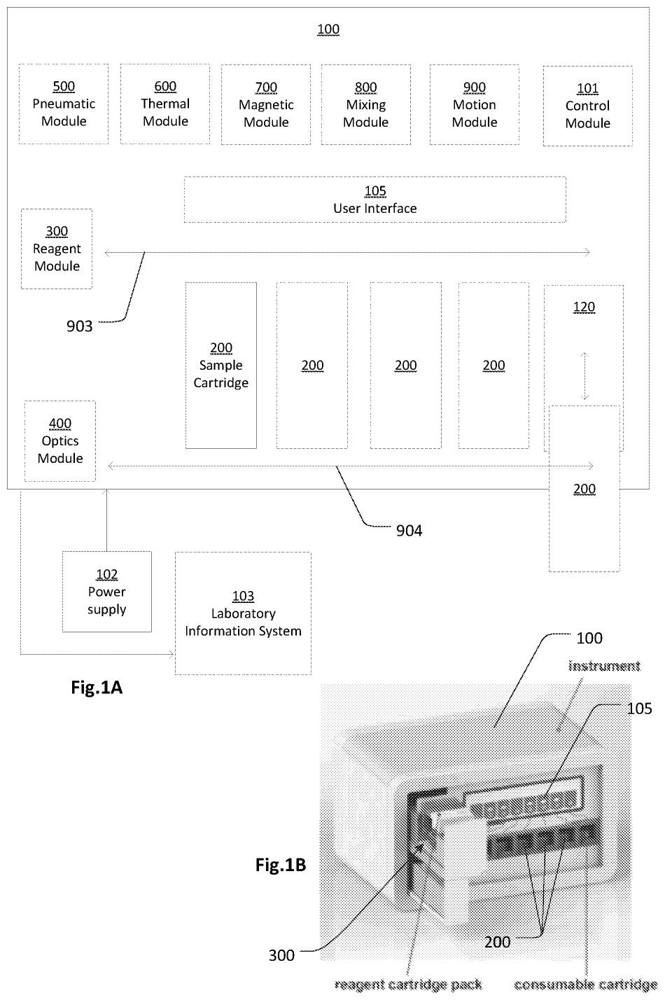

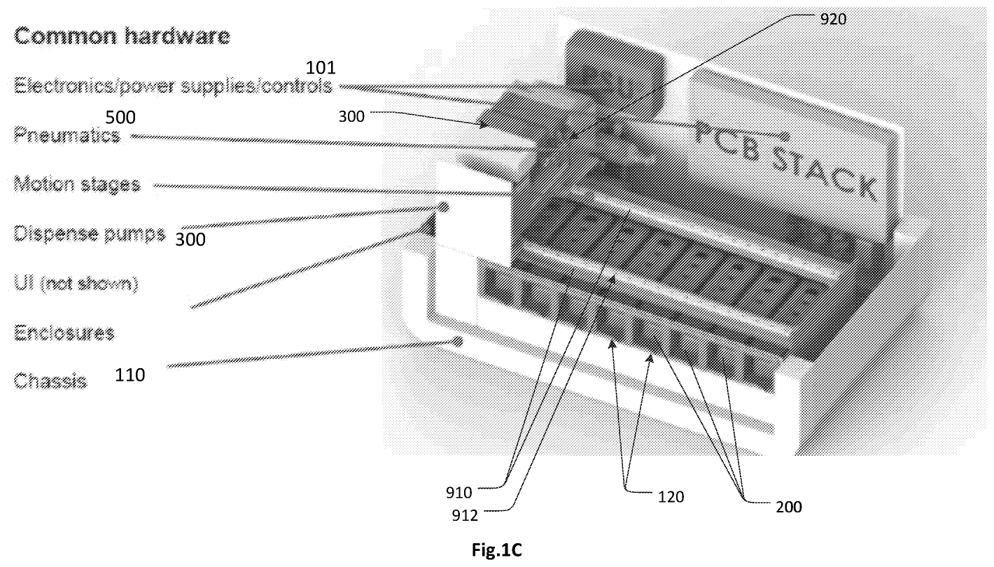

Referring first to FIG. 1A to 1C, an instrument 100 is shown, according to some embodiments. The instrument 100 may be configured to receive one or more sample cartridges 200, each containing a sample for processing. The instrument 100 may be configured to perform one or more operations on the sample, such as: chemical processing steps, heating, cooling, culturing, mixing, analysis or measurement. The instrument 100 may be configured to perform a plurality of operations on the sample which might conventionally be performed in separate instruments or manually in a laboratory.

In some embodiments, the instrument 100 may be configured to perform one or more nucleic acid extraction operations on the sample. For example, to extract nucleic acid (e.g., DNA or RNA) from a patient sample and provide a concentrated and, optionally, quantified output fluid containing nucleic acid from the sample.

The instrument 100 may comprise various different modules configured to perform the operations on the sample. These may include any one or more selected from the following group: reagent module 300, optics module 400, pneumatic module 500, thermal module 600, magnetic module 700, mixing module 800, motion module 900 and control module 101 to control the operations performed by the instrument 100. The instrument 100 may also have a power supply 102 or be connected to a power supply 102 to power the various modules.

The reagent module 300 may be configured to dispense selected reagents into the sample cartridges 200. For example, the reagent module 300 may comprise a plurality of reservoirs respectively containing a corresponding plurality of reagents for use in the operations of the instrument workflows. The reagent module 300 may comprise one or more pumps, channels and dispensing nozzles to selectively dispense controlled amounts of the reagents into a selected sample cartridge 200 at a selected time as part of one or more of the instrument workflows.

For example, the reagent module 300 may comprise a syringe pump configured to control dispensing of the reagents. The reagent module may comprise two dispense nozzles, each configured to dispense different reagents at different times. Previous reagents may be flushed out of the nozzle before dispensing subsequent reagents into the cartridge. In some embodiments, the instrument may comprise a waste receptacle and the reagent module may be configured to dispense some reagents into the waste receptacle to flush out previous reagents from the nozzles before dispensing into the cartridges.

In some embodiments, the reagent module 300 may comprise a sensor configured to detect the presence or absence of liquid in part of the reagent module. For example, the sensor may be configured to monitor the dispensing outlet, or a dispensing outlet tube to indicate or confirm when reagents are being dispensed via the outlet tube. In some embodiments, multiple sensors may be configured to monitor multiple different fluid lines within the reagent module, and/or fluid levels in the reagent reservoirs.

The or each sensor may comprise an optical sensor, such as a light source and light detector arranged to detect light from the light source passing through (or reflecting off of) a translucent or transparent wall of the fluid line or reservoir.

The sensor or sensors of the reagent module may be connected to the user interface or to indicator LEDs, for example, to confirm priming of the reagent lines; confirm when reagents are being dispensed; or to indicate when reagents are exhausted, or will be in the near future and need to be replaced.

The tubing used for the reagent lines within the reagent module may comprise any suitable materials, such as silicon tubing or PTFE tubing, for example. Any suitable dimensions of tubing may be chosen depending on the liquids to be dispensed for a particular application. For example, the inner diameter may be about 0.3 mm and the outer diameter may be about 1.6 mm.

The optics module 400 may comprise optical sensors or detectors for optical inspection of materials or fluids contained within the sample cartridges 200. The optics module 400 may further comprise one or more optical sources to illuminate the materials or fluids contained within the sample cartridges 200 for inspection. The optics module 400 may be configured to detect and/or measure certain frequencies and/or intensities of light in the optical or near optical spectrum in order to determine certain properties of the materials or fluids contained within the sample cartridges, such as concentration or density for example.

For example, the optics module may comprise an epifluorescent system including a UV LED light source, which transmits light through a band pass filter, excites fluorescence in dye within the cartridge and causes an emission from the dye which is detected by a photodiode.

The pneumatic module 500 may be configured to apply pressure differences across certain flow paths of the sample cartridges 200 or instrument 100 to drive fluid flow along those flow paths.

The pneumatic module may be configured to move liquids between the various vessels of the cartridge using positive pressure or negative pressure. That is, applying positive pressure (above atmospheric pressure) in one vessel to push liquid through the transfer channels into another vessel, or applying negative pressure (below atmospheric pressure) to one vessel to draw liquid through the transfer channels from another vessel.

In some embodiments, the pneumatic module may be configured to operate using a single pressure level selectively applied to the various pneumatic ports at different times to affect different operations. In some embodiments, the pneumatic module may be configured to operate using only two pressure levels selectively applied to the various pneumatic ports at different times to affect different operations.

For example, two pressure levels may be required if the cartridge comprises pressure actuated valves that require a higher pressure than the driving pressure for transferring liquids through the channels.

Any suitable pressure difference (e.g., vacuum pressure) may be used to drive flow in the cartridge, though it should be noted that too little pressure may result in particularly long liquid transfer times, and too greater pressure gradient may result in splashing or sputtering, which may be undesirable in certain applications, or high shear rates in the liquid flow, which could potentially be damaging to certain molecules, such as nucleic acid, for example. The suitable vacuum pressure will also depend on the viscosity or range of viscosities of liquids used in a given application. In some embodiments, the driving vacuum pressure may be in the range of 50 mBar to 500 mBar, 80 mBar to 300 mBar, 100 mBar to 200 mBar, 100 mBar to 120 mBar, about 100 mBar or about 120 mBar, for example.

The thermal module 600 may comprise one or more heating or cooling elements configured to control and/or adjust the temperature of the sample cartridges 200 and materials contained therein during different operations of the instrument workflows, such as incubation for culturing, for example.

The magnetic module 700 may comprise one or more permanent magnets or electromagnets configured to control movement of magnetic beads in the sample cartridges 200. For example, magnetic beads may be used in a primary reaction vessel 210 (FIG. 2A) for components of the sample to bind to during certain operations of the instrument workflows. The magnetic module 700 may be configured to hold the magnetic beads in position while liquids are drained away from the magnetic beads.

Alternatively, non-magnetic functionalised beads may be used for binding, and a filter may be used to restrict the beads from leaving the reaction vessels. Another alternative would be to use a porous material such as a frit with a functionalised surface for binding, and the liquids could be drawn through the frit to achieve the desired reactions.

In other embodiments, chemical catalysts or reactants may be provided as coatings on the surface of solid structures such as beads or porous solids for reaction with liquids in the reaction vessels.

The mixing module 800 may be configured to promote mixing of fluids in the primary and/or secondary reaction vessels 210, 220 (FIG. 2A) during certain operations of the instrument work flows. For example, the mixing module 800 may comprise an orbital shaker, such as an eccentric weight configured to be rotated by a motor.

The motion module 900 may comprise one or more motors or actuators configured to move certain modules to different positions corresponding to the cartridge slots 120 to perform operations on the corresponding cartridges 200 (and/or samples therein) at different times. For example, the reagent module 300 and optics module 400 may be moved to different cartridge positions to perform operations on the corresponding cartridges 200 at those positions.

The control module 101 may comprise electronics hardware in communication with the other modules of the instrument 100, and software configured to control operations of the instrument modules according to a selected instrument workflow.

Each of the modules is described further below, according to some embodiments.

The instrument 100 may be configured to be connected to an external computer system such as a laboratory information system 103. The instrument 100 may be configured to transmit data to the external laboratory information system 103, such as analysis or measurement data relating to the sample in the sample cartridge 200. In some embodiments, the instrument 100 may be configured to receive information from and external laboratory information system, such as data relating to the sample, reference data for comparison, or commands to control operations of the instrument 100.

In some embodiments, the instrument 100 may comprise a user interface 105. The user interface 105 may comprise a display on the instrument 100 itself, or an external display in communication with the instrument 100. The user interface 105 may be configured to allow a user to select a workflow program to perform on a sample in a sample cartridge 200. The workflow program may be selected from a list of different programs comprising different workflow operations configured to achieve different processes.

For example, the list of workflow programs may include: the extraction, isolation, enrichment, concentration or quantification of naturally or non-naturally occurring nucleic acids including, for example, DNA (such as genomic DNA, rearranged immunoglobulin or TCR DNA, cDNA, cfDNA) and RNA (such as mRNA, primary RNA transcript, transfer RNA or microRNA). Non-naturally occurring nucleic acids which one might seek to isolate include glycol nucleic acid, threose nucleic acid, locked nucleic acid and peptide nucleic acid. Other workflow programs may include the preparation of nucleic acid for amplification (eg. PCR library preparation) or any other type of manipulation or analysis, such as sequencing or the insertion into a vector for applications such in vitro transcription and/or translation.

The user interface 105 may also display information relating to the sample, and/or an indication of which workflow program or particular step of a workflow program is currently in progress.

The instrument 100 may comprise a chassis or housing 110 to accommodate some or all of the modules. In some embodiments, the housing 110 may be configured to be stackable with other ones of the instrument 100 so that multiple ones of the instrument 100 can be stacked vertically or arranged side by side in a laboratory, for example.

The instrument 100 may comprise a plurality of cartridge slots or sockets 120, each configured to receive a corresponding sample cartridge 200. In this way, multiple samples may be processed concurrently. The cartridge slots 120 may be at least partly defined by external openings in the housing 110 configured to receive the sample cartridges 200.

Some of the modules may have dedicated components for each cartridge socket 120. Some of the modules may act on all of the cartridges 200 in the cartridge slots 120 simultaneously. Some of the modules may be configured to act on different cartridges 200 in the cartridge slots 120 at different times.

Referring to FIG. 1C, a cutaway view of the instrument 100 is shown, illustrating part of the motion module 900, according to some embodiments. A plurality of sample cartridges 200 are shown disposed in a corresponding plurality of cartridge slots 120. The cartridges 200 and cartridge slots 120 are arranged in parallel, extending across part of the instrument 100.

The motion module 900 may comprise a track 910 extending across the plurality of cartridge slots 120, and a carriage 920 configured to move along the track 910. The carriage 920 may be configured to carry one or more of the modules, such as the reagent module 300 and optics module 400, and move them to different cartridge positions to perform operations on the sample cartridges 200. An actuator, such as a motor, operated by the control module 101 may be configured to move the carriage 920 between a rest position and the various cartridge positions.

In some embodiments, the motion module 900 may comprise a plurality of carriages 920 and corresponding tracks 910, each configured to carry a different module, such as the reagent module 300 and optics module 400, for example.

The track 910 may include motion stages 912, which may comprise markings or other indicia, specifying a plurality of carriage positions corresponding to cartridge positions which appropriately align the carriage module(s) with the cartridge slots 120 and corresponding sample cartridges 200 to allow the module(s) to perform operations on selected sample cartridges 200. The motion module 900 may comprise one or more sensors disposed on the carriage 920 configured to detect the indicia signalling for the carriage 920 to be stopped at a selected carriage position. Alternatively, known actuator states (e.g., angle of a stepper motor) corresponding to specific carriage positions may be selected to move the carriage to a selected carriage position.

Referring to FIGS. 2A to 2N a sample cartridge 200 is shown, according to some embodiments. The sample cartridge 200 comprises a base 202, a primary reaction vessel 210, a reagent vessel 230, and an output vessel 250. The sample cartridge 200 may comprise different features for different applications, depending on the operations to be performed on the sample.

In some embodiments, the sample cartridge 200 may further comprise an optional secondary reaction vessel 220, as shown in FIG. 2A and described further below.

In some embodiments, the sample cartridge 200 may further comprise an optional waste vessel 240, as shown in FIG. 2A and described further below.

In some embodiments, the sample cartridge 200 may further comprise an optional quality control module 260, as shown in FIG. 2A and described further below.

The sample cartridge 200 defines channels connecting the various vessels (the primary reaction vessel 210, reagent vessel 230, and output vessel 250, and in some embodiments, optional secondary reaction vessel 220, optional waste vessel 240, optional quality control module 260), such that the vessels are in fluid communication and fluids (including liquids and potentially liquid slurries containing solids) can be exchanged between the vessels. The sample cartridge 200 may include valves to selectively allow or disallow flow through the channels, and allow control of fluid exchange between the vessels. The network of valves and channels are described further below, according to some embodiments.

In some embodiments, the vessels (including the primary reaction vessel 210, reagent vessel 230, output vessel 250, and optional secondary reaction vessel 220, waste vessel 240, and quality control module 260) may be integrally formed with the base 202.

In some embodiments, the output vessel 250 may comprise a separate removable component, such as an Eppendorf tube, for example. This may allow a final output liquid to be readily removed from the cartridge 200 in a sealed vessel 250 for further processing or use elsewhere.

The sample cartridge 200 may define an output vessel holder or seat 254, which may be integrally formed with the base 202. The output vessel 250 may be seated in the seat 254 during processing in the instrument 100. When a selected instrument workflow is complete, and an output fluid has been deposited in the output vessel 250, the output vessel 250 may be sealed and removed from the seat 254, and the rest of the sample cartridge 200 may be discarded.

Referring FIG. 2G, a flow circuit diagram of the sample cartridge 200 is shown with optional additional features, according to some embodiments. The network of channels and valves of the sample cartridge 200 will be described with reference to a simple workflow, though it will be understood that many different workflows may be performed on or in the cartridge 200.

A liquid sample may be introduced to the primary reaction vessel 210 and a lid 211 used to seal the sample within the primary reaction vessel 210. The lid 211 may be integrally formed with the primary reaction vessel 210 as shown in FIG. 2A, for example.

One or more reagents may be dispensed (e.g., from the reagent module 300) into an open top of the reagent vessel 230. A primary reagent channel 231 extends between the reagent vessel 230 and the primary reaction vessel 210. Reagents may be delivered from the reagent vessel 230 to the primary reaction vessel 210 via the primary reagent channel 231.

A primary reagent valve 235 may be disposed in the primary reagent channel 231 to control flow through the primary reagent channel 231. The primary reagent valve 235 may comprise an active valve (examples of which are discussed below), or a passive valve. For example, the primary reagent valve 235 may comprise a low pressure valve, which has a relatively low cracking pressure in comparison with certain other valves in the network. That is, the valve may restrict flow until a relatively low threshold pressure difference exists across the valve, at which point the primary reagent valve 235 will open and fluid will be allowed to flow through the primary reagent channel 231 from the reagent vessel 230 to the primary reaction vessel 210.

A driving pressure gradient may be created using the pneumatic module 500. The cartridge 200 may comprise a primary pneumatic channel 212 extending between the primary reaction vessel 211 and a primary pneumatic port 213. The primary pneumatic port 213, along with other pneumatic ports described below, may be defined by openings in an external surface of the sample cartridge 200, such as a bottom surface or side surface of the base 202, and configured to engage with pneumatic connectors 510 in the instrument 100 to connect the pneumatic port 213 to the pneumatic module 500.

The pneumatic module 500 may comprise a plate defining a plurality of pneumatic ports, each connected to a pressure control manifold by a pneumatic line. Each pneumatic port may include a seal and be configured to connect to a corresponding port on the underside of the cartridge base 202. The plate may be configured to be moved upwards by the motion module to meet the cartridge once the cartridge is installed in the instrument, such that the corresponding ports are connected to connect the pneumatic module to the channels in the cartridge, so that they are in fluid communication.

With the lid 211 sealed, when the pneumatic module 500 applies a negative or vacuum pressure to the pneumatic port 213 (negative relative to atmospheric or ambient pressure), a pressure gradient is created between the primary reaction vessel 210 and the reagent vessel 230 so that reagents can be drawn from the reagent vessel 230 through the primary reagent channel 231 and into the primary reaction vessel 210 and the sample contained therein.

The primary reagent valve 235 may remain closed and restrict flow in the primary reagent channel 231 until it is activated to open, or until the threshold cracking pressure is overcome by the pressure applied to the pneumatic port 213 by the pneumatic module 500. The primary reagent valve 235 may comprise a check valve configured to restrict or prevent back flow, to avoid part of the fluid sample in the primary reaction chamber 210 flowing into the reagent vessel 230.

In order to avoid aspiration of part of the contents of the primary reaction vessel 210 into the primary pneumatic channel 212, an opening of the primary pneumatic channel 212 into the primary reaction vessel 210 may be defined part way up a sidewall of the primary reaction vessel 210 or at or near a top of the primary reaction vessel 210, as shown in FIG. 2A. The primary pneumatic channel 212 may be defined in a structure extending up the side of the primary reaction vessel 210 either within or alongside the sidewall of the primary reaction vessel 210, as shown in FIG. 2A.

In some embodiments, the primary reagent channel 231 may also extend upwards alongside the sidewall and open into the primary reaction vessel 210 at or near the top of the primary reaction vessel 210, as shown in FIG. 2A. This may further reduce the likelihood of part of the fluid sample flowing from the primary reaction vessel 210 into the primary reagent channel 231 or reagent vessel 230.

Alternative designs for incorporating a pneumatic channel and input channel of either of the reaction vessels 210, 230 into the sample cartridge 200 are shown in FIGS. 2H and 2I. For example, the channels may be formed as open channels in the base 202 and in a flat perpendicular web 203, as shown in FIG. 2H. Alternatively, the channels may be formed as open channels in side structures 204 extending up alongside the reaction vessel 210, 230, as shown in FIG. I. The channels may then be closed by covering them with a foil or film, which may be adhesively bonded or welded to the base 202 and the web 203 or side structure 204.

If the instrument workflow includes operations that require the removal of waste fluid from the primary reaction vessel 210, then the sample cartridge 200 may comprise a waste vessel 240. Alternatively, the instrument 100 may comprise a waste receptacle or waste channel to dispose of waste fluid externally.

The sample cartridge 200 may comprise a primary waste channel 214 extending between the primary reaction vessel 210 and the waste vessel 240 (or other waste channel or receptacle). A primary waste valve 215 may be disposed in the primary waste channel 214 to control when fluid is removed from the primary reaction vessel 210 through the primary waste channel 214. For example, the primary waste valve 215 may comprise a low pressure valve with a relatively low cracking pressure.

The sample cartridge 200 may further comprise a waste pneumatic channel 242 extending between the waste vessel 240 and a waste pneumatic port 243. The waste pneumatic channel 242 may also open into the waste vessel 240 at or near a top of the waste vessel 240 to avoid aspiration of waste fluid into the waste pneumatic channel 242. The top of the waste vessel 240 may be sealed with a lid or foil, for example.

In some embodiments, depending on which liquids are required to be transferred between the vessels 210, 220, 230, 240, some splashing may occur, and small volumes of liquids may splash into the pneumatic channels 212, 222, 242. If liquids are aspirated through the pneumatic channels they may pass out of the cartridge and into the pneumatic module 500, thereby contaminating the instrument.

In order to mitigate against this scenario, the cartridge may include liquid traps associated with one or more (or each) of the pneumatic channels to prevent or restrict liquids leaving the cartridge via the pneumatic channels. For example, the liquid traps may comprise gas permeable membranes which allow passage of air but restrict or stop the passage of liquids. The gas permeable membranes may be located at any position along the pneumatic channels 212, 222, 242, such as at the openings, or at an end of each pneumatic channel at the base of the cartridge, for example.

In some embodiments, the gas permeable membranes may be disposed over a relatively large area (larger than a cross-section of the corresponding channel) in order to increase the capacity of trapped liquid that can be present before blocking the flow of gas through the membranes. The instrument may be configured to detect pressure changes due to one of the channels or liquid traps being blocked, and subsequently trigger an end to workflow operations and an indication that the process has failed, for example.

The sample cartridge 200 may further define a primary output channel 216 to allow the discharge of an output fluid from the primary reaction chamber 210. In some embodiments, if only one reaction vessel is required, the primary output channel 216 may lead directly to the output vessel 250. In some embodiments, if a secondary reaction vessel is required, the primary output channel 216 may extend between the primary reaction vessel 210 and the secondary reaction vessel 220.

A primary outlet valve 217 may be disposed in the primary outlet channel 216 to control the discharge of output fluid through the primary output channel 216. For example, the primary outlet valve 217 may comprise an active pressure actuated valve operated by applying pressure to a corresponding primary outlet valve pneumatic port 218.

In embodiments where the sample cartridge 200 comprises a secondary reaction vessel 220, sample cartridge 200 may comprise a secondary reagent channel 232 extending between the reagent vessel 230 and the secondary reaction vessel 220.

A secondary reagent valve 236 may be disposed in the secondary reagent channel 232 to control flow of reagents through the secondary reagent channel 232. For example, the secondary reagent valve 236 may comprise a high pressure valve with a relatively high cracking pressure compared with other valves in the sample cartridge 200.

The sample cartridge 200 may comprise a secondary pneumatic channel 222 extending between the secondary reaction vessel 220 and a secondary pneumatic port 223. The secondary pneumatic channel 222 may open into the secondary reaction vessel 220 at or near a top of the secondary reaction vessel 220. The top of the waste vessel 240 may be sealed with a lid or foil, for example.

Reagents may be drawn from the reagent vessel 230 into the secondary reaction vessel 220 via the secondary reagent channel 232 by applying a negative vacuum pressure to the secondary pneumatic port 223 to create a pressure difference across the secondary reagent valve 236 sufficient to overcome the relatively high cracking pressure. During this flow, the primary output valve 217 may be closed to avoid flow through the primary outlet output 216.

On the other hand, when flow of the output fluid is required from the primary reaction vessel 210 to the secondary reaction vessel 220, the primary output valve 217 may be opened and a vacuum pressure may be applied to the secondary pneumatic port 223 which to create a pressure difference which is sufficient to drive flow through the primary output channel 216, but not sufficient to overcome the relatively high cracking pressure of the secondary reagent valve 236. The primary output channel 216 may open into the secondary reaction vessel 220 at or near the top of the secondary reaction vessel 220.

The sample cartridge 200 may comprise a secondary waste channel 224 extending between the secondary reaction vessel 220 and the waste vessel 240 (or other waste channel or receptacle). A secondary waste valve 225 may be disposed in the secondary waste channel 224 to control when fluid is removed from the secondary reaction vessel 220 through the secondary waste channel 224. For example, the secondary waste valve 225 may comprise a low pressure valve with a relatively low cracking pressure. In some embodiments, a secondary waste channel 224 may not be required. That is, if there are no waste fluids to be removed from the secondary reaction vessel 220.

The sample cartridge 200 may further define a secondary output channel 226 to allow the discharge of an output fluid from the secondary reaction chamber 220. In some embodiments, if no quality control is required, the secondary output channel 226 may lead directly to the output vessel 250. In some embodiments, if quality control is required, the secondary output channel 226 may extend between the secondary reaction vessel 220 and the quality control module 260.

The secondary output channel 226 may extend between the secondary reaction vessel 220 and a buffer junction 228. A secondary outlet valve 227 may be disposed in the secondary outlet channel 226 to control the discharge of output fluid through the secondary output channel 226. For example, the secondary outlet valve 227 may comprise a high pressure valve with a relatively high cracking pressure.

The quality control (QC) module 260 comprises a quality control QC vessel 261 configured to receive an amount of output fluid from the secondary reaction vessel 220 (or primary reaction vessel 210 if there is no secondary vessel) for analysis. The sample cartridge 200 may further comprise a QC pneumatic channel 262 and QC pneumatic port 263 to which vacuum pressure may be applied to draw output fluid into the QC vessel 261 from the secondary output channel 226. A top of the QC vessel 261 may be sealed with a lid or foil, for example.

In some embodiments, the QC vessel 261 may be preloaded with a dye (optionally a desiccated dye) to facilitate optical analysis with the optics module 400.

In some embodiments, the output fluid may be mixed with a quality control buffer solution before optical analysis. The QC buffer solution may be held in a QC buffer vessel 265 prior to being transferred into the QC vessel 261 with the output fluid. For example, the QC buffer vessel 265 may define an open top so that buffer solution can be dispensed into the QC buffer vessel 265 by the reagent module 300.

The sample cartridge 200 may comprise a QC buffer channel 266 extending from the QC buffer vessel 261 to the secondary output channel 226 (or primary output channel 216 if there is no secondary vessel) at the buffer junction 228. A QC buffer valve 267 may be disposed in the QC buffer channel 266 to control flow of the buffer solution through the QC buffer channel 266. For example, the QC buffer valve 267 may comprise an active valve, such as a pressure actuated valve activated by applying positive or negative pressure to a corresponding QC buffer pneumatic port 268.

The sample cartridge 200 may further comprise a metering channel 299 in fluid communication with the secondary output channel 226 and buffer channel 266, and extending from the buffer junction 228 to a quality control junction 229.

The sample cartridge 200 may further comprise a QC channel 269 extending between the QC junction 229 and the QC vessel 261. The sample cartridge 200 may further comprise a QC vessel valve 264 disposed in the QC channel 269 to control the flow of fluid into the QC vessel 261 through the QC channel 269. The QC vessel valve 264 may comprise a low pressure valve with a relatively low cracking pressure.

While the QC buffer valve 267 is closed, vacuum pressure may be applied to the QC vessel pneumatic port 263 to create a relatively high pressure difference to overcome the threshold of the secondary output valve 227 for a short time to draw some of the output fluid from the secondary reaction vessel 220 into the secondary output channel 226 past the buffer junction 228 and into the metering channel 299 up to the QC junction 229, then the pressure difference may be neutralised to stop the flow. The metering channel 299 may define a known volume (e.g., 1 μL) so that the metering channel 299 can be filled from the buffer junction 228 to the QC junction 229, to define a precise aliquot of output fluid.

The QC buffer valve 267 may then be opened by applying the appropriate activation pressure to QC buffer pneumatic port 268 and applying vacuum pressure to the QC vessel pneumatic port 263 to create a pressure difference sufficiently high to open the low pressure QC vessel valve 264, but below the threshold for the high pressure secondary output valve 227. This allows QC buffer solution to flow through the QC buffer channel 266 and through the metering channel 299 and QC channel 269 into the QC vessel 261 along with the aliquot of output fluid from the metering channel 299.

The mixed fluid may then mix with the preloaded dye in the QC vessel 261 for analysis.

In some embodiments, the sample cartridge 200 may further comprise one or more QC reference vessels 271, each with a corresponding QC reference pneumatic channel 272 and QC reference pneumatic port 273, and each of which may be preloaded with a predefined quantity of desiccated dye. Each QC reference vessel 271 may also have a corresponding QC buffer vessel 275 configured to receive a certain required amount of QC buffer solution to be drawn into the QC reference vessel 271 by applying a vacuum pressure to the corresponding QC reference pneumatic port 273.

The contents of the QC vessel 261 can then be compared with the contents of the QC reference vessels 271 using the optics module 400 to measure a property of the output fluid, such as the concentration of a particular component, for example.

The sample cartridge 200 further comprises a final output channel 256 which branches off from the secondary output channel 226 at the QC junction 229 and connects the secondary output channel 226 to the output vessel 250. A final output valve 257 is disposed in the final output channel 256 to control flow through the final output channel 256. The final output valve 257 may comprise a low pressure check valve, for example.

The sample cartridge 200 further comprises an output vessel pneumatic channel 252 extending between the output vessel 250 and an output vessel pneumatic port 253. Vacuum pressure may be applied to the output vessel pneumatic port 253 to draw the output fluid through the final output channel 256 and into the output vessel 250.

The final output channel 256 and output vessel pneumatic channel 252 may be connected to a temporary removable lid 259 (shown in FIG. 2F and 2G) used to seal the output vessel 250 closed during the instrument workflow. Once the sample has been processed and the sample cartridge 200 removed from the instrument 100, the temporary lid 259 may be removed from the output vessel 250 and the output vessel 250 may be closed with a main output vessel lid 251. For example, the output vessel lid 251 may be a hinged lid, integrally formed with the output vessel 250 as shown in FIG. 2A.

In order to measure a precise aliquot of the output fluid for QC analysis, vacuum pressure may be applied for a predetermined period of time until the output fluid has filled the metering channel 299 between the QC junction 229 and the buffer junction 228 and entered the final output channel 256. The length of the metering channel 299 may be designed to define a specific known volume (e.g., 1 μL). The flow through the final output channel 256 may then be stopped by returning the pressure at the output vessel pneumatic port 253 to ambient pressure.

Then the QC buffer valve 267 may be opened, and vacuum pressure may be applied to QC pneumatic port 263 to draw buffer solution from the QC buffer vessel 265 past the QC and buffer junctions 228, 229 and through the metering channel 299 and QC channel 269 carrying the aliquot of output fluid and being drawn into the QC vessel 261. In this way, a precise aliquot volume is defined between the QC and buffer junctions 228, 229 which progresses as a slug into the QC vessel to be mixed with the buffer solution.

The entire contents of the QC buffer vessel 265 may be drawn into the QC vessel 261 so that no buffer solution (or only a minor quantity) remains in the channel between the QC and buffer junctions 228, 229. This ensures that the known volume (or very close to the known volume) of buffer solution has been drawn into the QC vessel 261. It also reduces or minimises the amount of buffer solution which might remain in the channel and dilute the output fluid, which may be advantageous if a high concentration of output fluid is required.

In some embodiments, the sample cartridge 200 may comprise a waste channel 279 to discard excess fluid to the waste vessel 240 as shown in FIG. 2G. However, in some embodiments, this may not be necessary, as a precise volume of output fluid and buffer solution may be measured and drawn into the QC vessel 261 so that there is no excess fluid.

In some embodiments, the sample cartridge 200 may further comprise an intermediate outlet 280 from the final output channel 256 between the final output valve 257 and the output vessel 250. The outlet 280 may be sealed with an air-permeable membrane 281 which is permeable to gas but does not allow liquid to pass. On the other side of the membrane 281 (opposite the channel 256) an intermediate outlet pneumatic channel 282 connects the outlet 280 to an intermediate outlet pneumatic port 283. Air can be drawn through the air-permeable membrane 281 by applying vacuum pressure to the intermediate outlet pneumatic port 283.

When this is done, the liquid output fluid will be drawn along the final output channel 256 but will stop once it reaches the air-permeable membrane 281. This will result in an increase in the pressure gradient, which can be detected by the pneumatic module 500, indicating that the channel 256 has been filled to the intermediate outlet 280. This signal may be used to trigger the next step in a workflow, such as flowing the buffer solution through the metering channel 299 and QC channel 269.

The sealed reaction vessels 210, 220, QC vessels 261, QC reference vessels 271, output vessel 250 and waste vessel 240 allow processing of a fluid sample without cross-contamination or instrument contamination due to the splashing of the fluid sample out of these vessels. This is achieved by providing separate vessels for receiving reagents from the reagent module (e.g., reagent vessel 230 and buffer vessels 265, 275), and transferring the reagents into the sealed vessels for processing using the pneumatic module and corresponding pneumatic ports to create pressure gradients to drive flow as required. Locating the openings of the inlet channels and pneumatic channels at or near tops of the sealed vessels, also reduces the chance of backflow of sample fluid into the inlet channels or aspiration of sample fluid into the pneumatic module, which might otherwise contaminate the instrument.

Referring to FIG. 2E, a bottom view of the sample cartridge 200 is shown in further detail illustrating the network of channels and valves of the cartridge. A close-up view of the quality control module 260 is shown in FIG. 2F. Like elements are indicated with like reference numerals.

In some embodiments, the QC module 260 may be included as part of a larger sample cartridge, such as sample cartridge 200, or any other sample cartridge which may require QC analysis or precise fluid metering. In some embodiments, the QC module 260 may be included as part of a measurement or analysis instrument.

Referring to FIG. 2F, the QC module 260 could also be considered independently as a separate sample cartridge 290, according to some embodiments. Some embodiments relate to an independent sample cartridge 290 comprising only the QC module 260, as shown in FIG. 2F.

The sample cartridge 290 may be configured for use with a fluid analysis instrument, for example. The cartridge 290 comprises a sample vessel 220 configured to accommodate a fluid sample for analysis. The sample vessel 220 corresponds to the secondary reaction vessel 220 of sample cartridge 200, or could correspond to the primary reaction vessel 210 in a sample cartridge 200 with no secondary reaction vessel 220.

The cartridge 290 comprises a buffer solution vessel 265 (similar to sample cartridge 200) configured to accommodate a buffer solution. The cartridge 290 comprises a sealed analysis vessel 261 (corresponding to QC vessel 261) configured to accommodate a mixed fluid comprising an aliquot of the fluid sample mixed with at least some of the buffer solution for analysis.

The cartridge 290 comprises a sample channel 226 (corresponding to secondary output channel 226) extending between the sample vessel 220 and a first junction 228 (corresponding to buffer junction 228).

The cartridge 290 comprises a sample channel valve 227 (corresponding to secondary output valve 227) disposed in the sample channel 226 to control flow of the sample through the sample channel 226.

The cartridge 290 comprises a buffer channel 266 extending between the buffer solution vessel 265 and the first junction 288. A buffer channel valve 267 is disposed in the buffer channel 266 to control flow of the buffer solution through the buffer channel 266.

The cartridge 290 comprises a metering channel 299 in fluid communication with the buffer channel 266 and sample channel 226, the metering channel 299 extending between the first junction 228 and a second junction 229 (corresponding to QC junction 229).

The cartridge 290 comprises an analysis vessel channel 269 (corresponding to QC channel 269) in fluid communication with the metering channel 299 and extending between the second junction 229 and the analysis vessel 261. The cartridge 290 comprises an analysis vessel pneumatic port 263 (corresponding to QC pneumatic port 263) in communication with the analysis vessel 261 and configured to be connected to a pneumatic module to selectively adjust a pressure in the analysis vessel 261 to draw fluid into the analysis vessel 261 via the analysis vessel channel 269.

At least one of the sample channel valve 227 and the buffer channel valve 267 may comprise an active valve which can be selectively opened and closed to allow an aliquot of the fluid sample to be drawn into the metering channel 299, and to allow buffer solution to then be drawn through the buffer channel 266 and through the metering channel 299 and analysis vessel channel 269 into the analysis vessel 261 with the aliquot of the fluid sample for analysis. For example, the buffer channel valve 267 may comprise an active valve, and the sample channel valve 227 may comprise a relatively high pressure check-valve.

The analysis vessel 261 may be preloaded with a dye configured to mix with the buffer solution and fluid sample to facilitate analysis.

The sample cartridge 290 or 200 may further comprise an intermediate outlet 280 in fluid communication with the metering channel 299 via the second junction 229. The intermediate outlet 280 may be similar to the intermediate outlet of sample cartridge 200, both of which may include any of the features described below.

Referring to FIG. 2O (adjacent FIG. 2F), a close-up top perspective view of the outlet 280 is shown according to some embodiments.

In some embodiments, the outlet 280 may be located at the second junction 229. In some embodiments, the outlet 280 may be located away from the second junction 229 and connected to the second junction 229 via an outlet channel 285.

The sample cartridge 290 or 200 may comprise an outlet chamber 284 into which the intermediate outlet 280 opens. An air-permeable liquid barrier membrane 281 may cover the outlet 280.

The sample cartridge 290 or 200 may comprise an intermediate outlet pneumatic port 283 in fluid communication with the outlet chamber 284 and configured to be connected to a pneumatic module to selectively adjust a pressure in the outlet chamber 284 to draw air through the air-permeable membrane 281 from the metering channel 299.

The sample cartridge 290 or 200 may comprise an intermediate outlet pneumatic channel 282 extending between the intermediate outlet pneumatic port 283 and the outlet chamber 284. The outlet chamber 284 may be sealed with only two fluid openings, namely, the outlet 280 and an opening of the intermediate outlet pneumatic channel 282. A top of the outlet chamber 284 may be sealed with a foil, for example.

The intermediate outlet 280 may be arranged such that liquid drawn into the metering channel 299 from the sample channel 226 or buffer channel 266 is allowed to fill the metering channel 299, but is not allowed to progress into the analysis vessel channel 269.

The sample cartridge 290 or 200 may comprise an outlet channel 285 extending between the second junction 229 and the outlet 280, such that liquid drawn into the metering channel 299 from the sample channel 226 or buffer channel 266 is allowed to fill the metering channel 299 and progress into the outlet channel 285, but is not allowed to progress into the analysis vessel channel 269.

The sample cartridge 290 or 200 may comprise an output vessel 250 in fluid communication with the metering channel 299 via the second junction 229 and via an output channel 256. The output channel 256 may extend from the second junction 229 to the output vessel 250. Alternatively, or additionally, the output channel may extend between the intermediate outlet 280 and the output vessel 250.

The sample cartridge 290 or 200 may comprise an output vessel pneumatic port 253 in communication with the output vessel 250 and configured to be connected to a pneumatic module to selectively adjust a pressure in the output vessel 250 to draw fluid into the output vessel 250 from the metering channel 299 via the second junction 229 and the output channel 256.

The arrangement of channels, valves, vessels and outlets in the sample cartridge 290 and QC module 260 allow for precise quantitation of an aliquot of sample fluid (or processed fluid), as the volume of the metering channel can be precisely defined. The arrangements described above may be used for precise metering fluid for quantitation for any application where precise quantitation is required.

The sample cartridge 290 may further comprise one or more reference vessels 271 and associated buffer vessels 275, pneumatic channels 272 and pneumatic ports 273, as described in relation to sample cartridge 200.

The output channel 256 and output vessel pneumatic channel 252 may be connected to a temporary lid 259 defining openings of the output channel 256 and output vessel pneumatic channel 252 into the output vessel 250, and configured to seal the output vessel 250. The temporary lid 259 may be removed to allow the output vessel 250 to be removed from a base 202 of the sample cartridge 290, and the output vessel 250 may be sealed with an output vessel lid 251.

The sample cartridge 200 or 290 may be formed of any suitable plastics material for a given application. For example, for handling biological materials, polypropylene may be used.

The sample cartridge 200 or 290 may be formed by injection moulding. For example, the sample cartridge 200 or 290 may be formed with some or all of the channels, chambers and vessels having an open top or open side, and some of the openings may be sealed with a welded foil, for example, as required to form the sealed channels, chambers and vessels described above.

The channels in the base may be covered with a polypropylene membrane which may be heat welded to the base. And channels in the side walls leading to and from the vessels may similarly be covered with a polypropylene membrane heat welded to the body. For example, the heat welding may comprise laser welding, and a tractor weld around the perimeter of each channel may fix the membrane to the body to define each channel.

The valves may comprise any suitable active or passive valves depending on the arrangement and application. Suitable valves may include check valves with different relative cracking pressures (as shown in FIG. 2J, for example), duck-bill valves (as shown in FIG. 2L, for example), umbrella valves (as shown in FIG. 2M, for example), microfluidic valves or capillary valves with different cracking pressures depending on surface tension and capillary action, pressure actuated switch valves (as shown in FIG. 2K, for example), electronically actuated switch valves (e.g., solenoid valves), or mechanically actuated switch valves such as Prodger valves (as shown in FIG. 2N, for example). A combination of different valve types may be used to achieve the required flows in the sample cartridge 200.

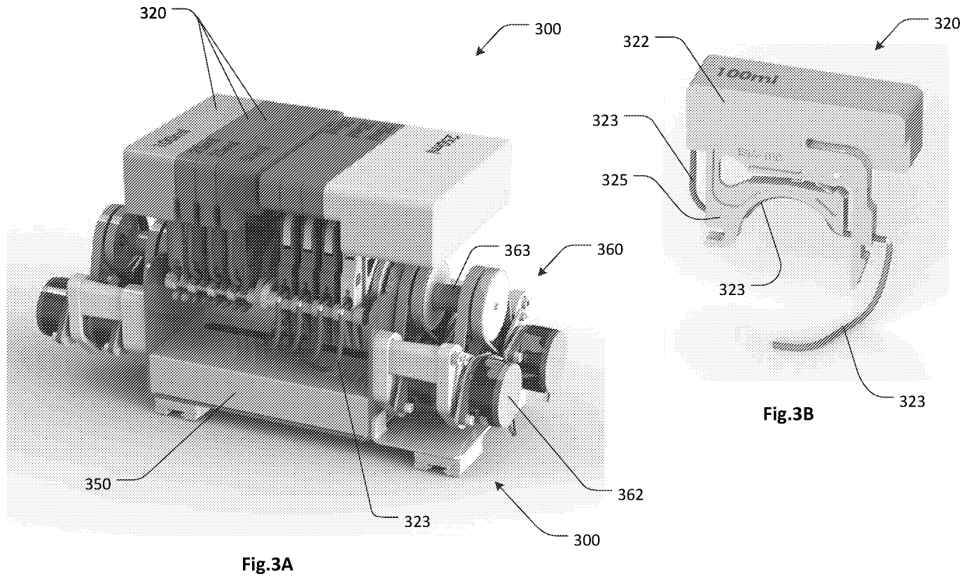

Referring to FIGS. 3A and 3B, the reagent module 300 is shown, according to some embodiments. The reagent module 300 comprises a plurality of reagent cartridges 320 removably mounted to a frame 350. The frame 350 also supports a pump 360 configured to control dispensing of reagents from the reagent cartridges 320.

An isolated reagent cartridge 320 is shown in FIG. 3B. Each reagent cartridge 320 comprises a reservoir 322, a flexible dispensing tube 323, and a reagent cartridge frame 325 configured to support the reservoir 322, and configured to engage the reagent module frame 350 to mount the reagent cartridge 320 on the frame 350.

The pump 360 may comprise a peristaltic pump. For example, the pump 360 may comprise one or motors 362 each configured to drive rotation of a pump shaft 363 and pump cam (not shown) mounted on the pump shaft 363. The pump cam may be generally circular with protuberances, like a round toothed cog, for example.

When mounted on the reagent module frame 350, the reagent cartridge frame 325 may support the dispensing tube 323 such that part of the tube 323 extends at least part way around a circumference of the pump cam, and when the pump cam is rotated by the corresponding motor 362, the protuberances of the pump cam contact and compress part of the dispensing tube 323 thereby pushing fluid through the dispensing tube 323 as the pump cam rotates. The dispensing tubes 323 may be positioned such that the openings dispense the reagents into the desired vessel of a sample cartridge 200 (reagent vessel or QC buffer vessels) when the reagent module 300 is aligned with the sample cartridge 200.

The dispensing tubes 323 may be formed of any suitable material, and in some cases, may be formed of different materials depending on compatibility with the respective reagents. For example, the dispensing tubes 323 may be formed of silicone, viton or Chem-Durance Bio tubing.

Each reagent cartridge 320 may be engaged by a respective pump cam driven by a corresponding one of the motors 362. In some embodiments, a single pump cam, or a single pump shaft 363 configured to drive rotation of multiple pump cams, may be configured to engage more than one of the reagent cartridges 320 to control dispensing. For example, if multiple reagents are to be dispensed simultaneously, in similar amounts, then the corresponding reagent cartridges 320 may be simultaneously engaged by a single pump system to dispense the reagents into the sample cartridge 200.

The pump 360 may comprise independent motors 362 and drive shafts 363 to independently control dispensing of reagents from different reagent cartridges 320.

The reservoirs 322 of the different reagent cartridges 320 may define different volumes in proportion to an expected ratio of consumption of the different reagents contained therein. For example, if a first reagent is typically dispensed at twice the volume of a second reagent, the reservoir 322 for the first reagent may be twice the volume of the reservoir 322 for the second reagent.

The reservoirs 322 may contain a sufficient volume of reagents for a certain number of instrument workflows to be performed. When the reagent reservoirs 322 are empty, the reagent module 300 may be partially slid out of the instrument housing 110 as shown in FIG. 1B so that the reagent reservoirs 322 can be refilled, or the empty reagent cartridges 320 can be removed entirely and replaced with filled reagent cartridges 320.

In some embodiments, the reagent module frame 350 may comprise or be mounted on the (or a) carriage 920 of the motion module 900. The reagent module 300 may be moved (by the motion module 900) along an axis of movement 903 across the plurality of sample cartridges 200 in the cartridge slots 120 to dispense reagents into the sample cartridges 200 at selected times during the instrument workflows.

The reagent module 300 may be moved to a selected carriage position at a selected time corresponding to a selected one of the sample cartridges 200. Then the pump 360 may be operated to dispense one or more reagents from the corresponding reagent cartridges 320 into a selected vessel in the sample cartridge 200, such as the reagent vessel 230 or quality control buffer vessels, for example.

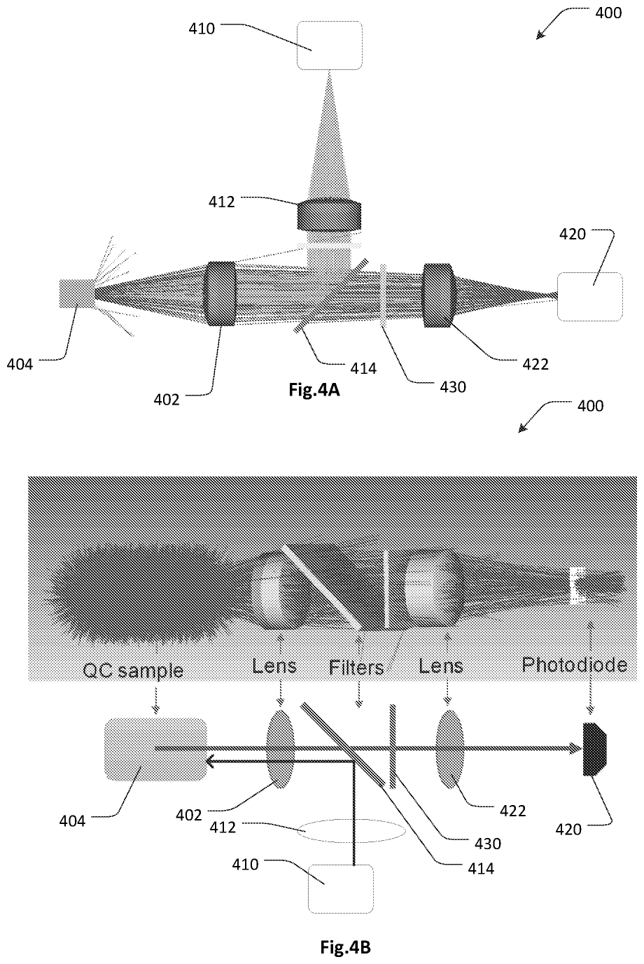

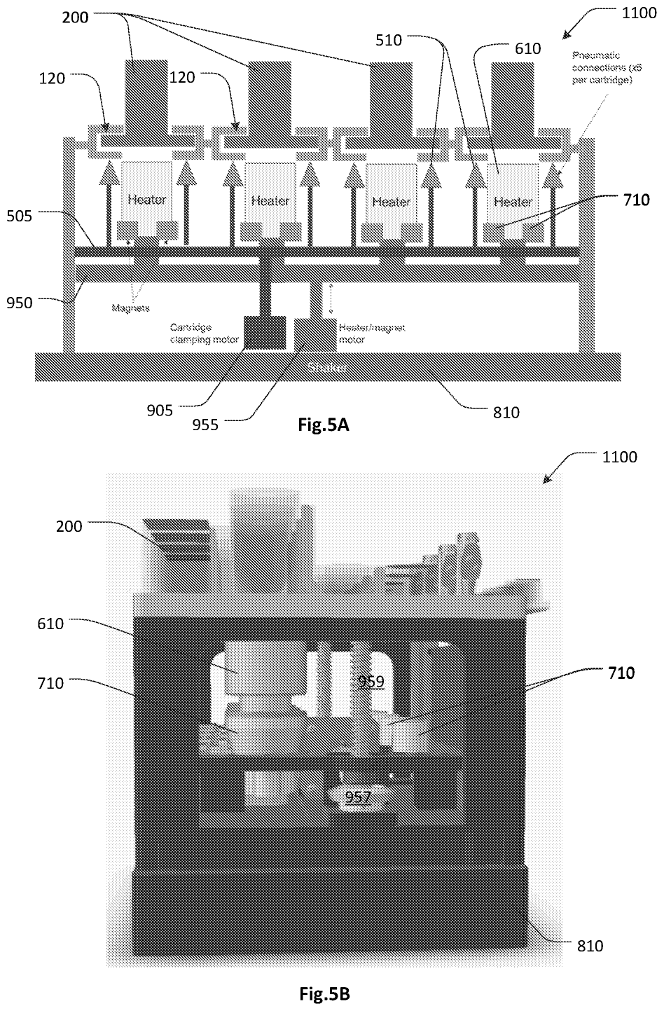

Referring to FIGS. 4A and 4B, a diagram of the optics module 400 is shown, according to some embodiments. The optics module 400 comprises a light source 410 and a detector 420. The light source 410 is configured to illuminate a quality control (QC) sample 404, which may comprise output liquid in the QC vessel 261, or reference liquid in one of the QC reference vessels 271. The detector 420 is configured to detect and measure light transmitted from the QC sample 404.

For example, the light source 410 may comprise an LED or LASER. The detector 420 may comprise a photodiode or any other suitable optical detector. Light source 410 and detector 410 may be configured to operate in any suitable frequency range depending on the application and the property being measured, including in the visible, near visible, infrared and ultraviolet ranges.

The optics module 400 may be configured to measure any one or more of scattered light, refracted light or reflected light transmitted from the QC sample 404.

In some embodiments, the optics module 400 may comprise one or more lenses, filters and/or other optical devices. For example, the optical module 400 may comprise a source lens 412 to focus light from the source 410 (e.g., into parallel rays); a beam splitter 414 to redirect light from the source 410 towards the QC sample 404; a sample lens 402 to focus the source light onto the QC sample 404 and refocus light transmitted from the QC sample 404 (e.g., into parallel rays); a detector lens 422 to focus the light transmitted from the QC sample 404 onto the detector 420; and one or more filters 430 disposed in the detector path and/or the source path to filter certain frequencies of light.

The optics module 400 may be mounted on a carriage 920 of the motion module 900 (either the same carriage as the reagent module 300 or an independent carriage 920), to allow the optics module 400 to be aligned with any selected one of the sample cartridges 200 in the cartridge slots 120 to optically analyse a QC sample 404 disposed in the sample cartridge 200.

For example, the sample cartridge 200 shown in FIG. 2A comprises one QC vessel 261 and three QC reference vessels 271 to be compared. The QC vessel 261 and three QC reference vessels 271 may be arranged along a lateral axis of the sample cartridge 200 parallel to an axis of movement 904 of the optics module 404, to allow ready access for the optics module 400 to the QC samples 404. The carriage 920 may be moved by the motion module 900 to different carriage positions corresponding to the positions of the QC vessel 261 and three QC reference vessels 271.

The QC vessel 261 and three QC reference vessels 271 may comprise a clear window (on the top, bottom or side) to allow light to pass from the optical source 410 into QC samples 404 contained therein, and from the QC samples 404 to the optical detector 420. The window may have a surface finish of SPI A-1 grade to minimise scattering. The window thickness may be less than or equal to 3 mm.

The motion module 900 may position with optics module 400 such that the QC sample 404 is within 2 mm of an optical focal plane of the optics module 400, and optionally within a lateral positional tolerance of 1.25 mm. Different tolerances may be suitable for different applications depending on the characteristics of the optics module 400 and sample cartridge 200.

The pneumatic module 500 is shown in FIG. 1C, according to some embodiments. The pneumatic module 500 may comprise a pressure regulator and a compressor, vacuum generator or vacuum pump. Alternatively, the pneumatic module 500 may be configured to be connected to an external pressure source or vacuum line, for example.

The pneumatic module 500 may comprise a network of pneumatic lines and valves with connectors adjacent the cartridge slots 120 configured to connect to the pneumatic ports of the sample cartridges 200. The pneumatic module 500 may be configured to selectively deliver positive and/or negative pressure (relative to atmospheric pressure) to selected pneumatic ports of the sample cartridges 200 at selected times during the instrument workflows.

In some embodiments, the pneumatic module 500 may be configured to deliver different magnitudes of relative pressure differences to different pneumatic ports of the sample cartridges 200. In some embodiments, the pneumatic module 500 may be configured to deliver different magnitudes of relative pressure differences to selected pneumatic ports of the sample cartridges 200 at different times. In some embodiments, the pneumatic module 500 may be configured to only deliver negative pressure to the pneumatic ports of the sample cartridges 200.

In some embodiments, the pneumatic module 500 may comprise sets of pneumatic lines, each set of pneumatic lines configured to simultaneously deliver a selected pressure to all corresponding pneumatic ports of the plurality of sample cartridges 200 in the cartridge slots 120. For example, to apply a certain negative pressure to all of the primary pneumatic ports 213 simultaneously.

In some embodiments, each pneumatic port in the sample cartridge 200 may have a single selected pressure or pressure range to be delivered to it at selected times without having to vary the pressure.

The pneumatic module 500 may comprise any suitable valve system for selectively delivering the required pressure to the required pneumatic ports at the selected times of the instrument workflows. For example, an array of solenoid valves operated electronically by the control module 101, or a manifold valve system, or rotary valve system.

Referring to FIGS. 5A and 5B, parts of the pneumatic module 500, thermal module 600, magnetic module 700, mixing module 800 and motion module 900 are shown, according to some embodiments, forming a core unit 1100 accommodated within the chassis or housing 110 and cooperating to define the cartridge slots or sockets 120.

Pneumatic connectors 510 are shown under the cartridge slots 120 supported by a pneumatic support frame 505. The support frame 505 is connected to a pneumatic module actuator 905, which may form part of the motion module 900. The pneumatic module actuator 905 may comprise a motor or linear actuator configured to raise and lower the pneumatic connectors 510. The pneumatic connectors 510 may be in a lowered position for loading the sample cartridges 200 into (or removing them from) the cartridge slots 120. When the sample cartridges 200 are accommodated within the cartridge slots 120, the pneumatic module actuator 905 may be operated to raise the pneumatic support frame 505 and pneumatic connectors 510, such that the pneumatic connectors 510 engage the pneumatic ports in the sample cartridges 200 and fluidly connect the pneumatic module 500 to the channels of the sample cartridges 200.

In some embodiments, the motion module 900 may further comprise a vertical movement platform 950 configured to raise and lower other components of the instrument 100 within the housing 110. Movement of the platform 950 may be driven by a platform actuator 955, which may comprise a linear actuator or a leadscrew actuator as shown in FIG. 4B, for example, with a motor 957 and lead screw 959.

The vertical movement platform 950 may be configured to raise and lower components of the thermal module 600 and/or the magnetic module 700, for example, as well as any other components of the instrument which might need to be raised and lowered. In some embodiments, the pneumatic support frame 505 and connectors 510 may be mounted on a similar vertical movement platform 950. In some embodiments, the motion module 900 may comprise multiple vertical movement platforms 950 configured to be operated independently to independently raise and lower different components or groups of components. For example, the thermal module and magnetic module may be mounted on a single vertical movement platform, which may comprise an additional vertical movement platform mounted thereon to raise and lower the thermal module independently of the magnetic module.

In some embodiments, the instrument 100 may not comprise a vertical movement platform 950.

The thermal module 600 may comprise one or more thermal control devices 610, which may comprise heating and/or cooling elements, thermoelectric devices, peltier elements, resistive heaters, heat lamps, heat exchangers, and/or fans. When heating (or other thermal control) is required during one of the instrument workflows (e.g., for culturing), the platform 950 may be raised to bring the thermal control devices 610 (e.g., heaters) closer to the sample cartridges 200 in the cartridge slots, and the thermal control devices 610 activated.

In some embodiments, the thermal module 600 may comprise a conducting member coupled to a heating element to facilitate heating of the reaction vessels. For example, the conducting member may comprise a plate or jacket, which may define a complimentary surface configured to partially surround the reaction vessel.

The thermal module 600 may comprise a cooling fan disposed below the heating element and conducting member and configured to direct ambient air up around the heating element and conducting member to cool them down when required.

The cartridge may define openings in the base 202 around the bottom of the primary reaction vessel 210 and/or secondary reaction vessel 220 configured to allow passage of the conducting member or conducting members and/or magnets for positioning beside the reaction vessels 210, 220.

In some embodiments, the thermal module 600 may be fixed in a location close to the cartridge slots 120 and aligned with the primary and/or secondary reaction vessel 210, 220, and simply switched from heating to cooling or neutral, depending on the required thermal adjustment for a particular workflow operation.

The magnetic module 700 may comprise one or more magnets 710 arranged to control movement of magnetic beads in the primary and/or secondary reaction vessel 210, 220. The magnets 710 may comprise permanent magnets and/or electromagnets, and may be mounted on the vertical movement platform 950 to be raised close to the primary and/or secondary reaction vessel 210, 220 when the magnetic beads are to be held still, and lowered further away from the primary and/or secondary reaction vessel 210, 220 so that the magnets 710 have less influence on the magnetic beads. The magnets 710 may be disposed on either side of the primary and/or secondary reaction vessel 210, 220 so as to hold the beads away from the discharge outlets to avoid blockage or constriction of the discharge flow into the channels.

In some embodiments, for example, when the magnets 710 comprise electromagnets, the magnets 710 may be fixed in a location close to the cartridge slots 120 and aligned with the primary and/or secondary reaction vessel 210, 220, and simply switched on or off, depending on the required state for a particular workflow operation.

In some embodiments, the instrument may not comprise a magnetic module 700, and the functionalised beads in the primary and/or secondary reaction vessels may be kept out of the output channels by a physical barrier or restriction, such as a filter, for example.

The mixing module 800 may comprise any suitable device for enhancing mixing of fluids in the sample cartridges 200. For example, the mixing module 800 may comprise a shaker 810. The shaker 810 may comprise an orbital shaker, such as an eccentric cam or offset weight configured to be rotated by a motor to induce vibrations in the instrument 100. Alternatively, other conventional mixing devices may be used to promote mixing of fluids in the sample cartridges 200. In some embodiments, the mixing module 800 comprises a single shaker 810 configured to shake all of the sample cartridges 200 simultaneously.

The orbital shaker may include multiple weights and counter weights configured to vibrate the cartridges without toppling the instrument. A suitable power, frequency and amplitude of vibration may be chosen for the required application. For processing relatively fragile molecules (e.g., nucleic acid), a frequency of less than 2000 rpm may be suitable, such as approximately 1100 rpm, for example.

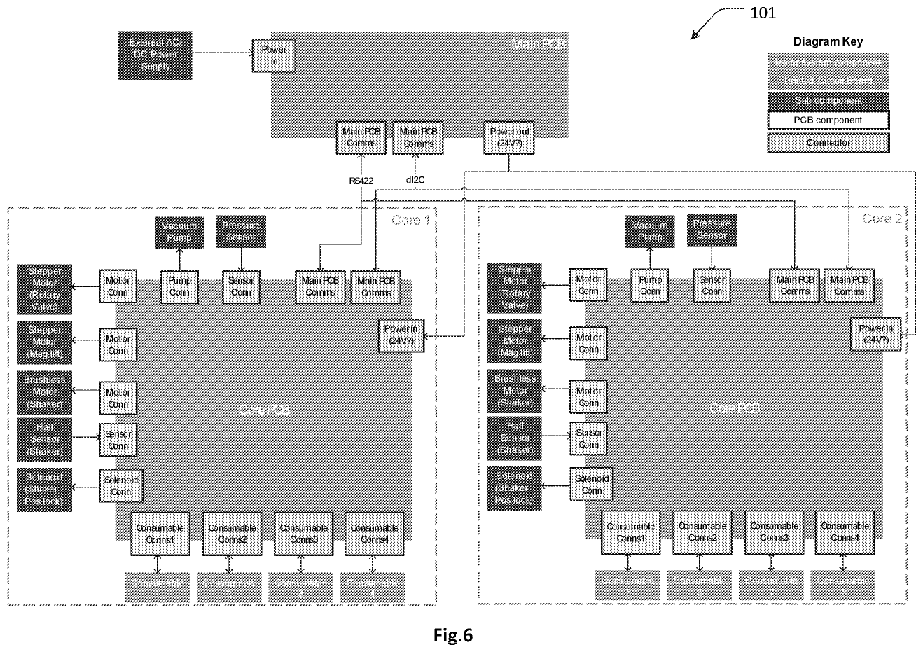

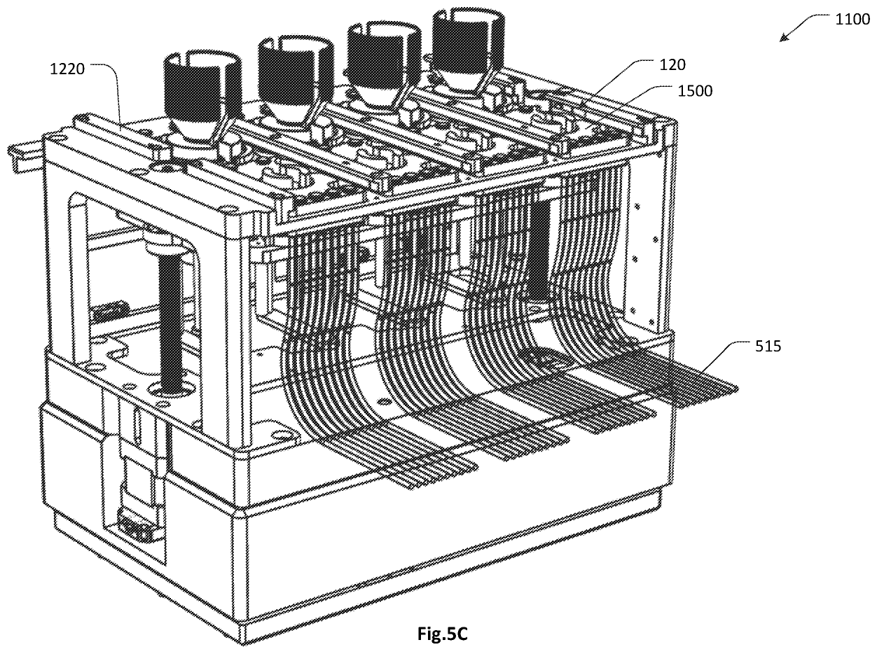

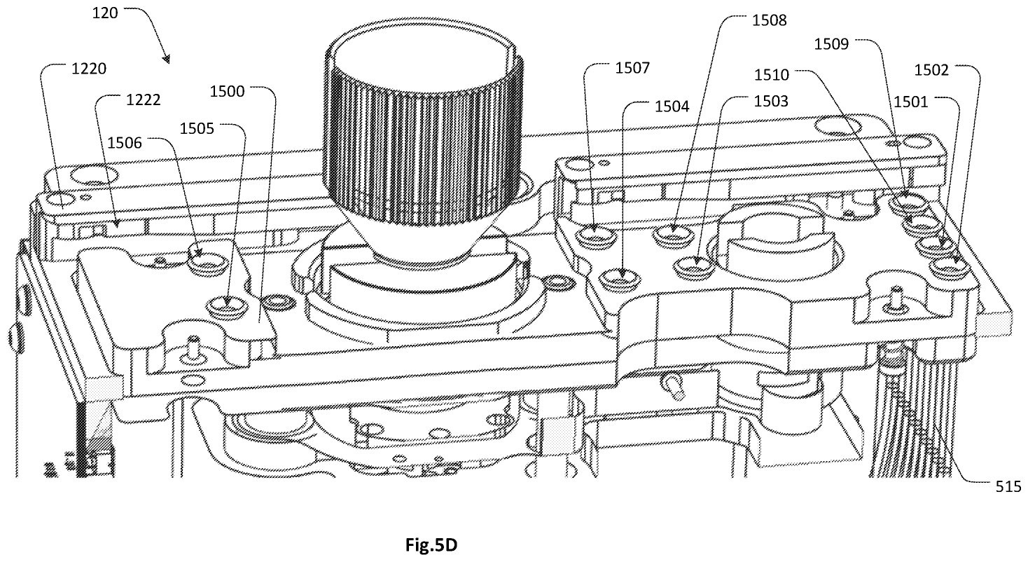

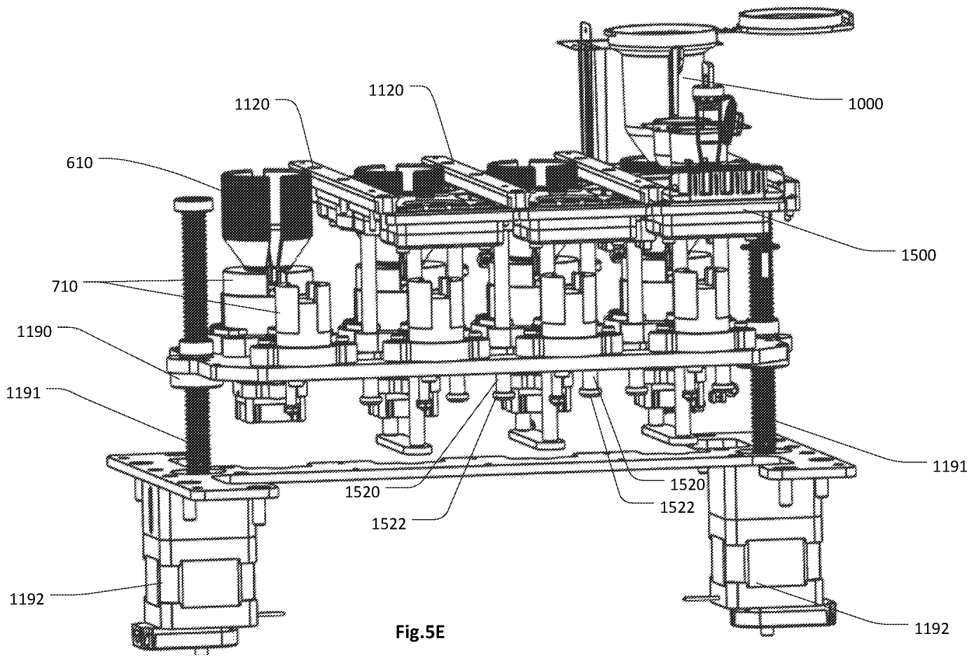

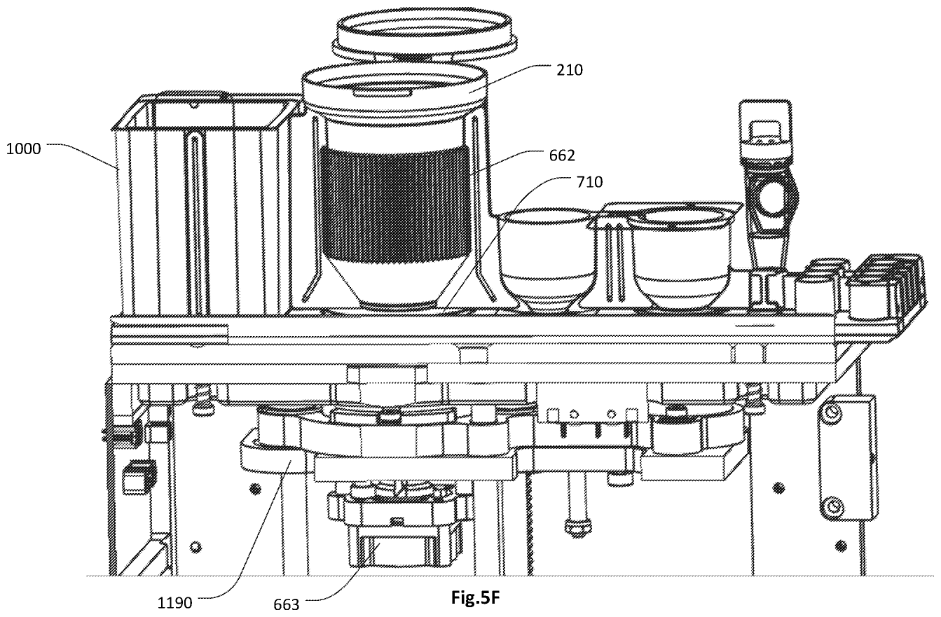

Referring to FIG. 6, a schematic diagram of the control module 101 is shown, according to some embodiments. The control module 101 comprises electronics and software configured to control the operations performed by the instrument 100, which may include control of the reagent module 300, optics module 400, pneumatic module 500, thermal module 600, magnetic module 700, mixing module 800, and motion module 900.

The control module 101 may also comprise one or more sensors to monitor operations of the modules. The sensors may include position sensors, accelerometers, proximity sensors, angular sensors (e.g., shaft angle or speed sensors), Hall sensors and pressure sensors, for example.

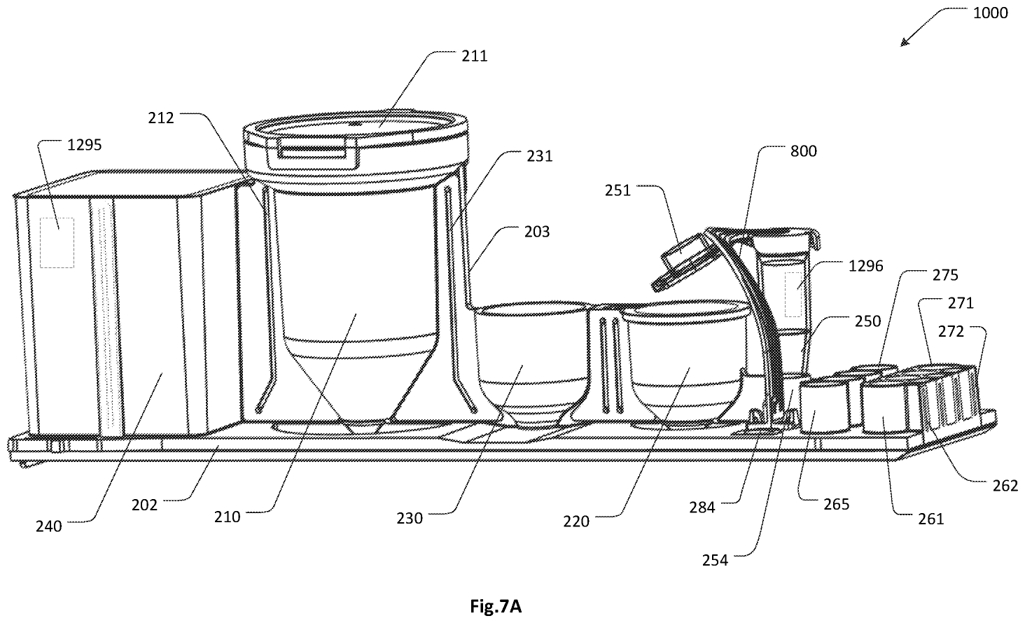

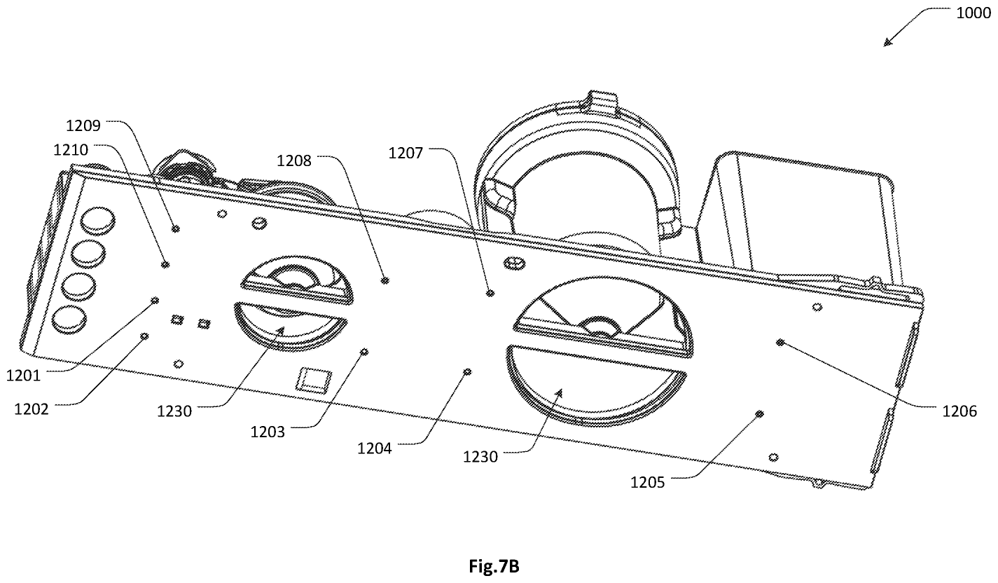

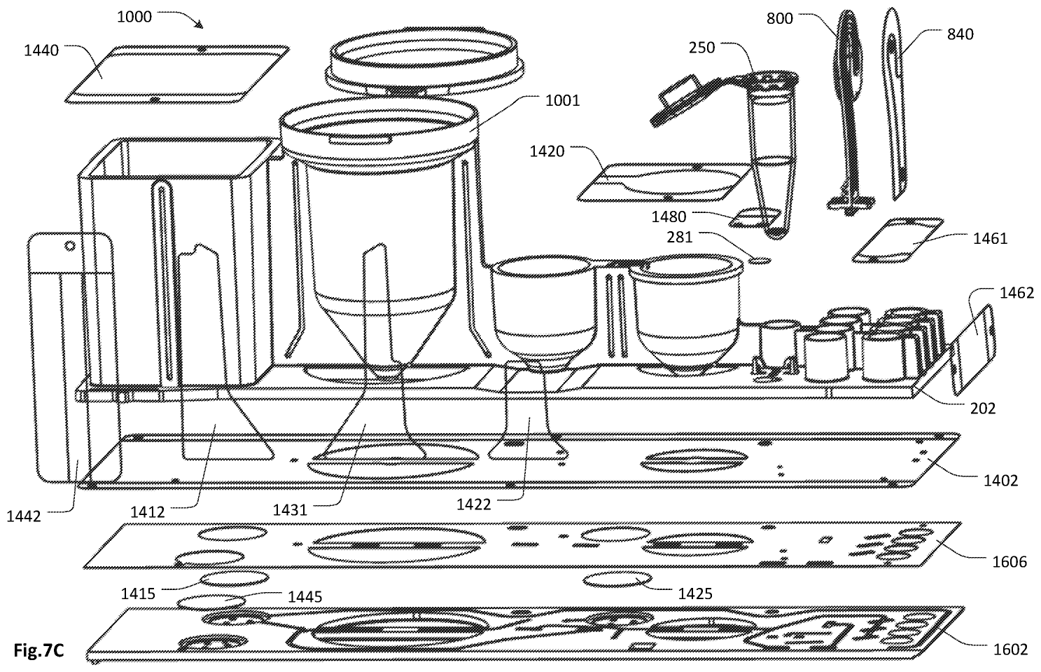

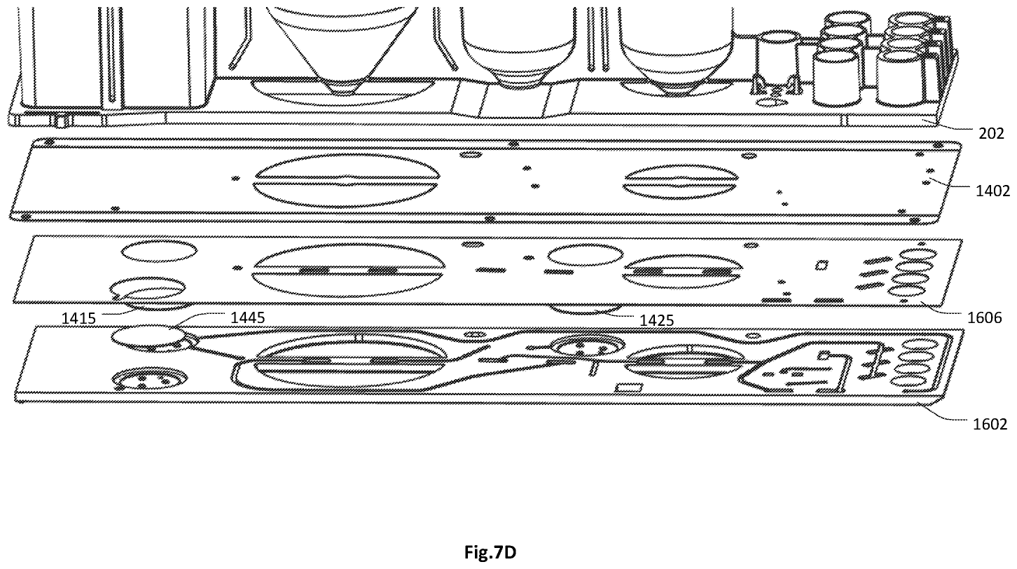

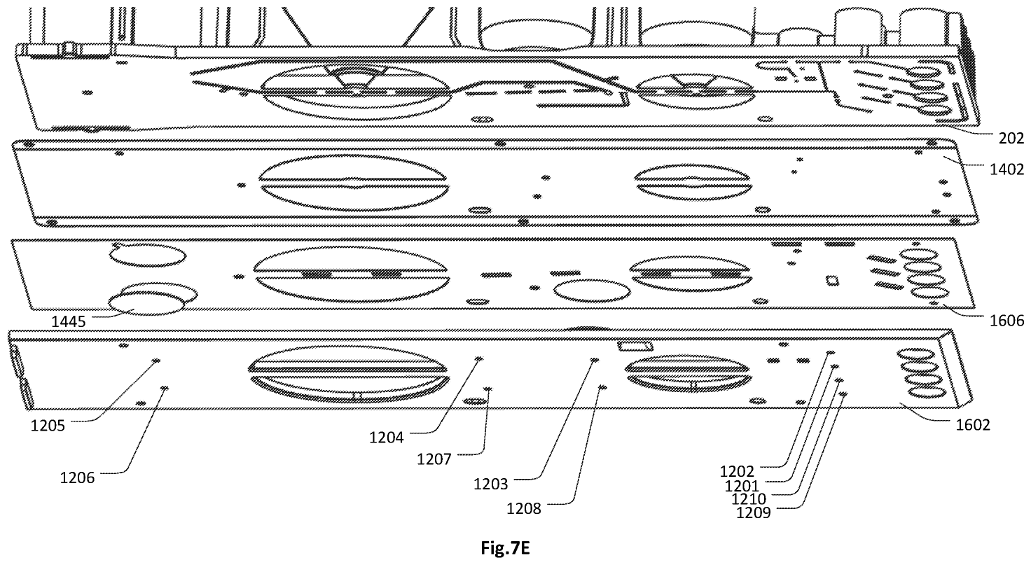

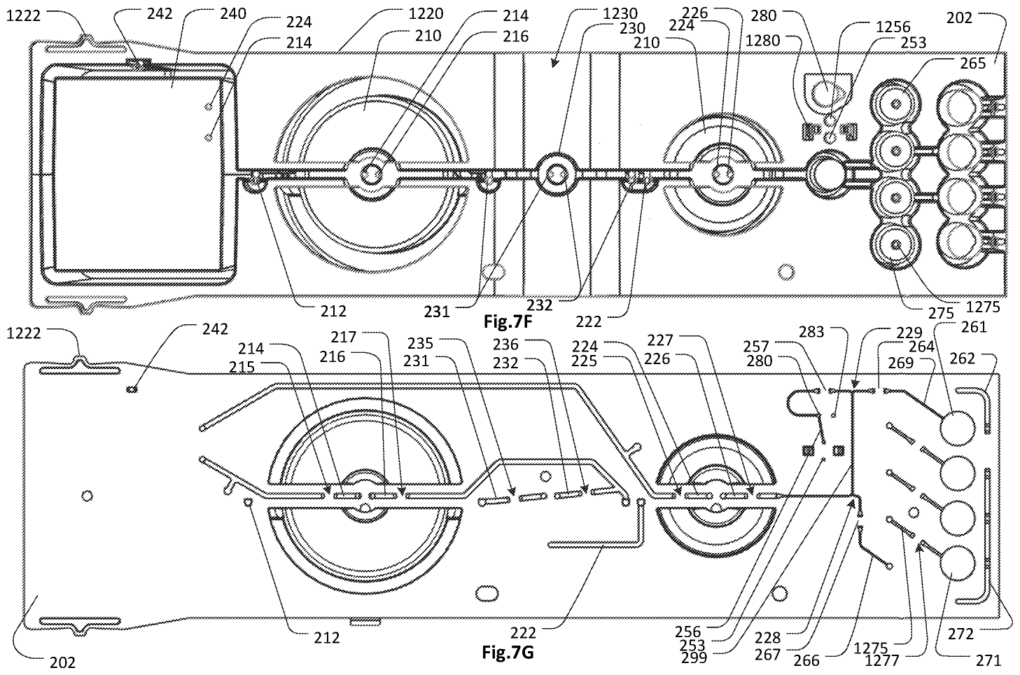

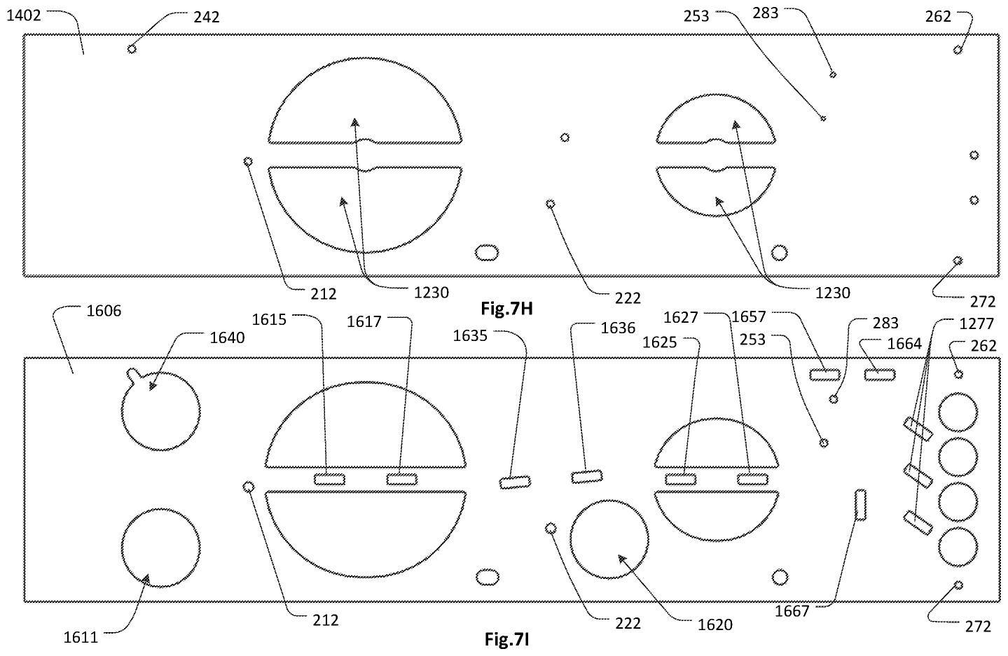

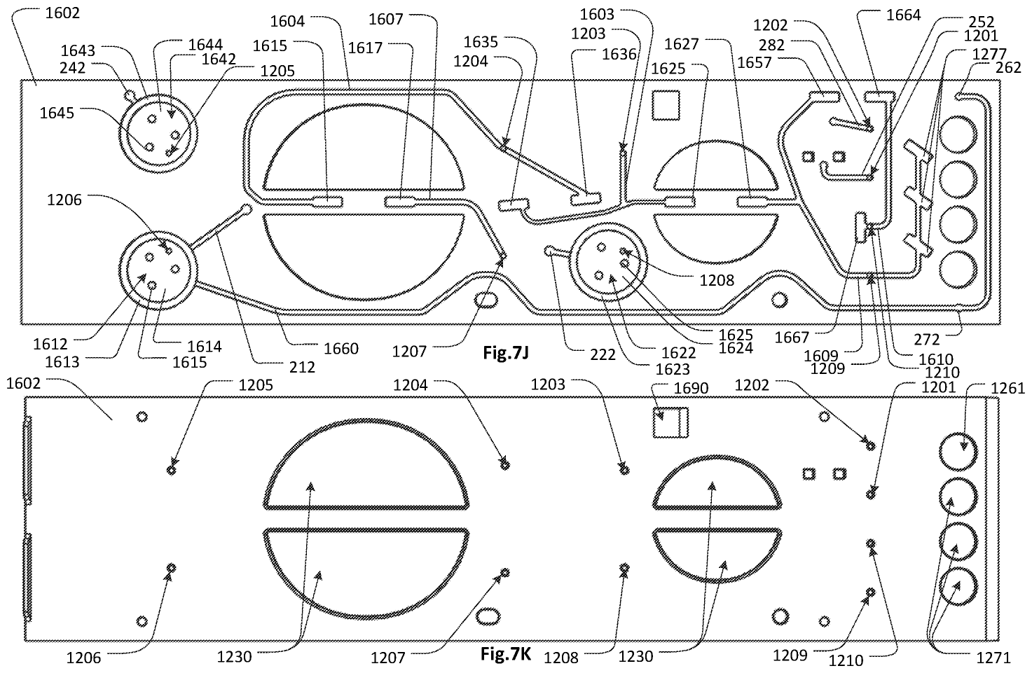

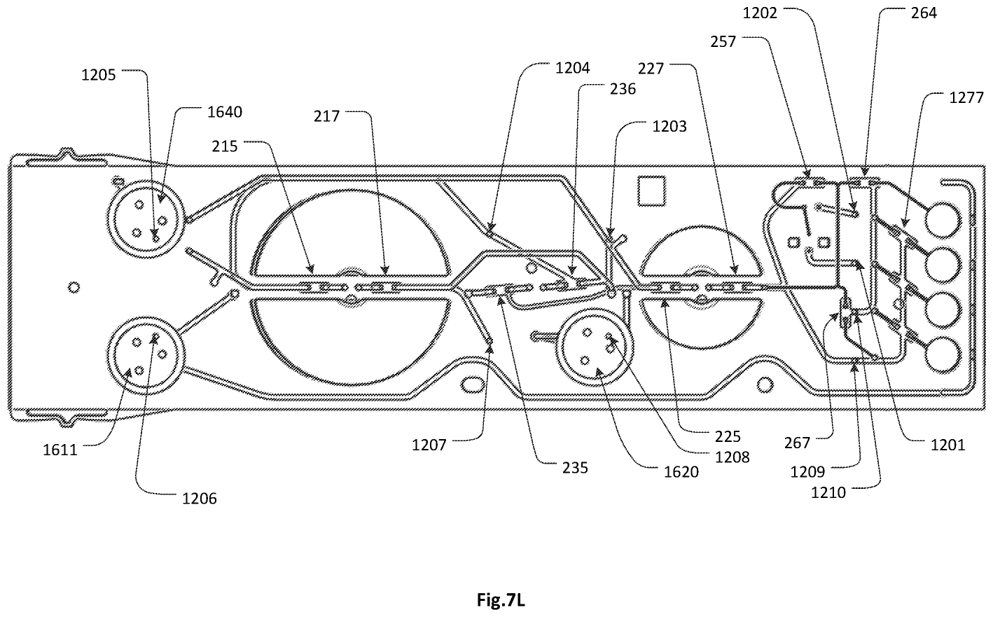

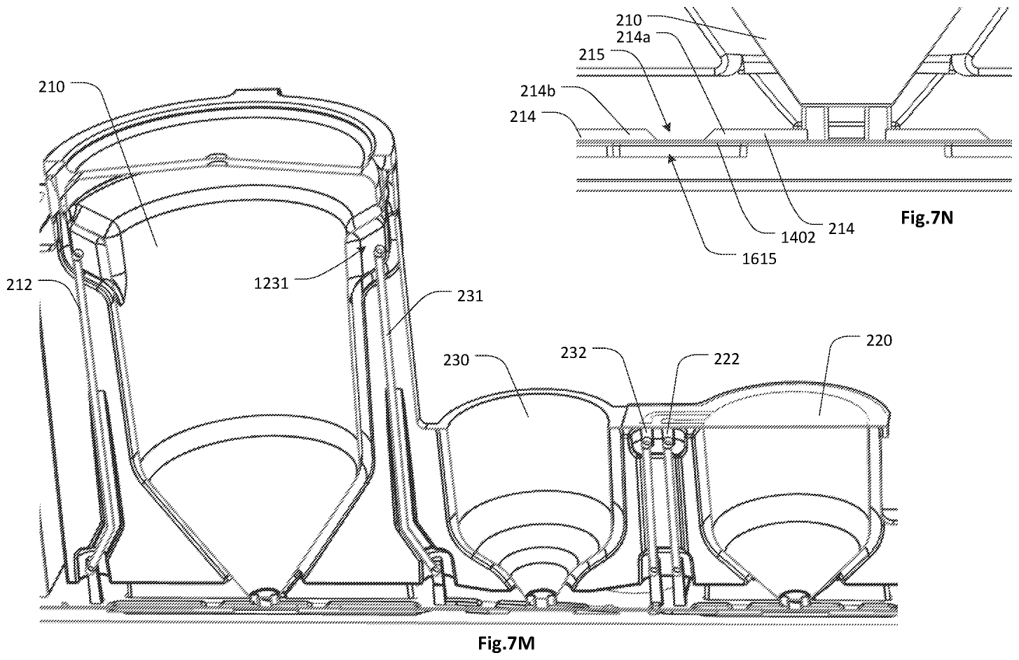

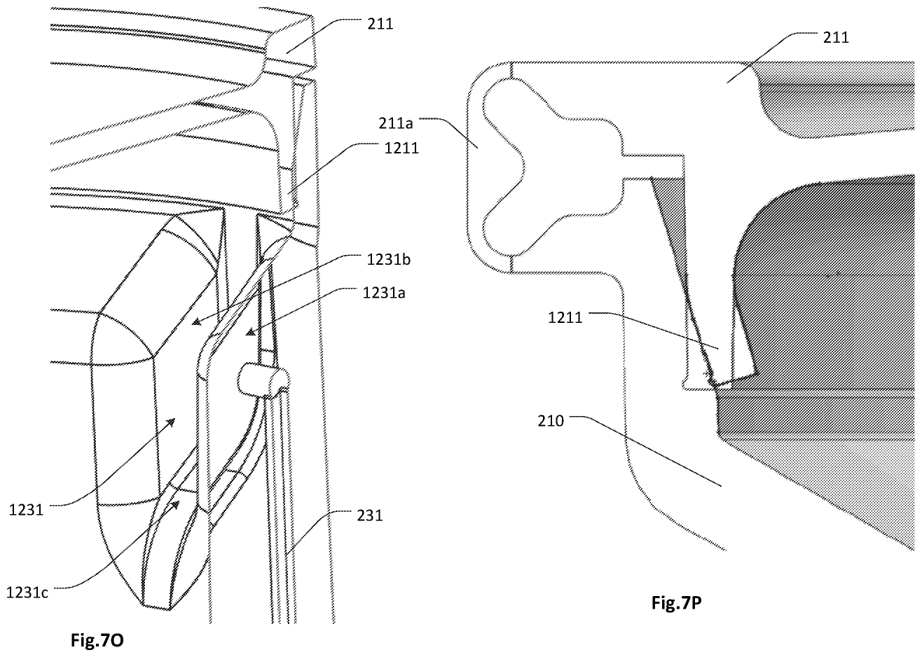

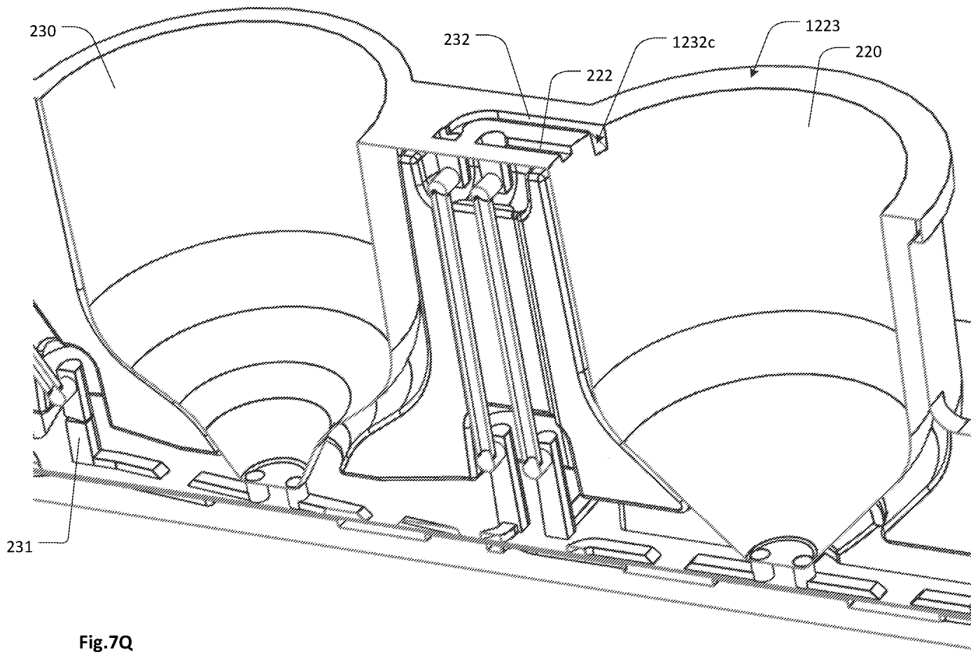

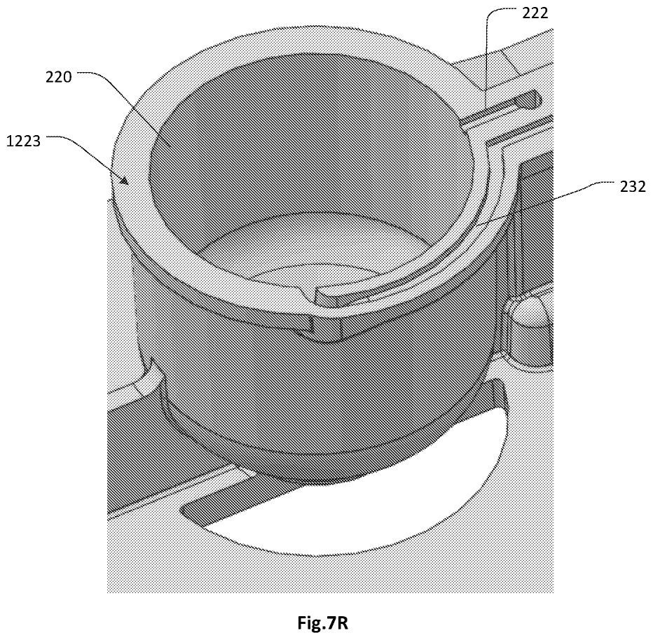

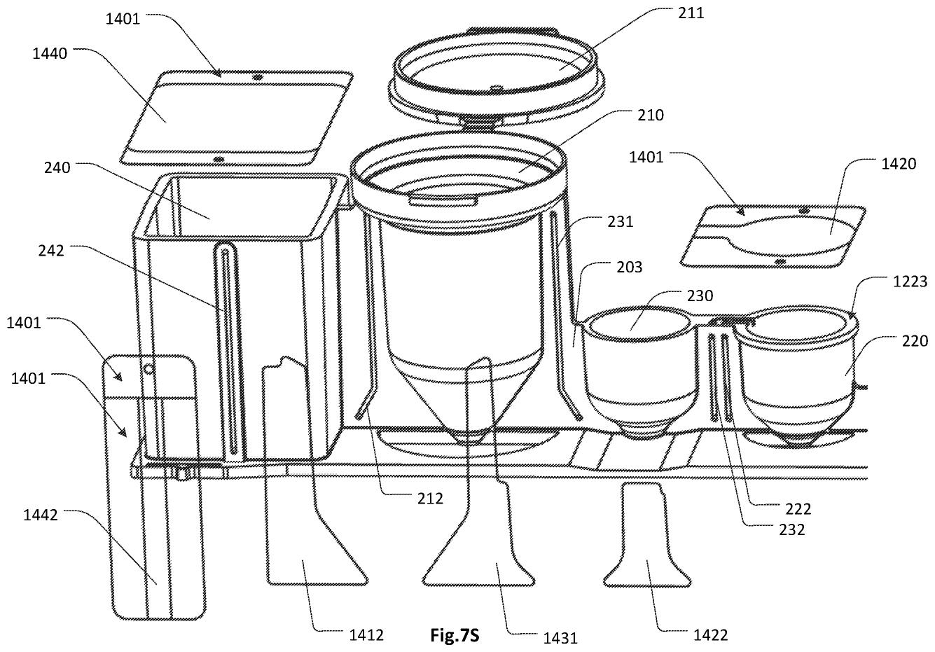

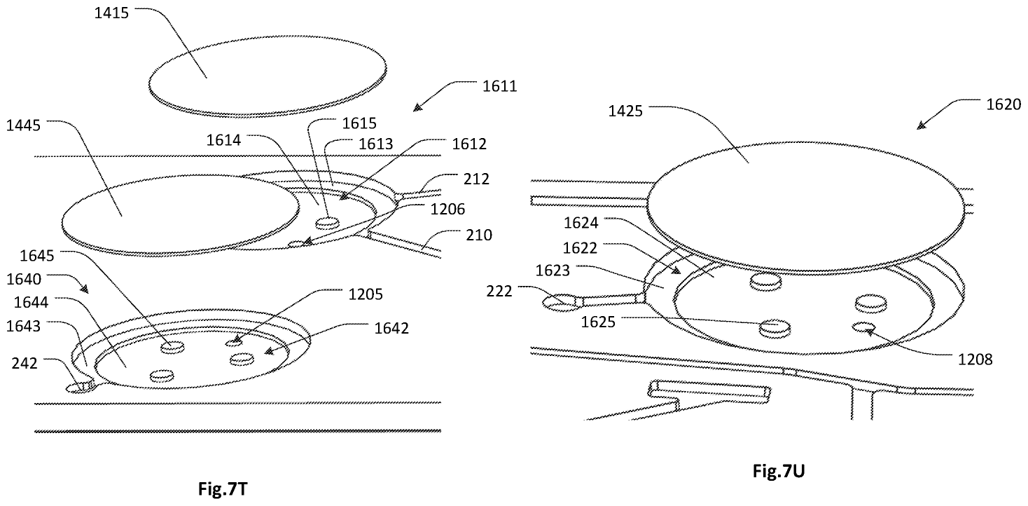

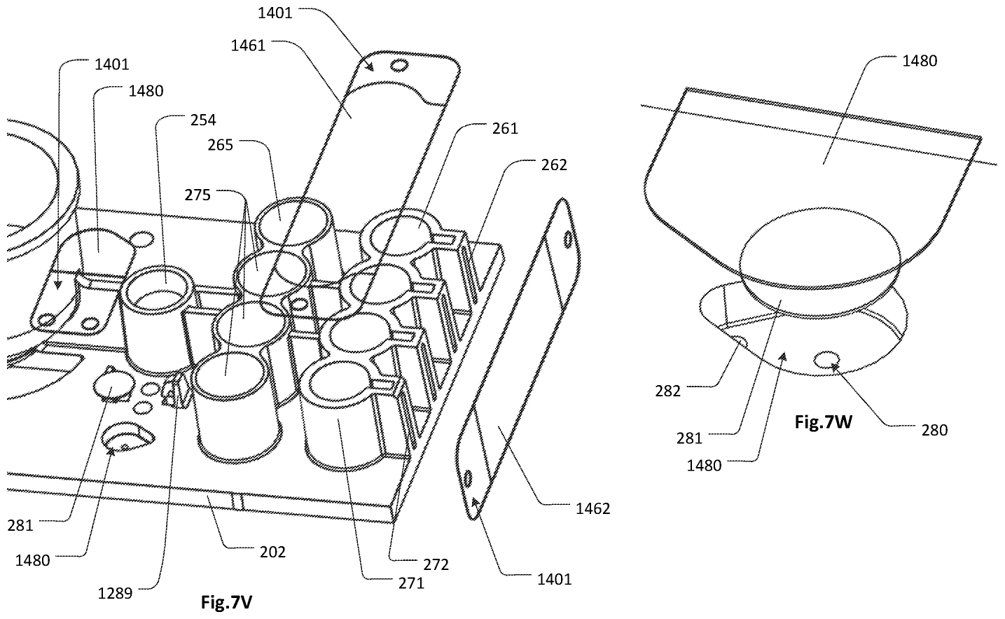

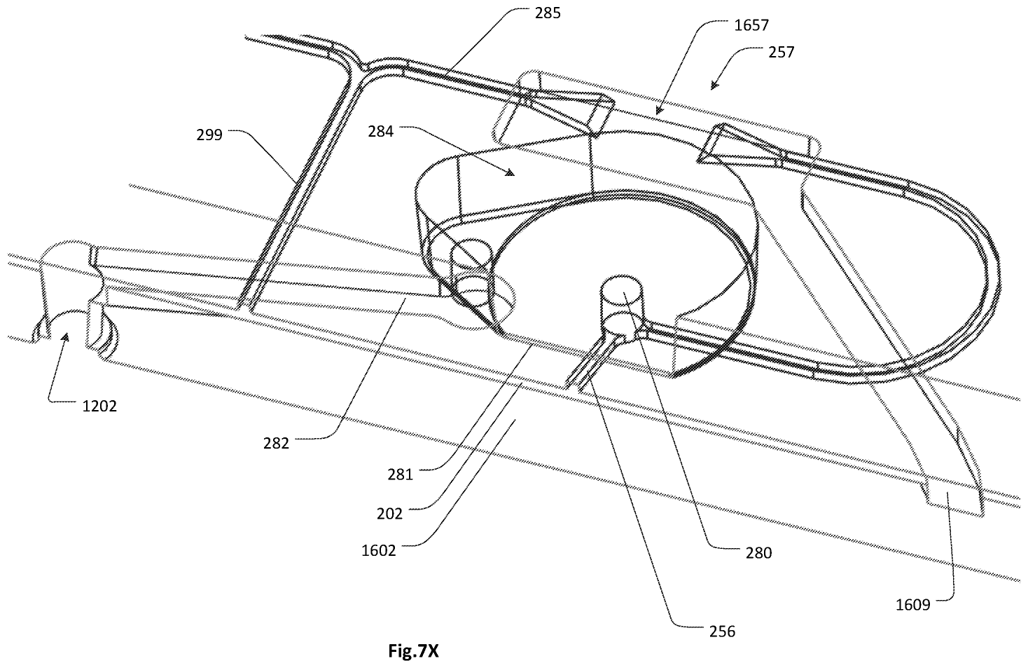

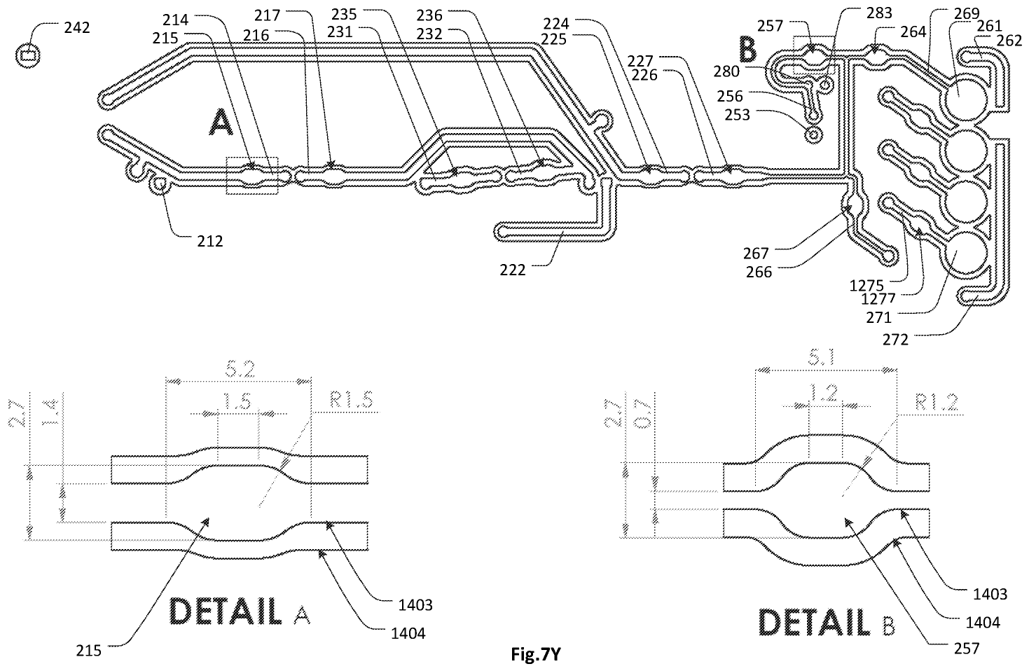

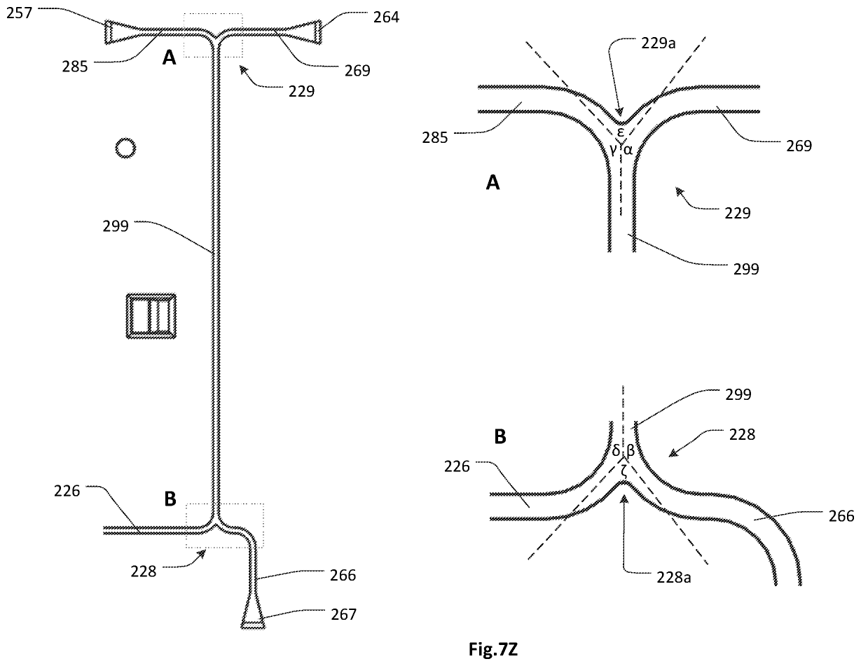

Referring to FIGS. 5C to 5F, the core unit 1100 is shown in further detail, according to some embodiments, which may be configured to receive a sample cartridge 200 (or sample cartridge 1000 shown in FIG. 7A) as described further below.

The core unit 1100 may at least partially define the cartridge slots or sockets 120, each configured to receive a cartridge 1000. Each cartridge socket 120 may have an associated pneumatic interface plate 1500 (FIG. 5D) configured to engage and connect the cartridge 1000 to the pneumatic module 500 via pneumatic lines 515.

The pneumatic plate 1500 may define pneumatic plate ports 1501, 1502, 1503, 1504, 1505, 1506, 1507, 1508, 1509, 1510 in fluid communication with the pneumatic lines 515. The pneumatic plate ports are in turn configured to connect with corresponding cartridge pneumatic ports 1201, 1202, 1203, 1204, 1205, 1206, 1207, 1208, 1209, 1210 in the cartridge 1000 (FIG. 7B). The pneumatic plate ports may be arranged differently or different in number to suit other different sample cartridges. The arrangement of and connection between the corresponding pneumatic plate ports and cartridge pneumatic ports on the underside of the sample cartridge 1000 can be understood by comparing FIGS. 5D, and 7B:
cartridge port 1201 is configured to connect to pneumatic plate port 1501;
cartridge port 1202 is configured to connect to pneumatic plate port 1502;
cartridge port 1203 is configured to connect to pneumatic plate port 1503;
cartridge port 1204 is configured to connect to pneumatic plate port 1504;
cartridge port 1205 is configured to connect to pneumatic plate port 1505;
cartridge port 1206 is configured to connect to pneumatic plate port 1506;
cartridge port 1207 is configured to connect to pneumatic plate port 1507;
cartridge port 1208 is configured to connect to pneumatic plate port 1508;
cartridge port 1209 is configured to connect to pneumatic plate port 1509;
cartridge port 1210 is configured to connect to pneumatic plate port 1510.

The pneumatic module 500 may be configured to selectively adjust the pressure in each pneumatic line 515, independently, in order to drive liquid flows within the channels of the cartridge 1000 and/or to operate valves in the cartridge 1000.

In some embodiments, the sample cartridge may be configured for positive operating pressure (above ambient pressure) in some or all of the pneumatic lines 515. In the illustrated embodiment, the sample cartridge 1000 is configured for negative operating pressures (below ambient pressure) in all of the pneumatic lines 515.

In some embodiments, the sample cartridge may be configured for operating pressures at a single pressure level. In the illustrated embodiment, the sample cartridge 1000 is configured for two operating pressure levels. The first operating pressure may be a relatively high magnitude negative pressure in the range of 180 mBar to 500 mBar, 190 mBar to 350 mBar, or about 200 mBar, for example. The second operating pressure may be a relatively low magnitude negative pressure in the range of 50 mBar to 200 mBar, 80 mBar to 150 mBar, 100 mBar to 120 mBar or about 120 mBar, for example. The difference between the two pressure levels may be in the range of 20 mBar to 200 mBar, 50 mBar to 100 mBar, at least 20 mBar, at least 50 mBar or at least 100 mBar, for example. The cartridge pneumatic ports 1201, 1202, 1203, 1204, 1205 may be configured for the relatively high first operating pressure. The cartridge pneumatic ports 1206, 1207, 1208, 1209, 1210 may be configured for the relatively low second operating pressure.

The socket 120 may comprise parallel rails 1120 defining grooves configured to slidably accommodate edges 1220 of the cartridge base 202 when inserted in the socket 120. The rails 1120 may include recesses 1122 configured to receive a resilient clip 1222 integrally formed with the cartridge base 202 (FIG. 7F).

The pneumatic interface plate 1500 is positioned below the socket 120 and may be biased to an engaged position by springs. The core unit 1100 may comprise a core carriage 1190 which is configured to move up and down a pair of lead screws 1191 operated by motors 1192, which form part of the motion module 900. The core carriage 1190 can be seen in FIG. 5E which omits some of the components of the core unit 1100 to better visualise the internal components.

The pneumatic plates 1500 may be connected to retraction rods 1520, which pass through the core carriage 1190 such that it can slide up and down the retraction rods 1520, and the lower ends of the retraction rods 1520 comprise stops 1522 positioned below the core carriage 1190. When the core carriage 1190 is lowered beyond engagement with the stops 1522, the retraction rods 1520 and pneumatic interface plates 1500 are lowered along with the core carriage 1190.

The retraction of the interface plates 1500 allows the cartridges 1000 to be inserted into the sockets 120. The motion module 900 can be operated to raise the core carriage 1190 allowing the springs to raise the interface plate 1500 and urge it against the base 202 of the cartridge 1000, clamping it between the interface plate 1500 and the rails 1120.

The pneumatic interface plates 1500 may comprise gaskets or sealing portions 1530 surrounding each of the pneumatic plate ports 1501, 1502, 1503, 1504, 1505, 1506, 1507, 1508, 1509, 1510, which are configured to be compressed and deformed between the pneumatic plate 1500 and the cartridge 1000 to provide a seal around the connection between the corresponding pneumatic ports 1501, 1201. The gaskets 1530 may be formed of any suitable elastomeric material, such as rubber, silicone, or other polymers, for example. The gaskets 1530 may define a frustoconical shape, for example or any other suitable shape for providing a seal between the opposing flat surfaces of the pneumatic interface plate 1500 and the bottom of the cartridge 1000.

The thermal module 600 may comprise heaters 610 including a radiator 662 at one end and a cooling fan 663 at an opposite end (FIG. 5F), which may be mounted to the core carriage 1190 or an independent motion stage.

Radiator 662 and magnets 710 may define a slit, as shown in FIGS. 5D and 5E, to allow them to extend through apertures 1230 in the base of the cartridge 1000, as shown in FIGS. 7B and 5F, allowing closer proximity between the radiator 662, magnets 710 and reaction vessels 210, 220.

Referring to FIGS. 7A to 7Z, the sample cartridge 1000 is shown in further detail, according to some embodiments. The sample cartridge 1000 may include similar features to those described in relation to sample cartridge 200, and similar features are indicated with like reference numerals.

Referring to FIG. 7C, the sample cartridge 1000 is shown in an exploded perspective view illustrating the various components that are combined to form the sample cartridge 1000.

The sample cartridge 1000 comprises a body 1001, which defines the base 202, primary reaction vessel 210, secondary reaction vessel 220, reagent vessel 230 and waste vessel 240. The body 1001 also defines other features described in detail below.

The body 1001 may be formed by any suitable means of any material which is suitable for a particular application. Some applications may require non-reactive materials suitable for the sample and reagents to be processed. The body 1001 may be injection moulded and formed of a non-reactive polymer material, such as polycarbonate or polyprolyene, for example.

The body 1001 defines a plurality of channels, as described in relation to sample cartridge 200, and further below in relation to cartridge 1000. Some of the channels defined in the body 1001 are partly open to facilitate manufacturing by injection moulding. Some of the vessels defined by the body 1001 may be formed with openings to facilitate manufacturing. The cartridge 1000 may comprise a plurality of membranes which are connected to the body 1001 to cover and seal some of the vessel openings and to cover the open channels and cooperate to define the channels.

The membranes may be formed of any suitable material, such as polypropylene, for example, and may have a thickness in the range of 20 μm to 200 μm, 50 μm to 150 μm, or about 100 μm, for example.

The membranes may be fixed to the body 1001 by adhesive bonding and/or welding, such as heat welding or laser welding, for example.

The cartridge 1000 may comprise:
a base membrane 1402 is to cover the channels defined in the base 202;
a waste top membrane 1440 to cover and seal the top of the waste vessel 240
a waste side membrane 1442 to cover part of the waste pneumatic channel 242;
a primary pneumatic side membrane 1412 to cover part of the primary pneumatic channel 212;
a primary reagent side membrane 1431 to cover part of the primary reagent channel 231
a secondary top membrane 1420 to cover and seal the top of the secondary reagent vessel 220;
a secondary side membrane 1422 to cover part of the secondary pneumatic channel 222 and secondary reagent channel 232;

an intermediate outlet membrane 1480 to cover and seal the top of the intermediate outlet chamber 284T;
a QC top membrane 1461 to cover and seal the tops of the QC vessel 261 and QC reference vessels 271; and
a QC side membrane 1462 to cover part of the QC pneumatic channel 262 and QC reference pneumatic channels 272.

The cartridge 1000 further may comprise a pneumatic channel plate 1602, which defines the cartridge pneumatic ports 1201, 1202, 1203, 1204, 1205, 1206, 1207, 1208, 1209, 1210 and a plurality of pneumatic channels connecting the pneumatic ports to corresponding pneumatic ports and pneumatic channels in the base 202 to drive fluid flows through the fluid channels in the base and to operate the cartridge valves. The pneumatic channel plate 1602 may also define valve recesses which cooperate with valve ports defined in the base 202 and with the base membrane 1402 to define the valves, as described further below in relation to FIGS. 7J and 7N.

The pneumatic channel plate 1602 may be coupled to the base 202 with the base membrane 1402 sandwiched between them. The pneumatic channel plate 1602 may be adhesively bonded to the base membrane 1402 and/or the base 202 by adhesive bonding, such as with a pressure sensitive adhesive (PSA), for example, 3M 300LSE adhesive. The adhesive may be prepared as a PSA layer 1606, defining apertures corresponding to certain portions that don't require bonding, such as the valves and pneumatic ports of the base 202, for example.

The cartridge 1000 may further comprise gas permeable membranes configured to allow the passage of air but resist or prevent the passage of liquid. As discussed in relation to sample cartridge 200, gas permeable membranes may be used to restrict liquid which may inadvertently enter pneumatic channels in the cartridge 100 from escaping the cartridge 1000 during processing and potentially contaminating the instrument 100.

The gas permeable membranes may be formed of any suitable material for a given application considering the sample and reagents involved, such as a hydrophobic gas permeable membrane, for example, PTFE or PP. The gas permeable membranes may have a thickness in the range of 20 μm to 200 μm, 50 μm to 150 μm, or about 110 μm, for example.

The cartridge 1000 may comprise:
a primary permeable membrane 1415 associated with the primary pneumatic channel 212 (and optionally also associated with the QC the QC pneumatic channel 262 and QC reference pneumatic channels 272);
a secondary permeable membrane 1425 associated with the secondary pneumatic channel 222;
a waste permeable membrane 1445 associated with the waste pneumatic channel 242; and
an intermediate outlet permeable membrane 281 associated with the intermediate outlet 280.

FIGS. 7D and 7E show the top and bottom surfaces of the base 202, base membrane 1402, PSA layer 1606 and pneumatic channel plate 1602 and illustrate how the components are aligned to connect together in a stack of layers.

The base 202 defines a plurality of channels which are recessed into the bottom surface of the base 202, which are covered by the base membrane 1402 to define the channels. The base membrane 1402 and PSA layer 1606 define simple sheets with through thickness apertures corresponding to various ports, valves and apertures in the base 202 and pneumatic channel plate 1602. The pneumatic channel plate 1602 defines a plurality of pneumatic channels, and valve recesses in a top surface of the pneumatic channel plate 1602, and the cartridge pneumatic ports 1201, 1202, 1203, 1204, 1205, 1206, 1207, 1208, 1209, 1210 are defined in a bottom surface of the pneumatic channel plate 1602.

FIGS. 7F to 7K show lateral cross-sections through each of the layers viewed from below the cartridge 1000 to facilitate comparison between the layers to illustrate the paths of and connections between the vessels, channels, valves and ports. FIG. 7L shows the channels and valves of the base 202 (FIG. 7G) superimposed on the channels, valve recesses and pneumatic ports of the pneumatic channel plate 1602 (FIG. 7J) for direct comparison and to see the alignment of the corresponding features.

FIG. 7F shows an upper layer of the base 202 just above the base channels. The edges 1220 and resilient clips 1222 of the base 202 are shown, which are configured to engage the rails 1120 and clip recesses 1122 of the cartridge sockets 120.

The base may also define a recessed portion 1230 surrounding the reagent vessel 230 with a reduced thickness to mitigate against warping due to material shrinkage after injection moulding. For example, the base 202 may have a thickness of approximately 2.5 mm in other regions, and taper down to approximately 1.5 mm in the recessed portion 1230.

FIG. 7G shows the channels formed in the bottom surface of the base 202. Referring to FIGS. 7F and 7G, these channels will be described, corresponding to the flow circuit diagram of FIG. 2G for exemplary purposes only. The channels and valves may be arranged differently in other embodiments, and may comprise different channels and valves associated with different combinations of vessels.

The primary waste channel 214 extends between an outlet in the bottom of the primary reaction vessel 210 and an inlet in the bottom of the waste vessel 240 via the primary waste valve 215 shown as a gap between two valve ports in FIG. 7G.

The secondary waste channel 224 extends between an outlet in the bottom of the secondary reaction vessel 220 and an inlet in the bottom of the waste vessel 240 via the secondary waste valve 225 shown as a gap between two valve ports in FIG. 7G.

The primary reagent channel 231 extends between an outlet in the bottom of the reagent vessel 230 and an inlet in the primary reaction vessel 210 (FIG. 7M) via the primary reagent valve 235 shown as a gap between two valve ports in FIG. 7G.

As discussed previously, the inlet of the primary reagent channel 231 may open into the primary reaction vessel 210 near a top of the primary reaction vessel 210, as shown in FIG. 7M, and in further detail in FIG. 7O.

In some embodiments, the primary reaction vessel 210 may define an inlet recess 1231 to reduce splashing of liquid reagents entering the primary reaction vessel 210. The primary reagent channel 231 may open into a first side wall 1231a of the inlet recess 1231, opposite an opposing second side wall 1231b of the inlet recess 1231. The inlet recess 1231 may be partially defined by a convex surface 1231c between the first and second side walls 1231a, 1231b. Liquid reagents entering the inlet recess 1231 at relatively high speed may impinge on the second side wall 1231b and then run down the convex surface 1231c and down the side wall of the primary reaction vessel 210. The convex surface 1231c may smoothly transition between the inlet recess 1231 and the side wall of the primary reaction vessel 210. These features may reduce or mitigate against splashing of the reagents in the primary reaction vessel 210, which might otherwise result in residual fluids being left on the side walls or potentially being aspirated into the pneumatic channel 212.

The primary reaction vessel 210 may define a similar recess at the opening to the primary pneumatic channel 212 to reduce the likelihood of liquid being aspirated into the primary pneumatic channel 212.

The secondary reagent channel 232 extends between an outlet in the bottom of the reagent vessel 230 and an inlet in the secondary reaction vessel 220 (FIG. 7M) via the secondary reagent valve 236 shown as a gap between two valve ports in FIG. 7G.

As discussed previously, the inlet of the secondary reagent channel 232 may open into the secondary reaction vessel 220 near a top of the secondary reaction vessel 220, as shown in FIG. 7M, and in further detail in FIG. 7Q.

In some embodiments, the secondary reaction vessel 230 may define an inlet recess similar to the inlet recess 1231 of the primary reaction vessel 210. In some embodiments, the secondary reagent channel 232 may open directly into the secondary reaction vessel 220. In some embodiments, the secondary reaction vessel 220 may define a concave surface 1232c leading from the secondary reagent channel 232 to the secondary reaction vessel 220. The concave surface 1232c may smoothly transition between the secondary reagent channel 232 and the side wall of the secondary reaction vessel 220.

Referring to FIGS. 7O and 7P, the lid 211 of the primary reaction vessel 210 may be integrally formed with the body 1001 and connected to the primary reaction vessel 210 via a flexible hinge portion 211a. The lid 211 may comprise a resiliently deformable annular flange 1211 configured to engage an upper rim of the primary reaction vessel 210 in a press-fit, snap-fit or interference fit connection, for example, to seal the primary reaction vessel 210.

It will be understood that references to vessels, chambers or channels being sealed in the specification is intended to mean sealed other than to the defined inlets and outlets to various ports and channels. In some cases, a fluid tight or air tight seal may be formed. However, depending on the application, a perfect seal may not be required and there may be some fluid leakage.

The secondary reagent channel 232 and secondary pneumatic channel 222 may be partially defined in a top surface 1223 surrounding the top of the secondary reaction vessel 230, and open into the secondary reaction vessel 230 in relative proximity, as shown in FIG. 7Q.

In some embodiments, the opening of the secondary reagent channel 232 into the secondary reaction vessel 230 may be relatively distant from the opening of the secondary pneumatic channel 222 into the secondary reaction vessel 230. For example, the openings may be separated by a distance in the range of 2 mm to 20 mm, 3 mm to 10 mm, 5 mm to 8 mm, or at least 2 mm, at least 3 mm, at least 5 mm, or at least 10 mm.

The secondary reagent channel 232 may extend part way around the circumference of the secondary reaction vessel 230 in the top surface 1223, to achieve a separation between the openings, as shown in FIG. 7R, for example. Alternatively, or additionally, the primary pneumatic channel 222 may extend part way around the circumference of the secondary reaction vessel 230 in the top surface 1223.

This arrangement may mitigate against or reduce the likelihood of reagents that are entering the secondary reaction vessel 220 from the secondary reagent channel 232 inadvertently being aspirated into the secondary pneumatic channel 222.

The primary output channel 216 extends from an outlet in the bottom of the primary reaction vessel 210 to join the secondary reagent channel 232 via the primary output valve 217 shown as a gap between two valve ports in FIG. 7G.

The secondary output channel 226 extends from an outlet in the bottom of the secondary reaction vessel 220 to the buffer junction 228 via the secondary output valve 227 shown as a gap between two valve ports in FIG. 7G.

From the buffer junction 228, the volumetric metering and QC module 260 may include similar channels and valves as described in relation to the close-up of FIG. 2F, but they may be arranged differently, as shown in FIG. 7G.

In particular, the base 202 defines reference buffer channels 1275 extending from outlets in the bottom of each of the QC reference buffer vessels 275 to the corresponding QC reference vessels 271 via reference buffer valves 1277. This allows for the QC pneumatic channel 262 and QC reference pneumatic channels 272 to be connected to a single pneumatic line 515 while allowing the QC reference pneumatic channels 272 to be shut off by closing the reference buffer valves 1277.

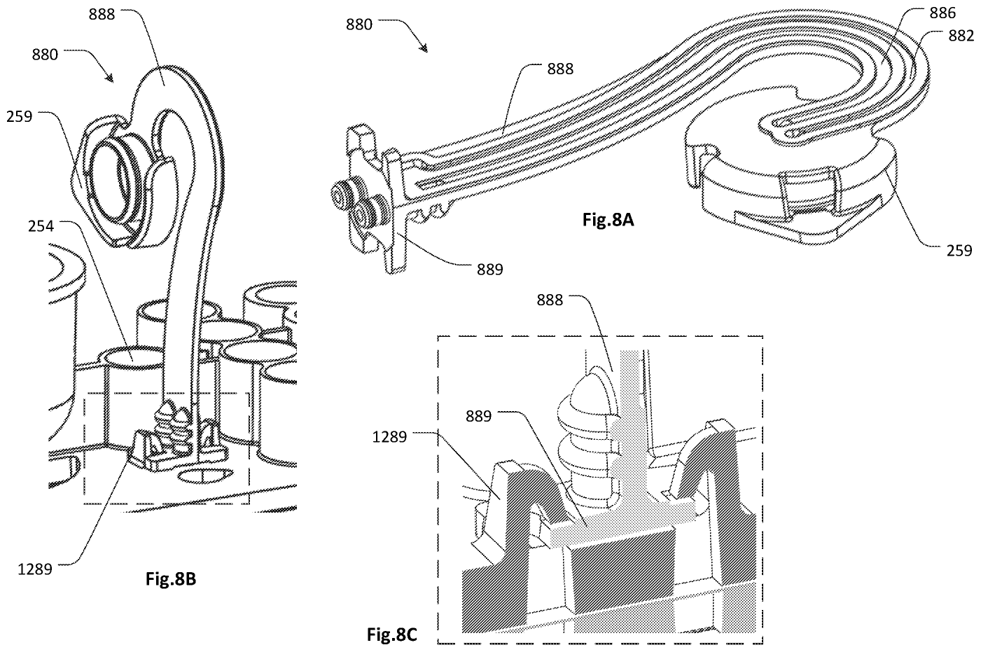

The final output channel 256 terminates in a fluid connection port 1256 adjacent the output vessel pneumatic port 253 and a mechanical clip 1280 configured to connect to a fluid transfer apparatus 880, shown in FIGS. 8A to 8C which in turn provide fluid communication between the final output channel 256 and output vessel pneumatic port 253 and the output vessel 250.

Part of the waste pneumatic channel 242 is shown, which extends up the side of the waste vessel 240 as shown in FIG. 7S, and down to connect to a waste fluid trap 1640, as shown in FIG. 7J. The waste fluid trap 1640 comprises a chamber defined by the base membrane 1402 and a recess 1642 in the pneumatic channel plate 1602.

The recess 1642 defines an annular ledge 1643 set at a level above a lower surface 1644 of the recess 1642. The waste pneumatic channel 242 extends through part of the pneumatic channel plate 1602 to be in fluid communication with the recess 1642 connecting through a side wall of the recess 1642 above the level of the ledge 1643, as shown in FIGS. 7J and 7T. The lower surface 1644 defines an aperture which forms cartridge pneumatic port 1205.

The waste permeable membrane 1445 is fixed to the ledge 1643 (e.g., by adhesive or heat welding) to separate cartridge pneumatic port 1205 from the waste pneumatic channel 242, so that any fluid inadvertently aspirated in the waste pneumatic channel 242 is caught in the waste fluid trap 1640 and is restricted from passing through the waste permeable membrane 1445 to the cartridge pneumatic port 1205.

The waste fluid trap 1640 may further comprise spacer protrusions 1645 extending away from the lower surface 1644 up to the level of the ledge 1643 in order to support the waste permeable membrane 1445.

Part of the primary and secondary pneumatic channels 212, 222 are shown extending up the side of the primary and secondary reaction vessels 210, 220 in FIG. 7F, and down towards the pneumatic channel plate 1602 in FIG. 7G. And the QC pneumatic channel 262 and QC reference pneumatic channels 272 are shown extending up the side of the QC vessel 261 and QC reference vessels 271 in FIG. 7F, and down towards the pneumatic channel plate 1602 via channels shown in FIG. 7G.

Similar to the waste fluid trap 1640, The primary and secondary pneumatic channels 212, 222 connect to primary and secondary fluid traps 1611, 1620, respectively. The QC pneumatic channel 262 and QC reference pneumatic channels 272 also connect to the primary fluid trap 1611, as shown in FIG. 7J.

The primary fluid trap 1611 comprises a chamber defined by the base membrane 1402 and a recess 1612 in the pneumatic channel plate 1602.

The recess 1612 defines an annular ledge 1613 set at a level above a lower surface 1614 of the recess 1612. The primary pneumatic channel 210 extends through part of the pneumatic channel plate 1602 to be in fluid communication with the recess 1612 connecting through a side wall of the recess 1612 above the level of the ledge 1613, as shown in FIGS. 7J and 7T. The lower surface 1614 defines an aperture which forms cartridge pneumatic port 1206.

The primary permeable membrane 1415 is fixed to the ledge 1613 (e.g., by adhesive or heat welding) to separate cartridge pneumatic port 1206 from the primary pneumatic channel 210, so that any fluid inadvertently aspirated in the primary pneumatic channel 210 is caught in the primary fluid trap 1611 and is restricted from passing through the primary permeable membrane 1415 to the cartridge pneumatic port 1206.

Similarly, the QC pneumatic channel 262 and QC reference pneumatic channels 272 both connect to a common QC pneumatic channel 1660 in the pneumatic channel plate 1602 which connects through a side wall of the recess 1612 above the level of the ledge 1613, as shown in FIGS. 7J and 7T. Any fluid inadvertently aspirated in the QC pneumatic channel 262 or QC reference pneumatic channels 272 is caught in the primary fluid trap 1611 and is restricted from passing through the primary permeable membrane 1415 to the cartridge pneumatic port 1206.

The primary fluid trap 1611 may further comprise spacer protrusions 1615 extending away from the lower surface 1614 up to the level of the ledge 1613 in order to support the primary permeable membrane 1415.

Similar to the waste and primary fluid traps 1640, 1611, the secondary fluid trap 1620 comprises a chamber defined by the base membrane 1402 and a recess 1622 in the pneumatic channel plate 1602.

The recess 1622 defines an annular ledge 1623 set at a level above a lower surface 1624 of the recess 1622. The secondary pneumatic channel 220 extends through part of the pneumatic channel plate 1602 to be in fluid communication with the recess 1622 connecting through a side wall of the recess 1622 above the level of the ledge 1623, as shown in FIGS. 7J and 7U. The lower surface 1624 defines an aperture which forms cartridge pneumatic port 1208.

The secondary permeable membrane 1425 is fixed to the ledge 1623 (e.g., by adhesive or heat welding) to separate cartridge pneumatic port 1208 from the secondary pneumatic channel 220, so that any fluid inadvertently aspirated in the secondary pneumatic channel 220 is caught in the secondary fluid trap 1620 and is restricted from passing through the secondary permeable membrane 1425 to the cartridge pneumatic port 1208.

The secondary fluid trap 1620 may further comprise spacer protrusions 1625 extending away from the lower surface 1624 up to the level of the ledge 1623 in order to support the secondary permeable membrane 1425.

The shape, depth, diameter and volume of the fluid traps 1611, 1620, 1640 (as well as the exposed area of the gas permeable membranes 1415, 1425, 1445) may be adjusted for different applications depending on the amount of liquid which may be inadvertently aspirated in the pneumatic channels. The volume in the fluid traps above the membranes may be in the range of 10 μL to 1 mL, 50 μL to 500 μL, or about 100 μL, for example, while the surface area of the membranes may be in the range of 50 mm² to 500 mm², 100 mm² to 300 mm², or about 200 mm², for example.

Alternatively, in some embodiments, other types of fluid traps may be employed, such as microfluidic or gravity type fluid traps. In some embodiments, fluid traps may be omitted entirely.

Referring to FIG. 7S, part of the waste pneumatic channel 242 may be defined in an external side face of the waste vessel 240 and sealed by waste side membrane 1442. The top of the waste vessel 240 may be sealed by waste top membrane 1440.

Part of each of the primary pneumatic channel 212, primary reagent channel 231, secondary pneumatic channel 222 and secondary reagent channel 232, may be defined in an external side surface of the support web 203 (which extends between the waste vessel 240, primary reaction vessel 210, reagent vessel 230, and secondary reaction vessel 220) and sealed by corresponding side membranes 1412, 1431, 1422, as shown in FIG. 7S. Other parts of the channels 212, 231, 222, 232 may be defined entirely by the body 1001, as shown in FIGS. 7M and 7Q, for example, near the base 202 and/or near the tops of the reaction vessels 210, 220.

Part of the secondary pneumatic channel 222 and secondary reagent channel 232 may be defined in the top surface 1223 as shown in FIGS. 7Q and 7R, and sealed by secondary top membrane 1420.

The sealing membranes may comprise breakaway portions 1401 to facilitate assembly, which may be removed once the corresponding sealing membrane is fixed to the body 1001.

Referring to FIG. 7V, part of the QC pneumatic channel 262 and QC reference pneumatic channels 272 may be defined in an external side face of the QC vessel 261 and QC reference vessels 271, and sealed by QC side membrane 1462. And QC top membrane 1461 may be provided to cover and seal the tops of the QC vessel 261 and QC reference vessels 271.

The intermediate outlet membrane 1480 may be fixed to a top surface of the base 202 to cover and seal the top of the intermediate outlet chamber 284. This is shown in further detail, in FIGS. 7W and 7X.

The intermediate outlet chamber 284 may be defined by a recess in the top surface of the base 202. A bottom surface of the outlet chamber 284 may define the intermediate outlet 280 and an opening to the intermediate outlet pneumatic channel 282. The intermediate outlet permeable membrane 281 may be fixed (adhesive or heat welding) to the bottom surface of the intermediate outlet chamber 284 to cover the intermediate outlet 280, but not the intermediate outlet pneumatic channel 282. The top opening of the intermediate outlet chamber 284 may be sealed by the intermediate outlet membrane 1480.

When the pneumatic module 500 is operated to reduce pressure in the intermediate outlet pneumatic channel 282, air may be drawn through the permeable membrane 281 from the metering channel 299 (and/or outlet channel 285), such that liquid in the metering channel is drawn up to the membrane 281 without passing into the chamber 284.

Referring to 7J, the pneumatic channel plate 1602 also defines a plurality of pneumatic channels connecting other pneumatic ports to valve recesses to allow operation of the cartridge valves. The cartridge valves comprise switch valves configured as shown in FIG. 2K.

For example, a vertical cross-section of the primary waste valve 215 is shown in FIG. 7N. The primary waste channel 214 may be defined in the base 202 extending from the outlet in the bottom of the primary reaction vessel 210 toward the waste vessel 240. There may be a break in the primary waste channel 214 which is separated into two sections terminating in first and second valve ports 214a and 214b at the valve 215.

The valve ports 214a, 214b may be closed in a rest configuration by the base membrane 1402 (which also closes corresponding valve ports in all of the other cartridge valves in a rest configuration). On the other side of the base membrane 1402, opposite the valve ports 214a, 214b is a primary waste valve recess 1615 defined by the pneumatic channel plate 1602 and extending between the valve ports 214a, 214b (on the opposite side of the base membrane 1402).

The primary waste valve recess 1615 may be connected to the cartridge pneumatic port 1204, such that the pneumatic module 500 can be operated to reduce the pressure in the primary waste valve recess 1615, which causes a deflection of the base membrane 1402 towards the primary waste valve recess 1615 to open the primary waste valve 215 and allow fluid communication between the first and second valve ports 214a, 214b. In some embodiments, positive pressure may be applied to the valve recess 1615 (and others) to ensure that the valve remains closed, for example, during operations that might put pressure on the valve to open.

In a similar manner, the other cartridge valves may comprise valve ports and corresponding valve recesses connected to cartridge pneumatic ports by pneumatic channels to allow operation of the valves by the pneumatic module 500.

The pneumatic channel plate 1602 defines primary waste valve recess 1615 corresponding to the primary waste valve 215 and connected to cartridge pneumatic port 1204 via pneumatic channel 1604.

The pneumatic channel plate 1602 defines a secondary reagent valve recess 1636 corresponding to the secondary reagent valve 236 and connected to cartridge pneumatic port 1204 via pneumatic channel 1604.

The pneumatic channel plate 1602 defines a primary output valve recess 1617 corresponding to the primary output valve 217 and connected to cartridge pneumatic port 1207 via pneumatic channel 1607.

The pneumatic channel plate 1602 defines a primary reagent valve recess 1635 corresponding to the primary reagent valve 235 and connected to cartridge pneumatic port 1203 via pneumatic channel 1603.

The pneumatic channel plate 1602 defines a secondary waste valve recess 1625 corresponding to the secondary waste valve 225 and connected to cartridge pneumatic port 1203 via pneumatic channel 1603.

The pneumatic channel plate 1602 defines a secondary outlet valve recess 1627 corresponding to the secondary outlet valve 227 and connected to cartridge pneumatic port 1209 via pneumatic channel 1609.

The pneumatic channel plate 1602 defines a final output valve recess 1657 corresponding to the final output valve 257 and connected to cartridge pneumatic port 1209 via pneumatic channel 1609.

The pneumatic channel plate 1602 defines three reference buffer valve recesses 1677 corresponding to the three reference buffer valves 1277 and connected to cartridge pneumatic port 1209 via pneumatic channel 1609.

The pneumatic channel plate 1602 defines a QC vessel valve recess 1664 corresponding to the QC vessel valve 264 and connected to cartridge pneumatic port 1210 via pneumatic channel 1610.

The pneumatic channel plate 1602 defines a QC buffer valve recess 1667 corresponding to the QC buffer valve 267 and connected to cartridge pneumatic port 1210 via pneumatic channel 1610.

The valve recesses may comprise any suitable size, shape and proportion for a particular application. For example, the valve recesses may be generally rectangular with rounded corners, as shown in the drawings. The valve recesses of the illustrated embodiment are all similar in dimensions, with a length of about 6 mm, a width of about 2 mm, and a depth of about 0.5 mm, for example.

The pneumatic channels defined in the pneumatic channel plate 1602 are about 0.5 mm in depth and about 1 mm wide.

Similarly, the fluid channels may have a depth of about 0.5 mm and a width of about 1 mm. However, some of the fluid channels may have lesser dimensions, such as for the volumetric metering section, for example, where a smaller channel cross-section allows for more precise control of the volumetric flow rate and volume of liquid in the channels.

For example, channels 226, 256, 266, 269, 299, 285, may have a width of less than 0.5 mm, less than 0.3 mm, or about 0.25 mm, and a depth of less than 1 mm, less than 0.5 mm, less than 0.3 mm, or about 0.2 mm. These channels may flare to form the valve ports for each valve to a width of about 1 mm, for example, as shown in FIG. 7X.

In some embodiments, all of the valve ports may flare out from the corresponding channels, as shown in FIG. 7Y, which illustrates a welding pattern for welding the base membrane 1402 to the base 202 (by heat welding or laser welding, for example). Some suitable dimensions are provided in the close-up views of FIG. 7Y for different valves in the cartridge 1000, for exemplary purposes only. The corresponding valve recesses in the pneumatic channel plate 1602 may substantially conform to the shape and dimensions shown in FIG. 7Y, for example.

The welding pattern may comprise inner weld lines 1403, running along the edges of the channels and connecting the valve ports to form the valves. In some embodiments, the welding pattern may also comprise outer weld lines 1404 providing a second barrier around the channels for redundancy.

Referring to FIG. 7Z, the metering channel 299 is shown in further detail with close-ups of the buffer junction 228 and quality control junction 229, according to some embodiments. The channel and junction shapes may comprise any suitable geometry for a given application. For example, in FIG. 2F, the junctions 228, 229 are shown as perpendicular T-junctions. Alternatively, the junctions 228, 229 may comprise angled Y-junctions, for example, or curved Y-junctions, as shown in FIG. 7Z, or any other suitable geometry.

At the quality control junction 229, the quality control channel 269 may form an obtuse angle α with the metering channel 299.

At the buffer junction 228, the buffer channel 266 may form an obtuse angle β with the metering channel 299.

Similarly, at the quality control junction 229, the output channel 285 may form an obtuse angle γ with the metering channel 299.

At the buffer junction 228, the secondary output channel 226 (or alternatively, the primary output channel 216) may form an obtuse angle δ with the metering channel 299.

Each of the junction angles α, β, γ, δ may be in the range of 90° to 180°, 100° to 170°, 110° to 160°, 120° to 150°, 130° to 140°, about 135° or about 137°, for example.

The metering channel 299 may flare at each junction 228, 229 and may define curved edges that transition into the connecting channels 226, 266, 269, 285.

At the quality control junction 229, the quality control channel 269 and output channel 285 may form an acute angle ε and an inflection point 229a.

At the buffer junction 228, the buffer channel 266 and secondary output channel 226 (or alternatively, the primary output channel 216) may form an acute angle ζ and an inflection point 228a.

Each of the acute angles ε and ζ may be in the range of 10° to 90°, 30° to 60°, about 45° or about 40°, for example.

The radius of curvature of the inflection points 228a and 229a may be in the range of 0.1 mm to 0.5 mm, less than 0.5 mm, less than 0.4 mm, less than 0.3 mm, less than 0.2 mm, or about 0.2 mm, for example.

Referring to FIG. 7H, the base membrane 1402 defines through apertures to allow fluid communication through the base membrane 1402 between corresponding portions of ports and channels 242, 212, 222, 253, 283, 262, 272 in the base 202 and pneumatic channel plate 1602. The base membrane 1402 also includes apertures 1230 to allow passage of the radiator and magnets.

In the QC and metering portion of the cartridge 1000, the intermediate outlet 280 is connected to cartridge pneumatic port 1202 via the intermediate outlet pneumatic channel 282, which is defined in the pneumatic channel plate 1602, as shown in FIGS. 7J and 7X.

The output vessel pneumatic port 253 is connected to cartridge pneumatic port 1201 via output vessel pneumatic channel 252 which may be defined in the pneumatic channel plate 1602, as shown in FIG. 7J.

The pneumatic channel plate 1602 defines a QC aperture 1261 aligned with the QC vessel 261 and three QC reference apertures 1271 aligned with the QC reference vessels 271. The polypropylene membrane 1402 may form the bottom of each of the QC vessel 261 and reference vessels 271, and provide a transparent viewing window allowing optical access for the optics module to analyse the contents of the QC vessel 261 and reference vessels 271 through the QC aperture 1261 and QC reference apertures 1271.

In some embodiments, the pneumatic channel plate 1602 (or alternatively another part of the cartridge 1000) may define a switch recess 1690 configured to engage a switch or microswitch on the instrument 100 to indicate that the cartridge 1000 is correctly installed in the socket 120.

FIG. 7I illustrates the PSA layer 1606 in further detail, showing apertures corresponding to areas that do not require adhesive bonding, which essentially corresponds to the apertures in the base membrane 1402 and all of the recesses in the top surface of the pneumatic channel plate 1602, including the valve recesses, fluid traps, QC aperture 1261 and QC reference apertures 1271. The PSA layer 1606 does not necessarily need to define apertures for the pneumatic channels in the pneumatic channel plate, as the adhesive may not effect the function of the channels.

Referring to FIGS. 8A and 8B, the fluid transfer apparatus 880 is shown in more detail. The apparatus 880 comprises the temporary removable lid 259 used to seal the output vessel 250 closed during the instrument workflow as described in relation to in FIGS. 2F and 2G.

The apparatus 880 further comprises a transfer pneumatic channel 882 configured to connect to the to fluidly connect the output vessel 250 to the output vessel pneumatic channel 252, and a liquid transfer channel 886 configured to carry liquid from the final output channel 256 to the output vessel 250 through an outlet in the temporary lid 259.

The channels 882, 886 are defined in a body 888 (e.g., injection moulded polypropylene) and covered and sealed with a transfer apparatus membrane 840 (e.g., heat welded polypropylene membrane) as shown in FIG. 7C.

The body 888 also defines a connector 889 configured to be mechanically coupled to a corresponding connector 1289 on an upper surface of the base 202 near the output vessel seat 254, thereby connecting the transfer pneumatic channel 882 to the output vessel pneumatic channel 252 and the liquid transfer channel 886 to the final output channel 256, as shown in FIG. 8C.

The body 888 may be resiliently flexible and when bent into a twisted connecting configuration, as shown in FIG. 7A, to fluidly and mechanically couple the output vessel 250 to the cartridge 1000, the body 888 may be configured to urge the output vessel 250 towards the cartridge 1000 (e.g., into the seat 254) to secure it during instrument operations, such as mixing with the orbital shaker, for example.

The fluid transfer apparatus 880 may be provided together with the cartridge 1000 (and optionally also an output vessel 250) in a kit, for example.

Alternatively, the temporary lid 259 may simply be connected to the channels 256, 252 via tubes, rather than the fluid transfer apparatus 880.

The cartridge 1000 may comprise an indicia 1295, such as a barcode, for example, to identify a sample stored within (FIG. 7A). The cartridge 1000 may be provided with the output vessel 250 which may comprise a corresponding indicia 1296 or barcode, which may be the same as or associated with the indicia 1295. Alternatively, the cartridge 1000 may comprise one or more peel off labels with corresponding indicia 1296 which may be removed from the cartridge 1000 and applied to a suitable output vessel 250 in which the output fluid is to be accommodated in once the sample has been processed.

The indicia 1295, 1296 may be scanned or otherwise have the data input into the laboratory information system or similar so that it is associated with data produced by the instrument 1000 in processing the sample.

### Example 1

An example of an instrument workflow will now be described, for the purposes of illustration only. In some embodiments, the instrument 100 may be configured to perform a nucleic acid extraction workflow, for example.

Before the instrument workflow begins, a user may pipette a fluid sample, such as a biological specimen, into the primary reaction vessel 210 of a sample cartridge 200. For example, 0.2 to 5 mL of blood or bone marrow taken from a patient.

The user may then close the lid 211 of the primary reaction vessel 210, then record or scan a serial number or other indicia of the sample cartridge 200 and record corresponding patient details, for example from a vial previously containing the sample. This information may be recorded in a LIMS system or Laboratory information system, for example.

The user may then insert the cartridge 200 into one of the cartridge slots 120 in the instrument 100.

The user may then select a workflow program for the instrument using the user interface. Then the instrument workflow may begin, with instrument functions controlled by the control module 101 under instructions recorded on a computer readable storage media. For example, a nucleic acid extraction workflow described below.

The motion module is operated to engage the pneumatic module with the pneumatic ports on the sample cartridge and clamp the cartridge to restrict removal of the cartridge 200 from the cartridge slot 120.

The motion module is then operated to move the reagent module to a position over the sample cartridge and the reagent module is operated to dispense Proteinase K into the reagent vessel 230. For example, in the range of 50 to 100 μg of Proteinase K per mL volume of the specimen.

The pneumatics module is operated to transfer the reagent to the primary reaction vessel 210 with the specimen.

The orbital shaker of the mixing module is operated to promote mixing of the reagent with the specimen in the primary reaction vessel.

The motion module and thermal module are operated activate and raise the heater to heat the primary reaction vessel and incubate at 62 C for 10 min to digest the proteins within the blood. The heater may then be lowered and deactivated.

The motion module and reagent module are then operated to dispense Lysis buffer (e.g., 5M Guanadinium HCl, 0.25% Tween-20) into the reagent vessel 230.

The pneumatic module is then operated to transfer the Lysis buffer to the primary reaction vessel.

The motion module and reagent module are then operated to dispense functionalised magnetic beads (e.g., carboxyl COOH Magbeads) into the reagent vessel.

Any suitable type of functionalized bead may be used, including: solid phase reversible immobilization (SPRI) functionalised beads, carboxylated beads, or other magnetic functionalised beads, for example.

The pneumatic module is then operated to transfer the beads to the primary reaction vessel.

The orbital shaker is operated to promote mixing of the contents of the primary reaction vessel.

The motion and thermal modules are operated to heat the primary reaction vessel and incubate the contents at 62 C for 15 minutes to lysis the blood and bind the nucleic acid (NA) to the beads.

The heater is then deactivated and the cooling fan operated to cool the primary reaction vessel 210.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel including the lysate into the waste vessel 240.

The magnets 710 are then disengaged from the primary reaction vessel.

The motion module and reagent module are then operated to dispense Wash 1 buffer into the reagent vessel (e.g., 3M Guanadinium HCl, 30% Ethanol).

The pneumatic module is then operated to transfer the Wash 1 solution to the primary reaction vessel.

The orbital shaker is operated to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240.

The magnets 710 are then disengaged from the primary reaction vessel.

The motion module and reagent module are then operated to dispense Wash 2 buffer into the reagent vessel (e.g., 20 mM Glycine. HCl (pH 3.0) 80% Ethanol).

The pneumatic module is then operated to transfer the Wash 2 solution to the primary reaction vessel.

The orbital shaker is operated to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240.

The magnets 710 are then disengaged from the primary reaction vessel.

The motion module and reagent module are then operated to dispense Wash 3 buffer into the reagent vessel (e.g., 20 mM Glycine. HCl (pH 3.0)+0.1% Tween 20).

The pneumatic module is then operated to transfer the Wash 3 solution to the primary reaction vessel.

The orbital shaker is operated to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240.

The magnets 710 are then disengaged from the primary reaction vessel.

The motion module and reagent module are then operated to dispense Wash 4 buffer into the reagent vessel (e.g., 20 mM Glycine. HCl (pH 3.0)+0.1% Tween 20).

The pneumatic module is then operated to transfer the Wash 4 solution to the primary reaction vessel.

The orbital shaker is operated to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240.

The magnets 710 are then disengaged from the primary reaction vessel.

The motion module and reagent module are then operated to dispense Elution buffer into the reagent vessel (e.g., 1×TE, pH8.0).

The pneumatic module is then operated to transfer the elution buffer to the primary reaction vessel.

The orbital shaker is operated to promote mixing of the contents of the primary reaction vessel.

The heater is raised and activated to heat the primary reaction vessel to 74 C for 15 minutes to release the DNA from the beads into the elution buffer.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel (the eluate) into the secondary reaction vessel 220.

The magnets 710 are then disengaged from the primary reaction vessel.

The motion module and reagent module are then operated to dispense COOH (carboxyl) beads into the reagent vessel as well as a binding buffer (e.g., 0.8 M NaCl+11% PEG8000).

The pneumatic module is then operated to transfer the contents of the reagent vessel to the secondary reaction vessel.

The orbital shaker is operated to promote mixing of the contents of the secondary reaction vessel and binding of the extracted DNA to the COOH beads.

The motion module and magnetic module are operated to engage the magnets 710 and hold the magnetic beads to one or more sides of the secondary reaction vessel.

The beads are held in place for 1 to 5 minutes while the pneumatic module is operated to transfer the liquid contents of the secondary reaction vessel into the waste vessel 240.

The magnets 710 are then disengaged from the primary reaction vessel.

The motion module and reagent module are then operated to dispense COOH bead Wash 1 into the reagent vessel (e.g., 85% ethanol).

The pneumatic module is then operated to transfer the contents of the reagent vessel to the secondary reaction vessel.

The contents of the secondary reaction vessel are then allowed to incubate for 30 seconds

The motion module and magnetic module are operated to engage the magnets 710 and hold the magnetic beads to one or more sides of the secondary reaction vessel.

The beads are held in place for 1 to 5 minutes while the pneumatic module is operated to transfer the liquid contents of the secondary reaction vessel into the waste vessel 240.

The magnets 710 are then disengaged from the primary reaction vessel.

The motion module and reagent module are then operated to dispense COOH bead Wash 2 into the reagent vessel (e.g., 85% ethanol).

The pneumatic module is then operated to transfer the contents of the reagent vessel to the secondary reaction vessel.

The contents of the secondary reaction vessel are then allowed to incubate for 30 seconds

The motion module and magnetic module are operated to engage the magnets 710 and hold the magnetic beads to one or more sides of the secondary reaction vessel.

The beads are held in place for 1 to 5 minutes while the pneumatic module is operated to transfer the liquid contents of the secondary reaction vessel into the waste vessel 240. The magnets 710 are then disengaged from the primary reaction vessel.

The motion module and reagent module are then operated to dispense COOH Elution buffer (e.g., 10 mM Tris, pH 8.0) into the reagent vessel.

The pneumatic module is then operated to transfer the elution buffer to the secondary reaction vessel.

The orbital shaker is operated to promote mixing of the contents of the secondary reaction vessel to release DNA from the COOH beads into the Elution buffer.

The motion module and magnetic module are operated to engage the magnets 710 and hold the magnetic beads to one or more sides of the secondary reaction vessel.

The pneumatic module is then operated to draw the liquid contents of the secondary reaction vessel (the eluate) up to the air permeable membrane to fill the metering channel.

The motion module and reagent module are then operated to dispense neutral buffer into the QC buffer vessel 265, as well as the three QC reference buffer vessels 275.

The pneumatic module is then operated to draw the buffer solution from the QC buffer vessel through the metering channel and into the QC vessel along with a an aliquot of the eluate from the metering channel (e.g., 1 μL). And to transfer the buffer solution from the QC reference buffer vessels 275 to the corresponding QC reference vessels 271.

The pneumatic module is then operated to transfer the remainder of the eluate from the secondary reaction vessel to the output vessel 250.

The orbital shaker is operated to promote mixing of the contents of the QC vessel 261 and QC reference vessels 271, and resuspension of the preloaded dye and reference nucleic acid (NA) in the QC reference vessels.

The motion module is operated to move the optics module to a position corresponding to the sample cartridge and QC vessel containing the aliquot of eluate with buffer solution, and the optics module is operated to perform a fluorescence measurement on the contents of the QC vessel.

The motion module is further operated to move the optics module to three positions corresponding to three QC reference vessels, and the optics module is operated to perform a fluorescence measurement on the contents of each of the QC reference vessels.

Data from the fluorescence measurements is then used to determine the DNA concentration of the final eluate. The resulting data provides quantification and may be transmitted to a LIMS system for recording and/or capturing.

Finally the pneumatic module may be lowered and disengaged from the sample cartridge. This may comprise the end of the workflow program, according to some embodiments.

The sample cartridge 200 may then be removed from the instrument 100 by a user. The temporary lid 259 may be removed from the output vessel 250, and the main lid closed to seal the output vessel 250.

Then output vessel 250 may then be removed from the output vessel seat 254, and the rest of the sample cartridge 200 discarded.

### Example 2

Another workflow example is set out below according to some embodiments. The chemistry and operating parameters are suitable for gDNA extraction from a 0.5 mL sample of whole blood. The details of the instrument operation may also be suitable for other applications and processes.

Before the instrument workflow begins, a user may pipette a fluid sample, such as a biological specimen, into the primary reaction vessel 210 of a sample cartridge 200. For example, 0.5 mL of blood taken from a patient.

The user may then close the lid 211 of the primary reaction vessel 210, then record or scan a serial number or other indicia of the sample cartridge 200 and record corresponding patient details, for example from a vial previously containing the sample. This information may be recorded in a LIMS system or Laboratory information system, for example.

The user may then insert the cartridge 200 into one of the cartridge slots 120 in the instrument 100.

The user may then select a workflow program for the instrument using the user interface. Then the instrument workflow may begin, with instrument functions controlled by the control module 101 under instructions recorded on a computer readable storage media. For example, a nucleic acid extraction workflow is described below.

The motion module is operated to engage the pneumatic module with the pneumatic ports on the sample cartridge and clamp the cartridge to restrict removal of the cartridge 200 from the cartridge slot 120.

The motion module is then operated to move the reagent module to a position over the sample cartridge and the reagent module is operated to dispense 50 μL of Proteinase K (Qiagen, as received from supplier) into the reagent vessel 230.

The pneumatics module is operated to transfer the reagent to the primary reaction vessel 210 with the specimen.

Then the reagent module is operated to dispense 120 μL of commercial support buffer AL into the reagent vessel 230, and the pneumatics module is operated to transfer the reagent to the primary reaction vessel 210 with the specimen.

Alternatively, the Proteinase K and buffer solution may be dispensed into the reagent vessel 230 together, or one after the other, and then transferred into the primary reaction vessel 210 together in a single transfer step.

The operation of the pneumatics module may comprise applying a vacuum pressure or negative pressure (relative to ambient pressure) in the range of 100 mBar to 120 mBar, for example.

The orbital shaker of the mixing module is operated for 10 seconds at 1100 rpm to promote mixing of the reagent with the specimen in the primary reaction vessel.

The motion module and thermal module are operated to activate and raise the heater to heat the primary reaction vessel and incubate at 25° C. for 10 min to digest the proteins within the blood. The heater may then be lowered and deactivated.

Alternatively, if the ambient temperature is close to 25° C., the heater may not be required for this step.

The motion module and reagent module are then operated to dispense 825 μL Lysis buffer (0.8M g.HCl, 0.01M Tris pH8, 50% 2-propanol, 1.2M NaCl, 2 mM EDTA, 0.25% Tween-20) into the reagent vessel 230.

The pneumatic module is then operated to transfer the Lysis buffer to the primary reaction vessel.

The motion module and reagent module are then operated to dispense functionalised magnetic beads (Siemens Versant 50 μL) into the reagent vessel.

The pneumatic module is then operated to transfer the beads to the primary reaction vessel.

In order to avoid or reduce the time available for the beads to precipitate or sediment in the reagent vessel (which may lead to blockages), the pneumatic module may be operated to transfer the beads into the primary reaction vessel before completion of the dispensing of the beads into the reagent vessel. For example, the transfer may begin during or part way through the dispensing, and may be done in stages. The dispensing may also be done in stages in some embodiments.

Alternatively, or additionally, part of the Lysis buffer solution (e.g., two thirds) may be held back and dispensed into the reagent chamber after dispensing and transfer of the beads, in order to flush any beads remaining in the reagent vessel or transfer channel into the primary reaction vessel.

The orbital shaker is operated to promote mixing of the contents of the primary reaction vessel for 10 seconds at 1100 rpm.

The motion and thermal modules are operated to heat the primary reaction vessel and incubate the contents at approximately 62° C. for 15 minutes to lysis the blood and bind the nucleic acid (NA) to the beads. The orbital shaker may also be operated at 1100 rpm during the incubation period to promote mixing.

The heater is then deactivated and the cooling fan operated to cool the primary reaction vessel 210 back to ambient temperature. For example, the cooling operation may have a duration in the range of 1 minute to 5 minutes, 2 minutes to 3 minutes, or about 2 minutes, depending on the cooling rate. In some embodiments it may be necessary to cool the reaction vessel so that the beads do not dry out. In other embodiments, if drying is not problematic, this step may be omitted.

The motion module and magnetic module are operated to engage the magnets 710 and hold the magnetic beads to one or more sides of the primary reaction vessel.

The magnets may be engaged during the cooling operation.

The beads are held in place for 1 to 5 minutes while the pneumatic module is operated to transfer the liquid contents of the primary reaction vessel including the lysate into the waste vessel 240. The magnets may be applied to engage the beads for approximately 1 minute before transferring the liquid in order to allow the beads to migrate towards the magnets to be held against the wall of the vessel with sufficient strength to resist flowing with the liquid during the transfer process. The length of time required may depend on the strength of magnetic attraction between the beads and the magnets, as well as the viscosity of the fluid. In some embodiments, a shorter settling time (less than 1 minute) may be sufficient or a longer settling time may be required (e.g., more than 1 minute, more than 2 minutes, more than 3 minutes, or more than 4 minutes).

The magnets 710 are then disengaged from the primary reaction vessel.

The motion module and reagent module are then operated to dispense 850 μL of Wash 1 buffer into the reagent vessel (e.g., 3M Guanadinium HCl (gHCl), 30% Ethanol).

The pneumatic module is then operated to transfer the Wash 1 solution to the primary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

The magnets 710 are then disengaged from the primary reaction vessel.

The motion module and reagent module are then operated to dispense 450 μL of Wash 2 buffer into the reagent vessel (e.g., 80% ethanol, 0.1M sodium citrate buffer, pH 3).

The pneumatic module is then operated to transfer the Wash 2 solution to the primary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

The magnets 710 are then disengaged from the primary reaction vessel.

The motion module and reagent module are then operated to dispense 450 μL of Wash 3 buffer into the reagent vessel (e.g., 20 mM glycine.HCl, 0.1% Tw-20, pH3).

The pneumatic module is then operated to transfer the Wash 3 solution to the primary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

The magnets 710 are then disengaged from the primary reaction vessel.

The motion module and reagent module are then operated to dispense 450 μL of Wash 4 buffer into the reagent vessel (e.g., 20 mM glycine.HCl, 0.1% Tw-20, pH3).

Wash 4 is completed using the same buffer solution as Wash 3 in order to flush out contaminants in the dispensing system from previous steps. This step may be repeated more than once if needed to ensure purity or further reduce the likelihood of contaminants appearing in the solution. Alternatively, if contaminants are not a concern, or if the dispense system includes independent channels which avoids potential contamination, then this step may be omitted.

The pneumatic module is then operated to transfer the Wash 4 solution to the primary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

The magnets 710 are then disengaged from the primary reaction vessel.

The motion module and reagent module are then operated to dispense 165 μL of Elution buffer into the reagent vessel (e.g., 1×TE, pH8.0).

The pneumatic module is then operated to transfer the elution buffer to the primary reaction vessel.

The heater is raised and activated to heat the primary reaction vessel to approximately 62° C. for 10 minutes to release the DNA from the beads into the elution buffer. The orbital shaker may be operated at 1100 rpm during the 10 minute incubation period to promote mixing of the contents of the primary reaction vessel.

The motion module and magnetic module are then operated to engage the magnets 710 and hold the magnetic beads to one or more sides of the primary reaction vessel.

The beads are held in place for 1 to 5 minutes while the pneumatic module is operated to transfer the liquid contents of the primary reaction vessel (the eluate) into the secondary reaction vessel 220. The magnets may be applied to engage the beads for approximately 1 minute before transferring the liquid. The used beads will then remain in the primary reaction vessel until the end of the process (during further processing of the eluate in the secondary reaction vessel) or when the cartridge is discarded.

The magnets 710 are then disengaged from the primary reaction vessel.

The motion module and reagent module are then operated to dispense COOH (carboxyl) beads into the reagent vessel as well as a binding buffer (e.g., 470 μL mastermix, 1.24M NaCl, 13.95% PEG8000, 0.78% w/v magnify (MFY0002 Bangslab beads)).

The pneumatic module is then operated to transfer the contents of the reagent vessel to the secondary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

In this example, the beads in the secondary reaction vessel beads have a weaker magnetic attraction to the magnets and are in a more viscous solution. Therefore a longer settling time may be required (e.g., 2 minutes). However, longer or shorter settling times from less than 1 minute to more than 2 minutes, 3 minutes or 4 minutes may be used if sufficient.

In some embodiments, the magnets may remain engaged during the subsequent wash stages. For example, as in this case, if there are relatively weak binding kinetics on the beads, holding the beads in position with the magnets may mitigate against DNA being washed off of the beads prematurely.

The motion module and reagent module are then operated to dispense 200 μL of COOH bead Wash 1 into the reagent vessel (e.g., 85% ethanol).

The pneumatic module is then operated to transfer the contents of the reagent vessel to the secondary reaction vessel.

The contents of the secondary reaction vessel are then allowed to incubate for 30 seconds at room temperature.

The pneumatic module is then operated to transfer the liquid contents of the secondary reaction vessel into the waste vessel 240, while the magnets (still engaged) hold the beads in place.

The motion module and reagent module are then operated to dispense 200 μL of COOH bead Wash 2 into the reagent vessel (e.g., 85% ethanol).

COOH bead Wash 2 is completed using the same buffer solution as COOH bead Wash 1 in order to flush out contaminants in the dispensing system from previous steps. This step may be repeated more than once if needed to ensure purity or further reduce the likelihood of contaminants appearing in the solution. Alternatively, if contaminants are not a concern, or if the dispense system includes independent channels which avoids potential contamination, then this step may be omitted.

The pneumatic module is then operated to transfer the contents of the reagent vessel to the secondary reaction vessel.

The contents of the secondary reaction vessel are then allowed to incubate for 30 seconds at room temperature.

The pneumatic module is then operated to transfer the liquid contents of the secondary reaction vessel into the waste vessel 240, while the magnets (still engaged) hold the beads in place.

The magnets 710 are then disengaged from the primary reaction vessel.

The motion module and reagent module are then operated to dispense 30 μL of COOH Elution buffer (e.g., 1× TE buffer pH8) into the reagent vessel.

The pneumatic module is then operated to transfer the elution buffer to the secondary reaction vessel.

The orbital shaker is operated for 10 seconds at 1100 rpm to promote mixing of the contents of the secondary reaction vessel to release DNA from the COOH beads into the Elution buffer.

The motion module and magnetic module are operated to engage the magnets 710 and hold the magnetic beads to one or more sides of the secondary reaction vessel. A settling time of approximately 1 minute may be allowed before the next step.

The pneumatic module is then operated to draw the liquid contents of the secondary reaction vessel (the eluate) up to the air permeable membrane to fill the metering channel.

The motion module and reagent module are then operated to dispense neutral buffer (e.g., 199 μL 1× TE buffer pH8) into the QC buffer vessel 265, as well as the three QC reference buffer vessels 275 (e.g., 200 μL 1× TE buffer pH8).

The pneumatic module is then operated to draw the buffer solution from the QC buffer vessel through the metering channel and into the QC vessel 265 along with an aliquot of the eluate from the metering channel (e.g., 1 μL) until air fills the channels. The pneumatic module is also operated to transfer the buffer solution from the QC reference buffer vessels 275 to the corresponding QC reference vessels 271.

Each of the QC vessel 265 and QC reference buffer vessels 275 contains a similar quantity (e.g., 0.2 μg) of a dried DNA dye and the QC reference buffer vessels 275 each contain a different reference quantity of gDNA for comparison (e.g., 4 ng gDNA, 60 ng gDNA, 500 ng gDNA, respectively).

The pneumatic module is then operated to transfer the remainder of the eluate from the secondary reaction vessel to the output vessel 250.

The orbital shaker is operated for 10 seconds at 1100 rpm to promote mixing of the contents of the QC vessel 261 and QC reference vessels 271, and resuspension of the preloaded dye and reference nucleic acid (NA) in the QC reference vessels.

The motion module is operated to move the optics module to a position corresponding to the sample cartridge and QC vessel containing the aliquot of eluate with buffer solution, and the optics module is operated to perform a fluorescence measurement on the contents of the QC vessel.

The motion module is further operated to move the optics module to three positions corresponding to three QC reference vessels, and the optics module is operated to perform a fluorescence measurement on the contents of each of the QC reference vessels.

Data from the fluorescence measurements is then used to determine the DNA concentration of the final eluate by fitting a curve between the measurements from the three reference vessels with known concentrations, and interpolating (or extrapolating) to determine the concentration of the eluate). The resulting data may be transmitted to a LIMS system for recording and/or capturing.

Finally the pneumatic module may be lowered and disengaged from the sample cartridge. This may comprise the end of the workflow program, according to some embodiments.

The sample cartridge 200 may then be removed from the instrument 100 by a user. The temporary lid 259 may be removed from the output vessel 250, and the main lid closed to seal the output vessel 250.

Then output vessel 250 may then be removed from the output vessel seat 254, and the rest of the sample cartridge 200 discarded.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1-71. (canceled)

72. A sample cartridge for a chemical processing instrument, the sample cartridge comprising:
a primary reaction vessel configured to accommodate a fluid sample for processing and configured to receive a lid for closing an open top of the primary reaction vessel;
a reagent vessel configured to receive one or more fluid reagents via an open top of the reagent vessel, the reagent vessel being connected to the primary reaction vessel via a primary reagent channel with a primary reagent valve disposed in the primary reagent channel to control fluid flow through the primary reagent channel; and
a primary pneumatic port in fluid communication with the primary reaction vessel and configured to be connected to a pneumatic module to selectively adjust a pressure within the primary reaction vessel when the lid is closed to draw the fluid contents of the reagent vessel into the primary reaction vessel.

73. The sample cartridge of claim 72, further comprising a primary pneumatic channel extending between the primary pneumatic port and the primary reaction vessel,
wherein an opening of the primary pneumatic channel into the primary reaction vessel is located part way up a sidewall of the primary reaction vessel.

74. The sample cartridge of claim 72, wherein an opening of the primary reagent channel into the primary reaction vessel is located part way up a sidewall of the primary reaction vessel.

75. The sample cartridge of claim 72, further comprising a final output channel configured to carry a final output fluid from the primary reaction vessel to a removable output vessel.

76. The sample cartridge of claim 75, further comprising an output vessel pneumatic port configured to be in fluid communication with the output vessel via an output vessel pneumatic channel and configured to be connected to a pneumatic module to selectively adjust the pressure in the output vessel to draw the final output fluid into the output vessel from the primary reaction vessel via the final output channel.

77. The sample cartridge of claim 76, further comprising a temporary lid configured to close the output vessel during processing, the temporary lid being configured to fluidly connect the final output channel and output vessel pneumatic channel to the output vessel.

78. The sample cartridge of claim 75, further comprising:
a sealed quality control vessel configured to receive an aliquot of the output fluid for quality control analysis;
a quality control channel extending between the quality control vessel and a quality control junction with the final output channel; and
a quality control pneumatic port in fluid communication with the quality control vessel and configured to be connected to a pneumatic module to selectively adjust a pressure within the quality control vessel to draw the aliquot of final output fluid from the final output channel through the quality control channel and into the quality control vessel.

79. The sample cartridge of claim 78, wherein the quality control vessel is preloaded with a dye to be mixed with the aliquot of final output fluid for quality control analysis.

80. The sample cartridge of claim 78, further comprising:
a buffer solution vessel configured to receive a buffer solution through an open top of the buffer solution vessel for mixing with the final output fluid for quality control analysis;
a buffer channel extending between the buffer solution channel and a buffer junction with the final output channel between the quality control junction and the primary reaction vessel; and
a buffer channel valve disposed in the buffer channel to control flow of the buffer solution through the buffer channel.

81. The sample cartridge of claim 79, further comprising:
an intermediate outlet from the final output channel between the quality control junction and the output vessel;
a sealed chamber into which the intermediate outlet opens;
an air-permeable liquid barrier membrane covering the outlet; and
an intermediate outlet pneumatic port in fluid communication with the sealed chamber and configured to be connected to a pneumatic module to selectively adjust a pressure within the sealed chamber to draw air through the air-permeable membrane from the final output channel.

82. The sample cartridge of claim 72, further comprising a sealed waste vessel configured to receive waste fluid from the primary reaction vessel via a waste channel; and
a waste pneumatic port in fluid communication with the waste vessel and configured to be connected to a pneumatic module to selectively adjust a pressure within the waste vessel to draw fluid from the primary reaction vessel through the waste channel and into the waste vessel.

83. The sample cartridge of claim 72, further comprising a secondary reaction vessel configured to receive a primary output fluid from the primary reaction vessel via a primary output channel fluidly connecting the primary reaction vessel to the secondary reaction vessel, and configured to receive one or more fluid reagents from the reagent vessel via a secondary reagent channel fluidly connecting the reagent vessel to the secondary reaction vessel;
a primary outlet valve disposed in the primary outlet channel to control flow through the primary outlet channel; and
a secondary reagent valve disposed in the secondary reagent channel to control flow through the secondary reagent channel.

84. The sample cartridge of claim 83, wherein the secondary reaction vessel is sealed, and
wherein the sample cartridge further comprises a secondary pneumatic port in fluid communication with the secondary reaction vessel and configured to be connected to a pneumatic module to selectively adjust a pressure in the secondary reaction vessel to draw fluid from the primary outlet channel or secondary reagent channel into the secondary reaction vessel.

85. The sample cartridge of claim 84, further comprising a secondary pneumatic channel extending between the secondary pneumatic port and the secondary reaction vessel,
wherein an opening of the secondary pneumatic channel into the secondary reaction vessel is located part way up a sidewall of the secondary reaction vessel, nearer to a top of the secondary reaction vessel than a bottom of the secondary reaction vessel.

86. The sample cartridge of claim 83, wherein an inlet or inlets of the primary output channel and secondary reagent channel open into the secondary reaction vessel part way up a sidewall of the secondary reaction vessel, nearer to a top of the secondary reaction vessel than a bottom of the secondary reaction vessel.

87. The sample cartridge of claim 80, wherein, at the quality control junction, the quality control channel forms an obtuse angle with part of the final output channel extending between the quality control junction and buffer junction.

88. The sample cartridge of claim 80, wherein, at the buffer junction, the buffer channel forms an obtuse angle with part of the final output channel extending between the quality control junction and buffer junction.

89. The sample cartridge of claim 80, wherein, at the buffer junction, a pre-buffer junction part of the final output channel forms an obtuse angle with part of the final output channel extending between the quality control junction and buffer junction, and
wherein, at the quality control junction, a post-QC junction part of the final output channel forms an obtuse angle with part of the final output channel extending between the quality control junction and buffer junction.

90. A sample cartridge for use with a fluid analysis instrument, the cartridge comprising:
a sample vessel configured to accommodate a fluid sample for analysis;
a buffer solution vessel configured to accommodate a buffer solution;
an analysis vessel configured to accommodate a mixed fluid comprising an aliquot of the fluid sample mixed with at least some of the buffer solution for analysis;
a sample channel extending between the sample vessel and a first junction;
a sample channel valve disposed in the sample channel to control flow of the sample through the sample channel;
a buffer channel extending between the buffer solution vessel and the first junction;
a buffer channel valve disposed in the buffer channel to control flow of the buffer solution through the buffer channel;
a metering channel in fluid communication with the buffer channel and sample channel, the metering channel extending between the first junction and a second junction;
an analysis vessel channel in fluid communication with the metering channel and extending between the second junction and the analysis vessel; and
an analysis vessel pneumatic port in communication with the analysis vessel and configured to be connected to a pneumatic module to selectively adjust a pressure in the analysis vessel to draw fluid into the analysis vessel via the analysis vessel channel.

91. A method of use of the sample cartridge of claim 72, the method comprising operating an instrument to achieve the extraction, isolation, enrichment, concentration or quantification of nucleic acids from a sample in the sample cartridge, or the preparation of nucleic acid for manipulation, analysis, amplification, sequencing, PCR library preparation or insertion into a vector.
